(19) United States
(12) Patent Application Publication
(10) Pub. No.: US 2007/0071524 A1
(43) Pub. Date: Mar. 29, 2007

(54) Printer and image forming method

(75) Inventor: Yoichi Nakamura, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 11/516,507

(22) Filed: Sep. 7, 2006

(30) Foreign Application Priority Data
Sep. 7, 2005 (JP) 2005-259211
Sep. 9, 2005 (JP) 2005-262737

(51) Int. Cl. G03G 15/20; G03G 15/00

(52) U.S. Cl. 399/341; 399/401

(57) ABSTRACT

A printer includes a image recording section for recording an image on a recording medium at a predetermined recording position, a surface treatment section for performing surface treatment on one surface of the recording medium, a first reversing section for reversing the recording medium after the image has been recorded by the image recording section and supplying the recording medium to an upstream of the image recording section and a second reversing section for reversing the recording medium. The second reversing section reverses the recording medium subjected to the surface treatment by the surface treatment section to supply the recording medium to the upstream of the surface treatment section, and the surface treatment section performs the surface treatment on another surface of the reversed recording medium. The printer performs an image forming method producing a two-side print in which one or two surfaces is subjected to the surface treatment.

### BACKGROUND OF THE INVENTION

The present invention relates to a printer and an image forming method capable of suitably performing two-side printing in which at least one surface (i.e., one side) of a recording medium is subjected to surface treatment such as gloss treatment, and both surfaces of the recording medium have images recorded thereon. In particular, the present invention relates to a printer and an image forming method capable of performing surface treatment on one surface of a recording medium to produce a two-side print having a high-quality image formed on one surface of the recording medium, and also relates to a printer and an image forming method capable of performing surface treatment on both surfaces of a recording medium to produce a two-side print having high-quality images formed on both surfaces thereof.

Known as electrophotographic printing is a method of producing a glossy print equivalent to a photographic print, by using a recording sheet (i.e., image recording medium) having a transparent resin layer composed of a thermoplastic resin formed on a surface (i.e., one side) of a base material as an image recording layer.

In such method of producing the glossy print, an image is recorded on the transparent resin layer (i.e., image recording layer) of the recording sheet, and then the transparent resin layer is allowed to abut against surface treatment means having high smoothness to perform surface treatment by applying heat and pressure. Then, the transparent resin layer is melted and coagulated to smoothen a surface of the image recording medium and put a gloss thereto.

As an example, JP 2005-49530 A (hereinafter, referred to as “patent document 1”) discloses a printer (i.e., image forming apparatus) for obtaining a high-quality print substantially equivalent to a photographic print in the following manner. That is, a toner image is formed on a recording sheet (i.e., image receiving medium) having a transparent resin layer on one surface thereof, and then the toner image is fixed on the recording sheet by using smoothening and glossing means which includes a fixing belt which is an endless belt having high surface smoothness, rollers including a heating roller on which the fixing belt is attached, and a nip roller (in other words, nips the endless belt with the heating roller) which is pressed against the fixing belt (i.e., heating roller).

In this printer, the toner image obtained through an electrophotographic process is first formed on the surface of the transparent resin layer of the recording sheet.

Next, in the smoothening and glossing means, the image receiving medium is nipped and transported by the fixing belt and the nip roller with the transparent resin layer on which the toner image has been formed, facing the fixing belt. With the image receiving medium being nipped and transported, the transparent resin layer of the recording sheet is abutted/pressed against the fixing belt and heated to fix the toner image thereon, and the transparent resin layer is melted to allow the recording sheet to slightly adhere to the fixing belt. Further, while the adhered recording sheet is transported by the fixing belt, the transparent resin layer is cooled/coagulated and transported at a predetermined length, and then the recording sheet is detached from the fixing belt.

As a result, the toner image is fixed on the recording sheet, and a surface property of the fixing belt having high smoothness is transferred onto the transparent resin layer of the recording sheet, thereby putting a gloss on the surface of the print.

In various types of printers, an image is recorded on one surface (i.e., one side) of a recording sheet, and then the recording sheet is reversed by so-called switch-back or the like. After that, the recording sheet is transported to an image recording unit to record an image again on the other surface thereof, and then a print having images recorded on both sides thereof (i.e., so-called two-side print) is outputted.

Also in the above-mentioned printing method using the recording sheet having the transparent resin layer, it is expected to produce a print with a high added-value including various information recorded on a back surface of the transparent resin layer of a two-side print having an image formed thereon. The various information includes information on an advertisement or an image, an QR code or a two-dimensional bar code which indicates various information or the like, and photographing conditions or a photographing place which is required for forming an image by photographing.

On the other hand, in the above-mentioned printing method using the recording sheet having the image recording layer adapted for the surface treatment, such as the transparent resin layer, formed on one surface thereof, a two-side print cannot be produced in a similar manner as in a printer which is capable of performing general two-side image recording and which does not perform the surface treatment, and in addition, the surface treatment cannot be performed.

In recent years, in the above-mentioned electrophotographic printing method, a printer for recording high-quality images on both surfaces of the recording sheet in the following manner has been proposed. That is, in the printer, by using the recording sheet having the transparent resin layer composed of the thermoplastic resin formed on both surfaces of the base material as the image recording layer, the toner image is fixed on both surfaces of the recording sheet, and the surface property of the fixing belt having high smoothness is transferred onto both surfaces of the recording sheet to put a gloss on the surface of the print.

As an example, JP 2005-114832 A (hereinafter, referred to as “patent document 2”) discloses a printer (i.e., image forming apparatus) capable of recording (i.e., forming) high-quality photographic images on both surfaces of a recording sheet with efficiency. The printer includes an image forming unit for transferring a toner image on one surface of front and back surfaces of a recording sheet (i.e., recording medium), a primary fixing unit for fixing the toner image which has been transferred on the recording medium by the image forming unit, a forwarding unit for reversing the recording sheet so as to form an image on a surface opposite to the surface on which the toner image has been fixed, and a secondary fixing unit for simultaneously performing surface treatment, with respect to the both surfaces of the recording sheet, on the toner images having been fixed on both surfaces of the recording medium after the recording medium is forwarded by the forwarding unit.

### SUMMARY OF THE INVENTION

Also in a printer for performing surface treatment on an image recording layer, it is possible to form images on both surfaces of a recording sheet in the following manner. That is, a transport path which is provided for reversing the recording sheet and which branches from a predetermined transport path toward a surface treatment section, is provided downstream of an image recording unit. On the transport path, the sheet is reversed by switch-back or the like, and the recording sheet which has been reversed is transported upstream of the image recording unit to record an image again in the image recording unit.

In this case, the surface treatment section such as the above-mentioned smoothening and glossing means is arranged so as to perform the surface treatment on the image recording layer such as the transparent resin layer in accordance with the general printing (i.e., one-side print) in which an image is formed on only one surface of the recording sheet. In other words, the surface treatment can be performed only on one surface with respect to a transport surface of the recording medium.

Further, in the printer, recording sheets are contained in a cassette, a tray, and a magazine for a recording medium (i.e., roll paper) wound in a roll shape so that an image can be recorded on the image recording layer in accordance with the one-side printing.

Therefore, in a case where a recording sheet is supplied to the surface treatment section after the image has been recorded on the image recording layer and the recording sheet has been reversed to record an image on the other surface (i.e., back surface) thereof, the surface treatment is performed on the back surface which is not the image recording layer. In other words, the surface treatment cannot be performed on the image recording layer.

Also proposed is a method in which, after an image is recorded on the back surface of the recording sheet, recording means is transported again to the transport path, which is provided for reversing the recording means, to reverse the recording means, and the recording medium is transported from the upstream of the image recording apparatus to the surface treatment means passing through the image recording unit. However, in the method, the recording medium passes through the image recording unit three times in total, and image recording for a subsequent print cannot be performed until the third passing of the recording medium is completed. As a result, efficiency in printing deteriorates to a large extent.

The two-side print in which the surface treatment is performed on the image recording layer can be produced by recording an image on the image recording layer of a recording medium after recording an image on the back surface of the recording medium.

However, in order to produce such two-side print, it is necessary to take out the recording sheet contained in a cassette or a tray in accordance with the one-side printing, reverse the recording sheet, and to load/set the recording sheet again in the cassette or the tray, which requires a lot of time and labor. In addition, in a case where the recording sheet having the image recording layer adapted for the surface treatment such as the transparent resin layer is supplied as roll paper, it is substantially impossible to set the recording sheet in the printer with the recording sheet being reversed.

On the other hand, according to the printer disclosed in the patent document 2, high-quality photographic images can be formed on both surfaces of the recording sheet with efficiency.

However, the printer disclosed in the patent document 2 is provided with two secondary fixing units in total on both sides of the printer, that is, a secondary fixing unit is provided on each side of the printer, so as to simultaneously perform the surface treatment for the recording sheet with respect to both surfaces thereof.

With regard to the surface treatment means such as the secondary fixing unit and the smoothening and glossing means, a cost for one unit is extremely high, power consumption thereof is large, and a weight thereof is also large. As a result, when two such units are provided for one apparatus, a manufacturing cost or power consumption of the apparatus is increased, and the size of the apparatus is also increased. Further, when the surface treatment is performed simultaneously on both surfaces of the recording sheet, it becomes difficult to control temperatures on both surfaces of the recording sheets, which may result in melting the back surface thereof during the surface treatment.

To solve the above-mentioned problems in the conventional art, a first object of the present invention is to provide a printer and an image forming method capable of producing a two-side print, in which images have been recorded on both surfaces, that is, an image recording layer and a back surface thereof, and surface treatment has been performed on the image recording layer, without performing operations such as reversal of a recording sheet contained in a cassette or the like, and even in a case where the recording sheet having the image recording layer adapted for the surface treatment is supplied as roll paper wound in a roller shape, in print production in which the surface treatment is performed after the image has been recorded on the image recording layer by using a recording sheet having the image recording layer adapted for the surface treatment formed on one surface thereof, such as a recording sheet (i.e., recording medium) having the transparent resin layer composed of a thermoplastic resin as the image recording layer.

To solve the above-mentioned problems in the conventional art, a second object of the present invention is to provide a printer and an image forming method capable of producing a two-side print having high-quality images formed on both surfaces thereof, in which images are recorded on the image recording layers formed on both surfaces thereof, and surface treatment is performed on the image recording layers formed on both surfaces thereof, without increasing the size, a manufacturing cost, and power consumption of the apparatus.

In order to attain the first object, according to a first aspect of the present invention, there is provided a printer including: image recording means for recording an image on a recording medium at a predetermined recording position; surface treatment means for performing surface treatment on one surface of the recording medium; first reversing means for reversing two surfaces of the recording medium after the image has been recorded on the one surface of the recording medium by the image recording means and supplying the recording medium to an upstream of the image recording means; and second reversing means for reversing the two surfaces of the recording medium.

In this case, the second reversing means is preferably positioned upstream of the first reversing means. It is also preferable that the second reversing means is positioned upstream of the image recording means and the first reversing means, and the image recording medium before the image is recorded thereon by the image recording means is reversed.

Alternatively, it is preferable to share a part of a transport path for the recording medium by the second reversing means and the first reversing means.

Alternatively, it is preferable that the second reversing means is positioned downstream of the image recording means and the first reversing means and upstream of the surface treatment means, and the surface treatment means performs the surface treatment on the one surface of the recording medium, both surfaces of which have images formed by the image recording means.

In order to attain the second object, according to a second aspect of the present invention, in the printer according to the first aspect of the present invention, it is preferable that the surface treatment means performs the surface treatment on the one surface or both surfaces of the recording medium, and the second reversing means reverses the recording medium subjected to the surface treatment by the surface treatment means to supply the recording medium to the upstream of the surface treatment means. In other words, according to the second aspect of the present invention, there is provided a printer including: image recording means for recording an image on a recording medium at a predetermined recording position; surface treatment means for performing surface treatment on (one surface or both surfaces of) the recording medium; a first reversing means for reversing the recording medium after being recorded with the image by the image recording means to supply the recording medium to an upstream of the image recording means; and a second reversing means for reversing the recording medium subjected to the surface treatment by the surface treatment means to supply the recording medium to the upstream of the surface treatment means.

According to this aspect is preferable that the printer has a mode in which an image is formed on one surface of the recording medium to perform the surface treatment on the one surface, a mode in which images are recorded on both surfaces of the recording medium to perform the surface treatment on one surface of both surfaces thereof, and a mode in which images are recorded on both surfaces of the recording medium to perform the surface treatment on both surfaces thereof, and any one of the modes can be selected.

In order to attain the first object, according to the first aspect of the present invention, there is provided an image forming method including: performing image recording by image recording means after reversing a recording medium, thereby recording an image on a second surface (i.e., back surface) of the recording medium; reversing the recording medium and transporting the recording medium to an upstream of the image recording means; performing the image recording on a first surface (i.e., front surface) of the recording medium by the image recording means to record the image on the first surface (i.e., front surface) of the recording medium; and performing surface treatment on the first surface (i.e., front surface) of the recording medium.

Also, in order to attain the first object, according to the first aspect of the present invention, there is provided an image forming method including: recording an image on a first surface (i.e., front surface) of a recording medium by image recording means; reversing the recording medium and transporting the recording medium to upstream of the image recording means; performing image recording on a second surface (i.e., back surface) of the recording medium by the image recording means to record the image on the second surface (i.e., back surface) of the recording medium; and reversing the recording medium upstream of surface treatment means to perform surface treatment on the first surface (i.e., front surface) of the recording medium by the surface treatment means.

Also, in order to attain the second object, according to the second aspect of the present invention, in the image forming method according to the first aspect, it is preferable that, after the first surface (i.e., front surface) of the recording medium is subjected to surface treatment, the recording medium is further reversed, and is transported upstream of the surface treatment means to perform surface treatment on the second surface (i.e., back surface) of the recording medium by the surface treatment means. In other words, according to this aspect, there is provided an image forming method including: recording an image on a first surface (i.e., front surface) of a recording medium by image recording means; reversing the recording medium and transporting the recording medium to the upstream of the image recording means; recording an image on a second surface (i.e., back surface) of the recording medium by the image recording means; reversing the recording medium upstream of surface treatment means to perform surface treatment on the first surface (i.e., front surface) of the recording medium by the surface treatment means; reversing again the recording medium and transporting the recording medium to the upstream of the surface treatment means; and performing the surface treatment on the second surface (i.e., back surface) of the recording medium.

Also, in order to attain the second object, according to the second aspect of the present invention, there is provided an image forming method including: recording an image on a first surface (i.e., front surface) of a recording medium by image recording means; reversing the recording medium and transporting the recording medium to the upstream of the image recording means; performing image recording on a second surface (i.e., back surface) of the recording medium by the image recording means to record the image on the second surface (i.e., back surface) of the recording medium; performing surface treatment on a second surface (i.e., back surface) of the recording medium by surface treatment means; reversing the recording medium and transporting the recording medium to the upstream of the surface treatment means; and performing the surface treatment on the first surface (i.e., front surface) of the recording medium by the surface treatment means.

In the printer and the image forming method according to the first and second aspects of the present invention, it is preferable that the surface treatment means presses the recording medium against the surface treatment belt to heat the recording medium, transports the recording medium to cool the recording medium while the recording medium is adhered to the surface treatment belt, and then detaches the recording medium from the surface treatment belt, thereby transferring the surface property of the surface treatment belt onto the recording medium.

Further, the image recording means preferably records the image on the recording medium by the electrophotographic process.

According to the first aspect of the present invention with the above-mentioned structure, in print production using a recording sheet (i.e., image recording medium) having an image recording layer adapted for the surface treatment on one surface thereof, such as a recording medium having a transparent resin layer composed of a thermoplastic resin as an image recording layer used for performing gloss treatment, the printer includes the second reversing means for reversing the recording sheet before image recording or after being subjected to two-side recording, in addition to the first reversing means for reversing a recording sheet after being recorded with an image to supply the recording sheet to the upstream of the image recording unit. Thus, it is possible to record an image on the image recording layer and the other surface (i.e., back surface) of the recording sheet, and to produce a two-side print whose image recording layer is subjected to surface treatment, without performing operations such as reversal of the recording sheet to load the sheet again in a cassette or the like, even in a case where the recording sheet having the image recording layer adapted for the surface treatment is supplied as roll paper wound in a roll shape.

According to the second aspect of the present invention with the above-mentioned structure, the printer includes the second reversing means for reversing the recording sheet after being subjected to two-side recording to supply the recording sheet to the upstream of the surface treatment means, in addition to the first reversing means for recording images on both surfaces of the recording sheet. Thus, even when the recording sheet having image recording layers on both surfaces thereof is supplied, it is possible to produce a two-side print having high-quality images on both surfaces of the recording sheet which have images recorded on image recording layers formed on both surfaces thereof that are subjected to surface treatment, without providing two surface treatment means for one apparatus, in other words, without increasing a size, a manufacturing cost, and power consumption of the apparatus, which is caused by providing two surface treatment means.

### BRIEF DESCRIPTION OF THE DRAWINGS

FIG. 1 is a schematic diagram showing an embodiment of a printer according to a first aspect of the present invention;

FIGS. 2A and 2B are schematic diagrams for explaining cutting-plane lines of recording sheets, on which two images and one image are recorded respectively, in a width direction, the images being formed in a printer shown in FIG. 1;

FIG. 3 is a schematic diagram showing another embodiment of the printer according to the first aspect of the present invention;

FIG. 4 is a schematic diagram showing another embodiment of the printer according to the first aspect of the present invention;

FIG. 5 is a schematic diagram showing another embodiment of the printer according to the first aspect of the present invention;

FIG. 6 is a schematic diagram showing another embodiment of the printer according to the first aspect of the present invention;

FIG. 7 is a schematic diagram showing another embodiment of the printer according to the first aspect of the present invention;

FIG. 8 is a schematic diagram showing an embodiment of a printer according to a second aspect of the present invention;

FIG. 9 is a schematic diagram showing another embodiment of the printer according to the second aspect of the present invention;

FIG. 10 is a schematic diagram showing another embodiment of the printer according to the second aspect of the present invention;

FIG. 11 is a schematic diagram showing another embodiment of the printer according to the second aspect of the present invention;

FIG. 12 is a schematic diagram showing another embodiment of the printer according to the second aspect of the present invention; and

FIG. 13 is a schematic diagram showing another embodiment of the printer according to the second aspect of the present invention.

### DETAILED DESCRIPTION OF THE PREFERRED EMBODIMENTS

Hereinafter, a printer and an image forming method according to the present invention will be described in detail based on preferred embodiments shown in the attached drawings.

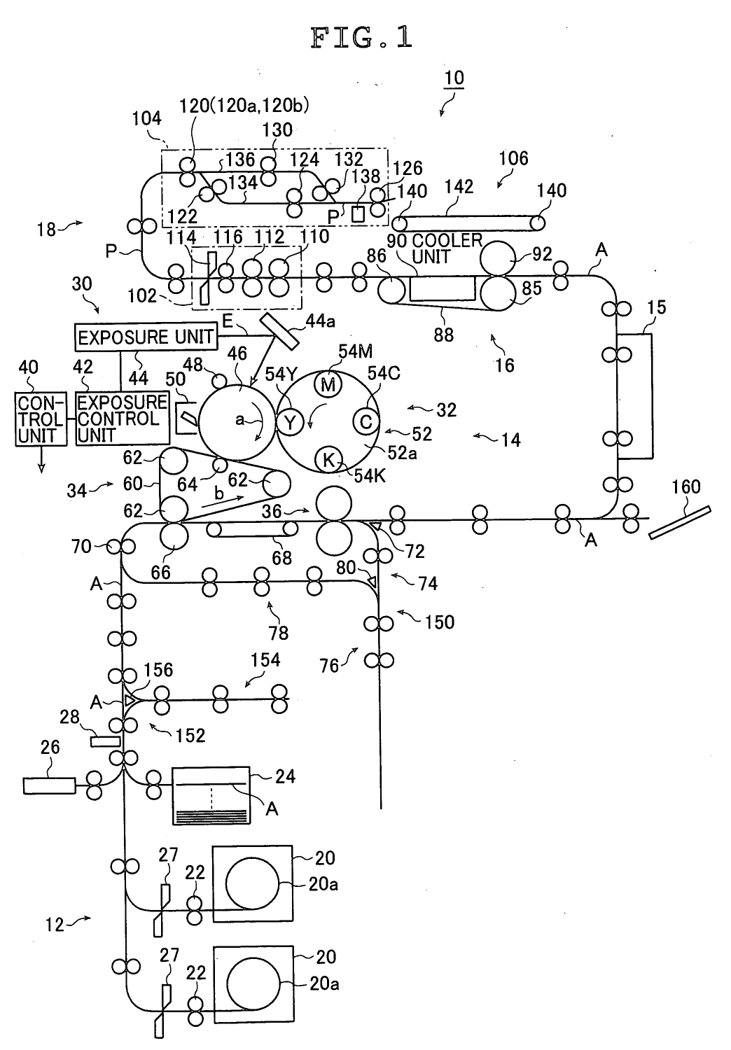

First, with reference to FIGS. 1 to 7, a description will be made of a printer and an image forming method according to a first aspect of the present invention.

FIG. 1 is a schematic diagram showing an embodiment of the printer which implements the image forming method according to the present invention.

A printer 10 shown in FIG. 1 records an image on a recording sheet A (i.e., image recording medium) by an electrophotographic process, in other words, transfers a toner image formed by the electrophotographic process onto an image receiving medium as an image to thereby produce a print or prints P. The printer 10 basically includes a recording sheet supplying unit (hereinafter, referred to simply as “supplying unit”) 12, an image recording unit 14, a position adjusting unit 15, a surface treatment section 16, and a cutting/arranging unit 18. In addition, a first reversing unit 150 is provided in the image recording unit 14, and a second reversing unit 152 is provided in a transport path provided downstream of the supplying unit 12 (i.e., between the supplying unit 12 and the image recording unit 14).

Note that in the printer 10, various members generally arranged in a known printer, for example, transporting means for the recording sheet A such as a transport roller pair or a guide member, and a sensor for detecting jamming or the recording material A, are provided in the respective parts or between the respective parts if needed, even when the members are not particularly shown or not denoted by reference symbols.

Further, in order to cause the printer 10 to execute the image forming method of the present invention and the like, the printer 10 is connected to control means (not shown) for separately controlling operations of the printer 10, that is, controlling the respective parts including, not only the supplying unit 12, the image recording unit 14, the surface treatment section 16, the position adjusting unit 15, and the cutting/arranging unit 18 of the printer 10, but also the first reversing unit 150 provided in the image recording unit 14 and the second reversing unit 152 provided between the supplying unit 12 and the image recording unit 14, both of which characterize the present invention, and components or operations thereof. The printer 10 is also provided with a control unit 40 for controlling the entirety of the printer 10 including the individual parts, the components, and the control means thereof.

The printer 10 records an image according to the size of a print to be outputted on the recording sheet A, and then cut the recording sheet A into the print size, thereby producing (finished) prints. In addition, in the illustrated example, so-called multiple-image allocation, in which a plurality of images such as two images or four images are allocated to one recording sheet A, is performed if needed, and then the recording sheet A is cut into the print size, thereby producing a plurality of prints from one recording sheet A.

Note that in the printer 10, to prevent staining on the apparatus due to unfixed toner, it is preferable to form an image on the recording sheet A with a margin on the periphery of the recording material A (i.e., leading and trailing edges thereof in the transport direction, and both edges thereof in a direction perpendicular to the transport direction).

In the following description, the width direction means the direction perpendicular to the transport direction of the recording sheet A, and the size of the recording sheet A in the width direction is called the width. Further, the size of the recording sheet A in the transport direction will be called the length. In addition, the leading edge and the trailing edge of the recording sheet A are description with regard to the transport direction.

The recording sheet supplying unit 12 is arranged at a lower part on one side of the printer 10, that is, at a lower right part of the illustrated example. The supplying unit 12 supplies a recording cut-sheet A to the image recording unit 14 arranged at an upper part thereof.

As shown in the illustrated example, the supplying unit 12 includes two loading units of magazines 20 containing recording sheet rolls 20a formed by rolling the long recording sheet A, a loading unit of a cassette 24 containing the recording cut-sheets A, a manual feeding unit 26, and front/back surface discriminating means 28.

Note that the supplying unit 12 also includes, as shown in the illustrated example, predetermined transporting means for transporting the recording sheet A from the supplying unit 12 to the image recording unit 14 arranged at the upper part thereof, and transporting means such as a transport roller pair which constitutes a vertical transport path for upwardly transporting the recording sheet A from the supplying unit 12 to the image recording unit 14.

In the illustrated example, the two loading units of the magazines 20 are arranged at the lowest part of the supplying unit 12, and are arranged in a vertical direction on a right side of the above-mentioned vertical transport path. The loading unit of the cassette 24 is arranged at an upper part of the loading units of the magazines 20.

In general, in the respective loading units of the magazines 20, the recording sheet rolls 20a whose widths are different from each other (i.e., having different sizes) are contained. On the other hand, the cassette 24 is a case containing the recording sheet A to load it to the printer 10, and is used in the same manner as in various printers.

The recording sheet A is not particularly limited thereto, and not only so-called plain paper, that is, a recording sheet having no image recording layer, both surfaces of which are subjected to surface treatment, but also various types of recording sheets (i.e., image receiving medium) used in electrophotographic printers including a sheet for a photographic-image-quality print to be mentioned below can be used.

Note that in the printer 10 according to the present invention, the recording sheet A having the image recording layer, only one surface of which is subjected to the surface treatment, is preferably used. In particular, more preferably used is a recording sheet (which is referred to as “sheet for a photographic-image-quality print” according to this aspect) having a transparent resin layer composed of a thermoplastic resin, which is formed on one surface of a base material made of paper or the like, as the image recording layer, and capable of producing a print having a photographic image quality and having high gloss by being subjected to surface treatment. The recording sheet roll 20a having a long length which is the sheet for a photographic-image-quality print wound in a roll shape, may be wound with the transparent resin layer being outside, or may be wound with the transparent resin layer being inside.

After the toner image has been formed on the transparent resin layer of the recording sheet A, heat and pressure are applied to the recording sheet A (which may be performed also as fixing of the toner image) by using a belt or the like having high surface smoothness, and the surface property of the belt or the like is transferred onto the recording sheet A by melting/cooling/coagulating the transparent resin layer, thereby making it possible to produce a print or prints with a high gloss equivalent to a photographic print (see the above-described patent document 1, JP 05-216322 A, and the like).

The thermoplastic resin of which the transparent resin layer is made is not particularly limited, and preferred examples thereof includes a polyester resin, a polyethylene resin, a styrene-acrylic ester resin. Further, the thickness of the transparent resin layer is also not particularly limited, but the thickness of the transparent resin layer is preferably set in a range of 5 to 20 μm in view of preventing stress strain (i.e., bending strain) after the surface treatment from causing cracking.

Note that in the respective loading units, detecting means and reading means (not shown) are arranged. The detecting means detects a width (i.e., size) of each of the recording sheet rolls 20a contained in the magazines 20, a size (i.e., width×length) of the recording sheet A contained in the cassette 24, a type of the recording sheet A, that is, the sheet for a photographic-image-quality print having the image recording layer such as the transparent resin layer adapted for the surface treatment formed on one surface thereof, ordinary plain paper, or the like. The reading means reads out the type of the recording sheet.

Note that the detecting means and the reading means are not particularly limited, and any known means used in various types of printers, for example, means for utilizing a DIP switch, means for utilizing a bar-code, and means for reading out information from a memory mounted on the magazines 20 or the cassette 24, can be used.

Drawing-out roller pairs 22 and cutters 27 are arranged at a horizontal transport path for the recording sheet downstream in the transport direction of the recording sheet A (hereinafter, referred to simply as “downstream”) which is provided for the respective magazines 20 loaded into the loading units.

The drawing out roller pairs 22 draw out the recording sheets each having a long length in a substantially horizontal direction from the recording sheet rolls 20a contained in the magazines 20. The cutters 27 are known cutting means for a sheet-like material such as guillotine cutters that cut the long recording sheet drawn out by the drawing-out roller pair 22 to obtain the recording cut-sheet A.

Drawing-out of the recording sheet from the recording sheet rolls 20a by the drawing-out roller pair 22 is stopped at a time point when the recording sheet transported on the downstream side (i.e., on the above-mentioned horizontal transport path and vertical transport path connected thereto) of the cutters 27 has a predetermined length. Subsequently, the cutters 27 cut the recording sheet to obtain the recording cut-sheet A having the predetermined size, and supply the recording cut-sheet A to the transport means such as the transport roller pair constituting the above-mentioned vertical transport path as shown in the illustrated example.

The recording sheet A contained in the cassette 24 loaded into the loading unit is drawn out by known means used in various printers, and is supplied to the above-mentioned transport roller pairs and the like of the vertical transport path in the illustrated example.

The manual feeding unit 26 supplies the recording cut-sheet A from the outside of an apparatus housing of the printer 10 to predetermined transport means, in the illustrated example, the above-mentioned transport roller pairs and the like of the vertical transport path. In the illustrated example, the manual feeding unit 26 is a known manual feeding unit provided in various printers, which is arranged upward of the loading unit of the cassette 24 on a left side of the vertical transport path, and which includes an inlet for inserting the recording sheet A and tray transport means.

Note that according to the present invention, arrangement of the magazines 20, the cassette 24, and the manual feeding unit 26 is not particularly limited to the illustrated example. Alternatively, any arrangement thereof may be adopted as long as the magazines 20, the cassette 24, and the manual feeding unit 26 are arranged upstream of the second reversing unit 152.

In the printer 10, the recording sheet A having the image recording layer (e.g., transparent resin layer in the case of the sheet for a photographic-image-quality print) only on one surface thereof, such as the sheet for a photographic-image-quality print, is preferably contained in the magazines 20 or the cassette 24 such that the image recording layer faces (i.e., faces upward in the drawing) a transfer belt 60 of a transferring unit 34 in the image recording 14.

Accordingly, in the printer 10 of the illustrated example, the recording sheet roll 20a having the image recording layer is wound with the image recording layer facing outside, and the recording sheet A having the image recording layer is contained in the cassette 24 with the image recording layer facing downward.

In the illustrated example, information on the respective recording sheet rolls 20a contained in the two magazines 20 loaded into the magazine loading units of the supplying unit 12 is automatically read out from (a DIP switch, a bar-code, or a memory of) the magazines 20 to the control unit 40 by the above-mentioned detecting means and the reading means (not shown) at the time when the magazines are loaded. Alternatively, the information is inputted to the control unit 40 by an operator. Such information contains surface types of the recording sheet rolls 20a, for example, plain paper or the above-mentioned sheet for a photographic-image-quality print, and sizes (i.e., widths) thereof. As a result, it is basically possible to select the recording sheet roll 20a suitable for a condition of the size of the print to be outputted or the surface type thereof according to the need of the surface treatment such as gloss treatment to obtain a photographic image quality.

However, it is usually difficult to acquire information on the type of the recording sheet A such as the surface type, while with regard to the recording cut-sheet A contained in the cassette 24 loaded into the cassette loading unit or the recording sheet A fed from the manual feeding unit 26, there is a method in which the control unit 40 automatically acquires information on the size such as the width by, for example, a method in which the recording sheet A having the predetermined size is contained in the predetermined cassette loading unit. In addition, also in the case of the above-mentioned magazines 20, an error may be caused when the information is read out or inputted.

As a result, in the printer 10 according to the present invention, the front/back surface discriminating means 28 is arranged on the transport path (i.e., the above-mentioned vertical transport path) for the recording sheet A in the supplying unit 12. In other words, the front/back surface discriminating means 28 is provided in the vertical transport path for the recording sheet A downstream (i.e., upward in the drawing) of the manual feeding unit 26 of the supplying unit 12 and on a left side of the vertical transport path.

Thus, the front/back surface discriminating means 28 measures the state of a surface (hereinafter, referred to as “transfer surface”) which faces the transfer belt 60 (which indicates a state where both surfaces are in contact with each other) of the transferring unit 34 in the image recording unit 14, that is, the state of a surface receiving image by transfer and, of both surfaces of the recording sheet A supplied from the magazines 20, the cassette 24, or the manual feeding unit 26. For example, the front/back surface discriminating means 28 measures glossiness of the transfer surface to discriminate whether or not the transfer surface of the recording sheet A is the image recording layer such as the transparent resin layer, that is, to detect and discriminate the surface type of the transfer surface of the recording sheet A, from the measurement result. As a result, the front/back surface discriminating means 28 can discriminate whether or not the transfer surface of the recording sheet A is oriented in a direction appropriate for the image recording or surface treatment.

For example, the front/back surface discriminating means 28 measures, for example, glossiness of the surfaces of the recording sheet A when the above-mentioned sheet for a photographic-image-quality print is used as the recording sheet A. From the measurement result, the front/back surface discriminating means 28 discriminates the surface of the image recording layer (e.g., front surface) and the plain paper surface (e.g., back surface) of the recording sheet A, and further discriminates whether or not the recording sheet A, that is, the transfer surface thereof is oriented in an appropriate direction in which it is possible to record the image and perform the surface treatment in the image recording unit 14 without changing the direction, that is, discriminates the front and back surfaces of the recording sheet A. In the illustrated example, when the sheet for a photographic-image-quality print is used as the recording sheet A, a state where the transparent resin layer faces the front/back surface discriminating means 28 corresponds to a state where the front and back surfaces of the recording sheet A are oriented to the appropriate directions.

Note that measurement of glossiness by the front/back surface discriminating means 28 may be performed by a known method such as measurement by using a glossiness sensor or the like, and by using known means. Accordingly, the front/back surface discriminating means 28 may perform discrimination of the surface type as to whether the transfer surface which is a measuring surface of the recording sheet A is the image recording layer directly from the level of the measured glossiness. Alternatively, the front/back surface discriminating means may only need acquisition of the measurement result of the glossiness. In this case, discrimination of the surface type of the measuring surface of the recording sheet A may be performed directly by the control unit 40 (including control means of the respective components) of the printer 10 from the measurement result of the acquired glossiness. In the case where the discrimination of the surface type of the measuring surface of the recording sheet A is performed directly by the control unit 40 in the above-mentioned manner, it may be discriminated whether or not the recording sheet A is appropriately oriented.

Herein, the discrimination of the surface type of the measuring surface of the recording sheet A is performed by using the measurement result, but the present invention is not limited thereto. Alternatively, discrimination of the orientation of the measuring surface of the recording sheet A may be performed by detecting only a difference between the predetermined glossiness and the measured glossiness, or the surface type of the measuring surface of the recording sheet A may be detected directly from a difference such as surface reflectance.

The front/back surface discriminating means 28 discriminates whether or not the transfer surface which is the measuring surface of the recording sheet A is the image recording layer, that is, performs discrimination of the surface type only of the measuring surface of the recording sheet A. As described above, in some cases, the type of the recording sheet A is discriminated in advance when the recording sheet A is supplied from the magazines 20 or the cassette 24. In this case, it is also possible to discriminate the surface type of a non-transfer surface which is the non-measuring surface of the recording sheet A.

For example, when the sheet for a photographic-image-quality print is used as the recording sheet A, in a case where the front/back surface discriminating means 28 has discriminated that the transfer surface of the recording sheet A corresponds to the image recording layer as the front surface, the non-transfer surface of the recording sheet A can be discriminated as the plain paper surface, which is not the image recording layer but is the back surface. In a case where the front/back surface discriminating means 28 has discriminated that the transfer surface of the recording sheet A is the plain paper surface as the back surface, the non-transfer surface of the recording sheet A can be discriminated as the image recording layer as the front surface. As a result, the front/back surface discriminating means 28 discriminates the front and back surfaces of the recording sheet A. In a case where the front/back surface discriminating means 28 has discriminated that the transfer surface of the recording sheet A is the plain paper surface, when the recording sheet A is the plain paper, the front/back surface discriminating means 28 can discriminate that the non-transfer surface of the recording sheet A is also the plain paper surface.

As described above, the front/back surface discriminating means 28 can discriminate the surface types of both surfaces of the recording sheet A in a case where the type of the recording sheet A is already known. Thus, according to the present invention, the discrimination of the surface type of the recording sheet means the discrimination of the front and back surfaces of the recording sheet A considering the case of the sheet for a photographic-image-quality print.

In the printer 10, when the sheet for a photographic-image-quality print is used as the recording sheet A, in a case where the front and back surfaces of the recording sheet A are not appropriately oriented, reversal of the recording sheet performed in the second reversing unit 152 to be described later is controlled based on the discrimination result from the front/back surface discriminating means 28.

To be specific, in producing a one-side print by using the sheet for a photographic-image-quality print as the recording sheet A, in a case where the front and back surfaces of the recording sheet A are appropriately oriented (i.e., the image recording surface), the recording sheet A is not reversed in the second reversing unit 152, and the recording sheet A is directly transported to the image supplying unit 14. On the other hand, in a case where the recording material A is inappropriately oriented (i.e., the plain paper surface), the recording sheet A is reversed in the second reversing unit 152, and then the recording sheet A is supplied to the image recording unit 14. Similarly, in producing a two-side print by using the sheet for a photographic-image-quality print, in a case where the front and back surfaces of the recording material A are inappropriately oriented (i.e., the plain paper surface), the recording sheet A is not reversed in the second reversing unit 152, and the recording sheet A is directly supplied to the image recording unit 14. While, in a case where the recording sheet A is appropriately oriented (i.e., the image recording surface), the recording sheet A is reversed in the second reversing unit 152, and then the recording sheet A is supplied to the image recording unit 14.

Thus, the recording sheet A cut into the predetermined size with the cutters 27, the recording sheet A drawn out from the cassette 24, and the recording sheet A supplied from the manual feeding unit 26 are directly transported to the image recording unit 14 provided at the upper part thereof by the transport roller pairs constituting the vertical transport path in the following cases, that is, in performing plain-paper printing or producing a photographic-image-quality print, in a case where the direction of the recording sheet A has been discriminated as appropriate (i.e., the image recording surface) by the front/back surface discriminating means 28 when one-side printing is performed, or in a case where the direction of the recording sheet A has been discriminated as inappropriate (i.e., the plain paper surface) by the front/back surface discriminating means 28 when two-side printing is performed. Meanwhile, in a case where the direction of the recording sheet A has been discriminated as inappropriate (i.e., the plain paper surface) when the one-side printing is performed, or in a case where the direction of the recording sheet A has been discriminated as appropriate (i.e., the image recording surface) when the two-side printing is performed, the recording sheet A is reversed in the second reversing unit 152, and then the recording sheet A is transported to the image recording unit 14 by the above-mentioned transport roller pairs as described above.

In this case, in the printer 10 according to this aspect is provided with the second reversing unit 152 between the supplying unit 12 and the image recording unit 14 (i.e., first reversing unit 150).

The second reversing unit 152 reverses the recording sheet A to set the back surface as the surface adapted for the image recording in the image recording unit 14 described later when a so-called two-side print is produced. In printing the two-side print, two images are recorded on both sides of the sheet for a photographic-image-quality print (i.e., recording sheet having the image recording layer such as the transparent resin layer formed on only one surface thereof which is adapted for the surface treatment performed in the surface treatment section 16 to be described later).

In the illustrated example, the second reversing unit 152 is reversing means for reversing the recording sheet A by so-called switch-back in which the recording sheet A is drawn into a branch path from the vertical transport path which is provided upward from the supplying unit 12 to the image recording unit 14, and the recording sheet A is transported downstream of the straight transport path by reversely transporting the recording sheet A on the branch path, thereby reversing the recording sheet A. The second reversing unit 152 includes a reverse transport path 154 and switching means 156 of the transport path for the recording A.

The reverse transport path 154 has a substantially Y-shaped form at which two transport paths merge to reverse the recording sheet A by switch-back. The reverse transport path 154 includes, similarly to the ordinary transport path for a sheet-like material, a transport roller pair, and a transport guide. The transport roller pair can rotate in forward and backward directions. The reverse transport path 154 is arranged such that an end portion on a branched portion (i.e., upper end of Y-shape) is connected to the transport path for the recording sheet A which extends from the supplying unit 12 to the image recording unit 14.

The switching means 156 is known switching means of the transport path for a sheet-like material, such as a flapper, which operates on (i.e., inserted into) the transport path to guide the recording sheet A along the predetermined transport path.

As described above, the second reversing unit 152 reverses the recording sheet A based on the discrimination result from the front/back surface discriminating means 28 when the one-side printing or the two-side printing is performed by using the sheet for a photographic-image-quality print as the recording sheet A.

Herein, in a case where the discrimination result from the front/back surface discriminating means 28 is appropriate (i.e., the image recording surface of the recording sheet A faces the side for recording and surface treatment without reversal of the recording sheet A) when the two-side printing is performed, the switching means 156 is caused to operate on the transport path extending from the supplying unit 12 to the image recording unit 14 to thereby draw the recording sheet A into the reverse transport path 154 when the recording sheet A is reversed in the second reversing unit 152.

At a time point when the trailing edge of the recording sheet A reaches the downstream of the branch point of the reverse transport path 154, transportation of the recording sheet A on the reversing transport path 154 is stopped, and then the switching means 156 is switched so as to guide the recording sheet A into the transport path extending from the reverse transport path 154 to the image recording unit 14.

After the switching means 156 has been switched, the recording sheet A is reversed by being transported in a direction opposite to the former direction on the reverse transport path 154 and further transported to the transport path extending from the reverse transport path 154 to the image recording unit 14, and is supplied to the image recording unit 14. As a result, the recording sheet A which is the sheet for a photographic-image-quality print is transported to the image recording unit 14 with the back surface (i.e., plain paper surface) being the surface adapted for the image recording, that is, the transfer surface.

Note that in the printer 10, when the one-side printing is performed by using the sheet for a photographic-image-quality as the recording sheet A, even in a case where the discrimination result from the front/back surface discriminating means 28 is inappropriate (i.e., the plain paper surface), the recording sheet A is reversed in the second reversing unit 152, and is transported to the image recording unit 14 with the front surface (i.e., image recording surface) being the transfer surface, in the same manner as described above.

As a result, in the printer 10, it is basically unnecessary to reverse the recording sheet A in the second reversing unit 152 except for the above-mentioned cases, and the recording sheet A is transported from the supplying unit 12 to the image recording unit 14 passing straight through the second reversing unit 152.

The image recording unit 14 is a portion for forming an image on the recording sheet A by the electrophotographic process, and includes an exposure unit 30, a toner image forming unit 32, the transferring unit 34, a primary fixing roller pair 36, and the first reversing unit 150.

The exposure unit 30 includes an exposure control unit 42 and an exposure unit 44.

The exposure control unit 42 acquires from an image supply source an image or images (i.e., image data) to be reproduced on a print or prints and performs the predetermined image processing thereon. After that, the exposure control unit 42 allocates images to one recording sheet A according to the number of images (i.e., the number of surfaces) to be recorded on the recording sheet A, thereby obtaining the images to be recorded on one recording sheet A. The exposure control unit 42 is connected to the control unit 40. The control unit 40 controls not only an exposing operation performed by the exposure unit 44 which is controlled by the exposure control unit 42, but also operations of the toner image forming unit 32, the transferring unit 34, the primary fixing roller pair 36, and the first reversing unit 150.

On the other hand, the exposure unit 44 is a known light beam scanning optical system including a light source of a light beam (i.e., recording light) E used for exposing an electrophotographic photosensitive drum 46 of the toner image forming unit 32, a light deflector, an fθ lens, a mirror for changing an optical path, and a lens for adjusting a light beam, which are described later.

In other words, the exposure unit 44 emits the light beam E modulated according to the image data (i.e., image to be recorded) supplied from the exposure control unit 42. The light beam E is deflected in a main scanning direction parallel to the width direction (i.e., direction perpendicular to the transport direction (i.e., rotation direction of the electrophotographic photosensitive drum 46)) and reflected on a mirror 44a to be incident on a predetermined exposing position, thereby recording a latent image on the electrophotographic photosensitive drum 46.

The toner image forming unit 32 is a known portion for forming a toner image by the electrophotographic process, and includes the electrophotographic photosensitive drum (hereinafter, referred to as “photosensitive drum”) 46, charging means 48, cleaning means 50, and toner supplying means 52.

The photosensitive drum 46 is a known electrophotographic photosensitive drum, and rotates in a direction indicated by the arrow a (i.e., direction opposite to the transport direction of the recording sheet A) about its central axis parallel to the width direction. As described above, the light beam E emitted from the exposure unit 44 is deflected in the width direction, so the photosensitive drum 46 is two-dimensionally scanned by exposure to the light beam E modulated according to the recorded image.

The toner supplying means 52 includes four toner supplying units, that is, a cyan (C) toner supplying unit 54C, a magenta (M) toner supplying unit 54M, a yellow (Y) toner supplying unit 54Y, and a black (K) toner supplying unit 54K, at intervals with a rotational angle of 90°.

The transferring unit 34 includes the transfer belt 60 which is an endless belt and a part of which is abutted against the photosensitive drum 46, three rollers 62 around which the transfer belt 60 is stretched, a pressing roller 64 for pressing the transfer belt 60 against the photosensitive drum 46 from the inside of the transfer belt 60, a transfer roller 66, and a belt conveyer 68. The transfer belt 60 is an intermediate transferring member for a toner image, and rotates in a direction indicated by the arrow b (i.e., the direction as the transport direction of the recording sheet A). In addition, the transfer roller 66 is movable between a position where the transfer roller 66 nips the transfer belt 60 (i.e., recording sheet A) with one of the rollers 62, and a position where the transfer roller 66 is spaced apart from the transfer belt 60.

The photosensitive drum 46 is uniformly charged in the width direction by the charging means 48 while rotating in the direction indicated by the arrow a of FIG. 1, and is two-dimensionally scanned by exposure to the light beam E modulated according to the image data as described above, thereby forming an electrostatic latent image. Subsequently, the electrostatic latent image is developed in the toner supplying unit arranged at an exposing position (i.e., position where the toner supplying unit faces the photosensitive drum 46) of the toner supplying means 52, for example, the Y toner supplying unit 54Y, thereby forming a Y toner image on a surface of the photosensitive drum 46.

Further, the transfer belt 60 a part of which is brought into contact with the photosensitive drum 46 and pressed by the pressing roller 64 rotates in the direction indicated by the arrow b in synchronization with the rotation of the photosensitive drum 46. As a result, the toner image on the photosensitive drum 46 which was developed by the toner supplying means 52 is transferred onto the transfer belt 60 in a contact portion (i.e., portion pressed by the pressing roller 64). In a region where the transfer of the toner image of the photosensitive drum 46 onto the transfer belt 60 is completed, residual toner is removed by the cleaning means 50.

In the illustrated example, formation of the toner image and transfer of the toner image onto the transfer belt 60 are performed by sequentially operating four toner supplying units, that is, the Y toner supplying unit 54Y, the M toner supplying unit 54M, the C toner supplying unit 54C, and the K toner supplying unit 54K.

For example, as described above, a Y toner image is transferred onto the transfer belt 60, and then the toner supplying means 52 (i.e., main body 52a) is rotated by 90° in a direction indicated by the arrow, thereby positioning the M toner supplying unit 54M at the developing position. Then, a latent image for an M toner image is formed on the photosensitive drum 46 in the same manner so that the formed Y toner image is in register with the M toner image to be formed, thereby forming the M toner image, and then the M toner image is transferred onto the transfer belt 60. After that, in the same manner as described above, a C toner image is transferred onto the transfer belt 60, and a K toner image is transferred onto the transfer belt 60. During the process, the transfer roller 66 is spaced apart from the transfer belt 60.

Thus, in the illustrated example, the Y, M, C, and K toner images are formed on the surface of the transfer belt 60 while registration is performed, in other words, a four- (i.e., full-) color image is formed.

On the other hand, the recording cut-sheet A having the predetermined size is supplied from the supplying unit 12, and the recording sheet A is reversed in the second reversing unit 152 if needed. Then, for example, the recording sheet A is on stand by at a registration roller, pair 70 immediately upstream of the transfer roller 66.

After the color image has been formed on the transfer belt 60, transportation of the recording sheet A by the registration roller pair 70 is started in timing for the rotation of the transfer belt 60 so as to perform registration of the color image formed on the transfer belt 60 with respect to the recording sheet A. And at the same time, the transfer roller 66 is pressed against the transfer belt 60 (i.e., rollers 62), and the transfer belt 60 and the transfer roller 66 nip and transport the recording sheet A. The recording sheet A being thus nipped and transported, the four color toner images, which are formed on the surface of the transfer belt 60, are transferred onto the recording sheet A, thereby forming the image on the surface of the recording sheet A.

As described above, the image is divided according to the number of images to be recorded.

The recording sheet A having the image formed thereon is transported to the primary fixing roller pair 36 by the belt conveyer 68.

The primary fixing roller pair 36 is a transport roller pair at least one of which is a heating roller. The primary fixing roller pair 36 may be in a nipped state or a released state if needed by a method, for example, in which the roller on the image forming surface side is allowed to move up and down.

In the same manner as in fixing the formed image in the general electrophotographic process, the transferring unit 34 of the primary fixing roller pair 36 nips the recording sheet A on which the toner image has been transferred to form an image thereon and applies heat and pressure to the toner image to fix it as the image on the recording sheet A.

In the printer 10 according to the present invention, the image recording method is not limited to the electrophotographic process as in the illustrated case, and any known image recording method can be used.

As an example, it is possible to use an image recording method carried out by various known printers (i.e., printing means) such as a printer which has a thermal development process and uses a photosensitive thermal-development photosensitive material for transferring and forming an image on an image receiving medium in the presence of an image forming solvent such as water; an ink jet printer; and a thermal printer using a thermal head. Also in the case of using those image recording methods, the following recording sheet A (i.e., image recording medium such as an image recording medium) is suitably used. That is, the recording sheet A has an image recording layer (e.g., image receiving layer for ink jet recording) formed only on one surface thereof, and the image recording layer is subjected to the surface treatment such as heating/pressurization and laminating for the transparent resin layer if needed.

The first reversing unit 150 reverses the recording sheet A on which the image has been fixed by the primary fixing roller pair 36 to produce a so-called two-side print both surfaces of which have images recorded thereon. Then, the first reversing unit 150 supplies again the recording sheet A to the upstream of the registration roller pair 70 (i.e., transferring unit 34).

In the illustrated example, the first reversing unit 150 includes a first switching means 72, which is arranged downstream of the primary fixing roller pair 36, a branch transport path 74, which branches from the transport path extending from the primary fixing roller pair 36, a reverse transport path 76, which is provided downstream of the branch transport path 74, a return transport path 78, which branches from the reverse transport path 76 and extends to the registration roller pair 70 provided upstream of the transferring unit 34, and a second switching means 80, which is provided at the branch point between the reverse transport path 76 and the return transport path 78.

The first switching means 72 and the second switching means 80 are known switching means provided in the transport path for sheets, such as a flapper for acting on the transport path to guide the recording sheet A to the predetermined transport path.

In addition, the individual transport paths are known transport means for sheets, and include transport roller pairs and transport guides. The reverse transport path 76 can transport the recording sheet A in forward and backward directions.

The first reversing unit 150 is reversing means for reversing the recording sheet A by switch-back, as in the above-mentioned second reversing unit 152.

In the printer 10, when the two-side print is produced, the first switching means 72 is caused to operate on the transport path extending from the primary fixing roller pair 36 to transport to the branch transport path 74 the recording sheet A on which the image has been fixed by the primary fixing roller 36. After that, the recording sheet A is transported from the branch transport path 74 to the reverse transport path 76, and at the time point when the trailing edge of the sheet A reaches the downstream of the second switching means 80, the transportation of the recording sheet A is stopped.

Then, the second switching means 80 is caused to operate on the reverse transport path 76 to transport the recording sheet A in a direction opposite to the former direction on the reverse transport path 76. After that, the recording sheet A is guided by the second switching means 80 to be transported to the return transport path 78, and is further transported from the return transport path 78 to the registration roller pair 70, thereby reversing the recording sheet.

The thus reversed recording sheet A is supplied again to the image recording unit 14 (i.e., transferring unit 34), and the image is recorded and fixed on both surfaces of the recording sheet A.

The recording sheet A on which the image has been fixed by the primary fixing roller pair 36 is subsequently transported to the position adjusting unit 15, and thereafter is transported to the surface treatment section 16.

The position adjusting unit 15 is a portion for moving the recording sheet A on which the image was formed in the image recording unit 14, in the width direction if needed, and, for example, changing the position of the recording sheet A in the width direction which is supplied to the surface treatment section 16 for each order.

As described later, in the printer 10, after the surface treatment section 16 performs the surface treatment, the cutting unit 102 cuts the recording sheet A in the width direction and in the transport direction thereby obtaining the prints P. The position adjusting unit 15 adjusts the position of the recording sheet A in the width direction so that a first slitter 110 and a second slitter 112 for cutting the recording sheet A in the transport direction in the cutting unit 102 are placed in the reference positions.

Further, as described later, in the surface treatment section 16, the recording sheet A is pressed/heated against the surface treatment belt 88 which is an endless belt, is cooled while being transported on the surface treatment belt 88 with the sheet being slightly adhered to the surface treatment belt 88, and is then detached from the surface treatment belt 88, thereby performing the surface treatment for putting a gloss thereon.

In the printer 10, the position adjustment of the recording sheet A in the width direction is also performed as registration for regulating an abutting position of the recording sheet A in the width direction on the surface treatment belt 88. When the recording sheet A is abutted against only a particular area on the surface treatment belt 88, only the particular area, against which the recording sheet A is abutted, of the surface treatment belt 88 deteriorates. In particular, particular positions against which the edges (i.e., edge portions) of the recording sheet A are abutted are damaged. In order to solve such inconveniences, the position adjusting unit 15 slightly changes, if needed, the position of the recording sheet A in the width direction on which the image has been formed, thereby preventing the recording sheet A from abutting against only the particular area on the surface treatment belt 88.

In the position adjusting unit 15, moving means (i.e., position adjusting means) for moving the recording sheet A in the width direction is not particularly limited thereto, and various known moving means for a sheet-like material can be used.

Illustrated as examples thereof are: moving means for pressing and moving the recording sheet A in the width direction by using pressing and moving means; moving means for regulating the position of the recording sheet A by being abutted against an edge (i.e., edge portion in the width direction) of the recording sheet A, and setting a position of the recording sheet A in the width direction to a predetermined position by using a guide member capable of changing positions in the width direction; moving means for moving in an axis line direction by using a transport roller pair while nipping the recording sheet A; moving means for holding the recording sheet A by using holding means such as a suction cup, and releasing holding of the recording sheet A by the holding means after moving the holding means in the width direction; and the like.

The recording sheet A having the position in the width direction set to the predetermined position in the position adjusting unit 15 is then transported to the surface treatment section 16 arranged downstream thereof.

When a high-quality print with a gloss or the like equivalent to a silver-salt photography is produced by using the above-mentioned sheet for a photographic-image-quality print as the recording sheet A, the surface treatment section 16 performs the surface treatment (or further performs secondary fixing) of the recording sheet A. To be specific, the surface treatment section 16 abuts the surface treatment means against the front surface (i.e., image forming surface) of the recording sheet A by using the belt-like surface treatment means to be pressed/heated, and then cools the front surface of the recording sheet A, thereby performing the surface treatment for the front surface of the recording sheet A.

Note that in the print production using plain paper, the surface treatment and the fixation in the surface treatment section 16 is not required in general, so the recording sheet A is allowed to pass through the surface treatment section 16 without being subjected to any treatment. Alternatively, when subsequent cutting operation in the cutting/arranging unit 18 is unnecessary, the recording material A may be outputted as a print to a plain paper discharge tray 160 immediately after the fixing of the image performed by the primary fixing roller pair 36 is completed.

However, according to the present invention, the following surface treatment may be applied not only to the sheet for a photographic-image-quality print, but also to various recording sheets A such as plain paper, if necessary.

In the illustrated example, the surface treatment section 16 includes a heating roller 85, a roller 86, a surface treatment belt 88 which is an endless belt suspended by the heating roller 85 and the roller 86, a cooler unit 90, and a nip roller 92.

The surface treatment belt 88 is a belt serving as surface treatment means, and has an extremely high smoothness of the front surface (i.e., outer surface). The heating roller 85 generates heat to a temperature corresponding to heating of the recording sheet A. The cooler unit 90 cools the surface treatment belt 88 by abutting against an inner surface of the surface treatment belt 88, thereby cooling the recording sheet A to be transported by the surface treatment belt 88. Further, the nip roller 92 abuts and is pressed against the surface treatment belt 88 at a position corresponding to the heating roller 85, thereby pressing the recording sheet A against the surface treatment belt 88 and nipping and transporting the recording sheet A together with the surface treatment belt 88.

Note that the heating means for the heating roller 85 and the cooler means for the cooler unit 9Q are not particularly limited thereto, and any known means can be used.

As is apparent from FIG. 1, the recording sheet A on which the image has been recorded (i.e., transferred)/fixed is transported to the surface treatment section 16 with the surface, on which the image is last recorded, facing the surface treatment belt 88 side.

In the surface treatment section 16, the recording sheet A is first nipped and transported by the surface treatment belt 88 (i.e., heating roller 85) and the nip roller 92, and the front surface (i.e., front surface of the transparent resin layer of the above-mentioned sheet for a photographic-image-quality print) of the recording sheet A is abutted and pressed against the front surface of the surface treatment belt 88, thereby heating the recording sheet A by the heating roller 85.

The recording sheet A being thus heated/pressed, the transparent resin layer is melted to be in a state of slightly adhering to the surface treatment belt 88, and the recording sheet A is transported by the surface treatment belt 88. In the surface treatment section 16, the recording sheet A is cooled by the cooler unit 90 during the transportation, thereby coagulating the melted transparent resin layer.

The cooled recording sheet A is detached from the surface treatment belt 88 at a returning portion by the roller 86, and is supplied downstream.

The transparent resin layer (i.e., thermoplastic resin) of the front surface of the recording sheet A is pressed against the surface treatment belt 88 to be heated/melted as described above, and is then cooled/coagulated while being transported. As a result, the surface property of the surface treatment belt 88 is transferred thereon. As described above, the surface treatment belt 88 has an extremely high surface smoothness. For this reason, the recording sheet A on which the surface property of the surface treatment belt 88 has been transferred has high surface smoothness and a preferable gloss. Accordingly, it is possible to obtain a print equivalent to a silver-salt photographic print.

Further, according to the surface treatment of the recording sheet A, the surface property of the surface treatment belt 88 is selected, thereby making it possible to perform not only the treatment for applying such gloss but also various surface treatment such as matting (i.e., surface roughening).

Note that in the printer 10 of the illustrated example, a heating condition and/or a cooling condition of the surface treatment section 16 can be adjusted, with the result that the gloss or the like to be applied to the front surface of the recording sheet A (i.e., print) may also be adjusted.

Further, in the illustrated example, the recording sheet A is detached from the surface treatment belt 88 by utilizing a so-called stiffness of the recording sheet A. As a result, as shown in FIG. 1, a diameter of the roller 86, which suspends the surface treatment belt 88 at the position where the recording sheet A is discharged from the surface treatment section 16, is preferably set to be small, thereby making it possible to enhance detachability of the recording sheet A from the surface treatment belt 88.

Note that in the present invention, the surface treatment for the image recording layer of the recording sheet A is not limited to the transfer of the surface property by heating/pressure-applying as illustrated, and various surface treatment carried out by a printer can be used.

As examples, illustrated are surface treatments such as laminating in which transparent resin layers (i.e., sheets) for applying a gloss on a surface of the image recording layer are laminated/adhered, and treatment for applying a gloss by performing heating/pressure-applying after the surface of the image recording layer is applied with thermoplastic resin powder (e.g., toner).

The recording sheet A subjected to the surface treatment in the surface treatment section 16 is subsequently transported to the cutting unit 102 of the cutting/arranging unit 18.

The cutting/arranging unit 18 includes the cutting unit 102, an arranging unit 104, and a discharge unit 106.

The recording sheet A after being subjected to the surface treatment (i.e., applying a gloss) in the surface treatment section 16 and being transported, is first cut in a print size in the cutting unit 102, and is then produced as the prints P (i.e., hard copies) to be outputted as a product.

The cutting unit 102 includes the first slitter 110 and the second slitter 112, a guillotine cutter 114, and a registration roller pair 116.

Both the first slitter 110 and the second slitter 112 cut the recording sheet A in the transport direction, and are known slitters using, for example, a rotary cutter and a circular cutter. In addition, the second slitter 112 is arranged downstream with respect to the first slitter 110.

The first slitter 110 and the second slitter 112 are each constituted of two cutters, that is, a pair of cutters, arranged in the width direction at the same position in the transport direction. The cutters constituting the slitters are each concentrically arranged in the width direction, and are each structured to be movable in the width direction by a known method such as screws directing opposite directions with each other or a belt moving in an opposite direction.

The first slitter 110 and the second slitter 112 each move the respective cutters in the width direction based on information on the width of the recording sheet A, position information of an image (i.e., position information in the width direction), and position adjustment information of the recording sheet A in the position adjusting unit 15, thereby positioning the respective cutters at a position corresponding to the print to be produced.

In the cutting unit 102, as described above, the sheet A is transported after the respective cutters of the first slitter 110 and the second slitter 112 are positioned to a cutting position in the width direction, thereby cutting the recording sheet A in the transport direction to be cut in a size in the width direction of the print to be produced.

The printer 10 records, for example, two images at the maximum in the width direction (i.e., performs two-image allocation at the maximum).

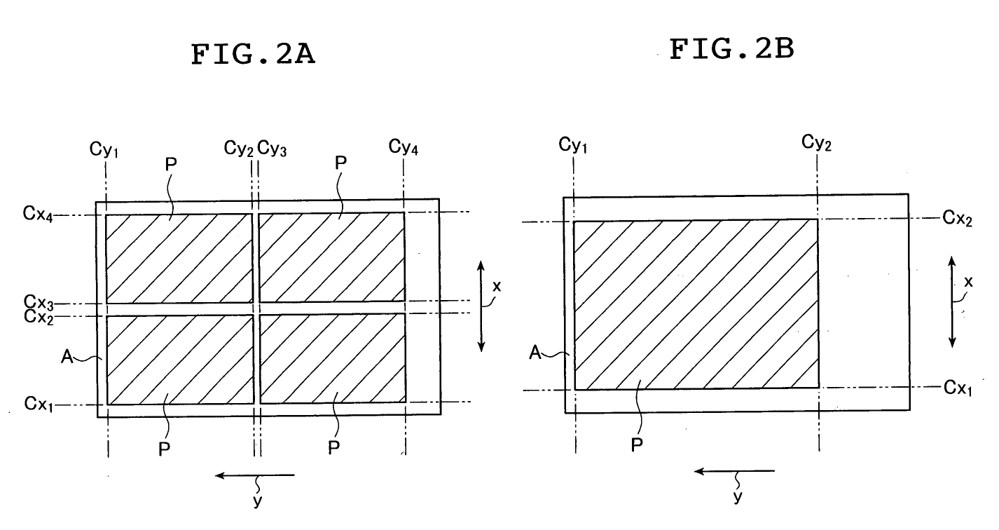

As shown in FIG. 2A, when two images are recorded in the width direction (i.e., direction indicated by the arrow x), one of the cutters of the first slitter 110 is arranged at a position indicated by a cutting-plane line Cx₁ for an image on a left side in the width direction along the transport direction (i.e., direction indicated by the arrow y), and the other cutter is arranged at a position indicated by a cutting-plane line Cx₂ for the same image. In addition, one of the cutters of the second slitter 112 is arranged at a position indicated by a cutting-plane line Cx₃ for an image on a right side in the width direction along the transport direction, and the other cutter is arranged at a position indicated by a cutting-plane line Cx₄ for the same image.

In the cutting unit 102, when two images are recorded in the width direction, as the recording sheet A is transported in the above-mentioned state, the first slitter 110 cuts the recording sheet along the transport direction into the size in the width direction of a print on the left side to be produced. Then, the second slitter 112 cuts the recording sheet into the size in the width direction of a print on the right side to be produced.

On the other hand, as shown in FIG. 2B, when one image is recorded in the width direction, the second slitter 112 (i.e., two cutters thereof) is retracted from the transport path for the recording sheet A. Then, one of the cutters of the first slitter 110 is arranged at the position indicated by the cutting-plane line Cx₁ and the other of the cutter is arranged at the position indicated by the cutting-plane line Cx₂.

In the cutting unit 102, when one image is recorded in the width direction, the recording sheet A is transported in this state, and the first slitter 110 cuts the recording sheet into the size in the width direction of a print to be produced.

The guillotine cutter 114 is a known guillotine cutter for cutting the recording sheet A along the width direction.

In addition, the registration roller pair 116 is a transport roller pair which stops transportation of the recording sheet A at the position at which the guillotine cutter 114 is to cut the sheet, based on position information (i.e., position information in the transport direction) of the image formed on the recording sheet A to thereby determine the cutting position in the transport direction of the recording sheet A.

For example, as shown in FIG. 2A, when two images are recorded in the transport direction (i.e., direction indicated by the arrow y), the registration roller pair 116 first stops the transportation of the recording sheet A at a time point when a cutting-plane line Cy₁ which is made on the leading end side of the image on the leading edge side of the recording sheet A reaches the cutting position at which the guillotine cutter 114 cuts the sheet. Then, the guillotine cutter 114 operates to cut the recording sheet A along the cutting-plane line Cy₁.

After thus cutting the recording sheet A, the registration roller pair 116 resumes the transportation of the recording sheet A, and stops the transportation of the recording sheet A at a time point when a cutting-plane line Cy₂ which is made on the rear end side of the same image reaches the cutting position by the guillotine cutter 114. Then, in a similar manner, the guillotine cutter 114 operates to cut the recording sheet A along the cutting-plane line Cy₂. In this case, the first slitter 110 and the second slitter 112 in the cutting unit 102 have already cut the recording sheet A along the cutting-plane line Cx₁ to cutting-plane line Cx₄, so two prints P on the leading edge side of the recording sheet A are obtained by the cutting operation with the guillotine cutter 114.

Then, in the same manner as described above, after thus cutting the recording sheet A, the registration roller pair 116 resumes the transportation of the recording sheet A, and stops the transportation of the recording sheet A at a time point when a cutting-plane line Cy₃ which is made on the leading end side of the second image in the transport direction reaches the cutting position by the guillotine cutter 114. Then, the guillotine cutter 114 operates to cut the recording sheet A along the cutting-plane line Cy₃. After that, the registration roller pair 116 resumes the transportation of the recording sheet A, and stops the transportation at a time point when a cutting-plane line Cy₄ on the trailing edge side of the recording sheet A reaches the cutting position by the guillotine cutter 114 to cut the recording sheet A along the cutting-plane line Cy₄ with the guillotine cutter 114.

The recording sheet has been cut along the cutting-plane line Cx₁ to cutting-plane line Cx₄, so two prints P on the trailing edge side of the recording sheet are obtained in the same manner as above. Thus, four prints P are obtained from four images recorded on the recording sheet A in accordance with the print size.

On the other hand, as shown in FIG. 2B, when one image is recorded in the transport direction, the registration roller pair 116 stops the transportation of the recording sheet A at a time point when the cutting-plane line Cy₁ which is made on the leading end side of the image reaches the cutting position by the guillotine cutter 114. Then, the guillotine cutter 114 operates to cut the recording sheet A along the cutting-plane line Cy₁.

After thus cutting the recording sheet, the registration roller pair 116 resumes the transportation of the recording sheet A, and stops the transportation at a time point when the cutting-plane line Cy₂ which is made on the rear end side of the same image reaches the cutting position by the guillotine cutter 114. Then, in a similar manner, the guillotine cutter 114 operates to cut the recording sheet A along the cutting-plane line Cy₂. As described above, the first slitter 110 of the cutting unit 102 has already cut the recording sheet A along the cutting-plane line Cx₁ and cutting-plane line Cx₂, so one print P is obtained from one image recorded on the recording sheet A in accordance with the print size by the cutting operation with the guillotine cutter 114.

The print or the prints P cut (i.e., obtained from the recording sheet A) in the cutting unit 102 are subsequently transported to the arranging unit 104, and is further transported from the arranging unit 104 to the discharge unit 106.

The arranging unit 104 discharges the prints P cut in the cutting unit 102 into the discharge unit 106. In this case, when two images are recorded on the recording sheet A in the width direction, the arranging unit 104 rearranges the prints P, which are obtained by being cut in the cutting unit 102 and arranged in two lines, into one line (i.e., rearranging prints P in a single line) in the width direction, and then discharges the prints P to the discharge unit 106. In the illustrated example, the arranging unit 104 includes carry-in rollers 120, transport roller pairs 122, 124, and 132, a discharge roller pair 126, and a rearranging-in-single-line roller pair 130. In addition, immediately upstream of the discharge roller pair 126, printing means 138 is arranged.

Further, the discharge unit 106 is a belt conveyer composed of two rollers 140 and an endless belt 14.2 suspended over the rollers 140.

The carry-in rollers 120 of the arranging unit 104 is composed of two roller pairs 120a and 120b which are concentrically arranged in the width direction. The roller pairs 120a and 120b are each a transport roller pair which can be driven separately from each other.

The roller pair 120a which is one of the carry-in rollers 120 is adapted for the prints P (i.e., position in the width direction thereof) cut along the cutting-plane lines Cx₁ and Cx₂ by the first slitter 110 when two images are recorded in the width direction. The roller pair 120b which is the other one of the carry-in rollers 120 is adapted for the prints P (i.e., the position in the width direction thereof) cut along the cutting-plane lines Cx₃ and Cx₄ by the second slitter 112.

The arranging unit 104 branches downstream of the carry-in rollers 120, and includes a first lower transport path 134 constituted of the transport roller pairs 122 and 124, and a second upper transport path 136 constituted of the rearranging-in-single-line roller pair 130 and the transport roller pair 132. The rearranging-in-single-line roller pair 130 of the second transport path 136 is a transport roller pair movable in the width direction.

A guide member (not shown) which operates on the roller pair 120a or further operates on the transport path from the roller pair 120b is arranged at a branch position between the first transport section 134 and the second transport path 136 to guide the print P into the first transport path 134.

Further, both of the transport paths merge with each other downstream of the transport roller pair 124 and the transport roller pair 132 by the guide member (not shown) or the like to reach the discharge roller pair 126.

Hereinafter, a description is made of a-process in which the prints P supplied in a plurality of lines in the width direction are rearranged in a single line to be discharged to the discharge unit 106.

As shown in FIG. 2A, when two images are recorded in the width direction, the above-mentioned guide member is caused to operate only on the transport path from the roller pairs 120a, of the two roller pairs 120a and 120b that are arranged in the width direction and constitute the carry-in rollers 120.

When the cut prints P arranged in two line in the width direction are transported, in the arranging unit 104, the print or prints P cut with the first slitter 110 are transported to the first transport path 134 by the roller pair 120a and the above-mentioned guide member. On the other hand, the print or prints P cut with the second slitter 112 are transported to the second transport path 136 by the other roller pair 120b constituting the carry-in rollers 120.

In the first transport path 134, the transported print P is further transported by the transport roller pairs 122 and 124, and is delivered to the discharge roller pair 126. Further, the print P is discharged to the discharge unit 106 by the discharge roller pair 126.

On the other hand, in the second transport path 136, the transportation of the print P is stopped (in this case, the roller pair 120b is also stopped) at a time point when the transported print P is nipped by the rearranging-in-single-line roller pair 130. Then, after the roller pair 120b is released from nipping if needed, the rearranging-in-single-line roller pair 130 is moved in the width direction, thereby moving the print P to a position in the width direction which corresponds to the roller pair 120a. After the print P have been moved to the position in the width direction, the transportation of the print P is started by the rearranging-in-single-line roller pair 130 and the transport roller pair 132 in timing for supplying the print P having been supplied to the first transport path 134 to the discharge roller pair 126 so that the print P to be transported are to be arranged behind the print P supplied to the first transport path 134. Then, the print P is delivered into the discharge roller pair 126. After that, the print P is discharged to the discharge unit 106 by the discharge roller pair 126.

Further, in the example shown in FIG. 2A, two prints P are produced also in the transport direction.

In this case, the rearranging-in-single-line roller pair 130 moves in a direction opposite to the former direction in the width direction to return to the original position at a time when the former print P is separated therefrom. Then, the print P is transported by the roller pair 120b and delivered to the second transport path 136. In the second transport path 136 to which the print P has been transported, the transportation of the print P is stopped, in the same manner as described above, at the time point when the print P is nipped by the rearranging-in-single-line roller pair 130. The roller pair 120b is released from nipping if needed before the rearranging-in-single-line roller pair 130 is moved in the width direction, and then the print P are moved to the position in the width direction which corresponds to the roller pair 120a. After that, the print P is transported by the rearranging-in-single-line roller pair 130 and the transport roller pair 132, and is further delivered into the discharge unit 106 by the discharge roller pair 126.

As a result, the prints P supplied in a plurality of lines in the width direction are rearranged in a single line and are discharged to the discharge unit 106.

On the other hand, as shown in FIG. 2B, when one image is recorded in the width direction on the recording sheet A, the above-mentioned guide member is caused to operate on the transport path from both the two roller pairs 120a and 120b.

In the arranging unit 104, when the cut print P is transported therein, the carry-in rollers 120 (i.e., two roller pairs of 120a and 120b are driven in synchronization with each other) and the guide member transport the print P to the first transport path 134. On the first transport path 134, the print P is transported by the transport roller pairs 122 and 124 to be delivered to the discharge roller pair 126. Then, the print P is discharged to the discharge unit 106 by the discharge roller pair 126.

Herein, as described above, immediately upstream of the discharge roller pair 126, the printing means 138 is arranged to correspond to the back surface (i.e., non-image recording surface) of a print P for one-side image recording. The printing means 138 is provided to record a so-called back print on the back surface of the print P. The printing means 138 is not particularly limited thereto, and it is possible to use various known printing means used in printing of the back print in photographic printers or the like such as an impact printer using an ink ribbon, and an ink jet printer.

Upon detecting that the prints P transported/discharged and dropped by the discharge roller pair 126 have been received and accumulated on the belt conveyer, and that the prints for one order have been accumulated based on sort information and the like, the discharge unit 106 transports the accumulated member of the prints P by a predetermined length, distance, or amount set according to the print size (i.e., maximum length of the prints for one order), stops the transportation of the accumulated member, and then receives prints P for a next order.

The printer 10 shown in FIG. 1 according to the first aspect of the present invention is basically structured as described above.

Hereinafter, a description is made of the operation of the printer 10 and the image forming method according to the first aspect of the present invention.

In the above-mentioned printer 10, in a case of producing a so-called one-side print, in which the sheet for a photographic-image-quality print is used as the recording sheet A, only one surface (i.e., transparent resin layer which is the image recording layer) has been recorded with an image, and the surface treatment such as the gloss treatment is performed on the recorded image, any one of the following processes is first performed. That is: the recording sheet A is drawn out from the magazines 20 containing the sheet for the photographic-image-quality print in the supplying unit 12 based on the control by the controlling unit 40 to cut the recording sheet A in a predetermined size with the cutters 27; the recording sheet A is drawn out from the cassette 24 containing the sheet for the photographic-image-quality print to supply the sheet A from the supplying unit 12; or the sheet for the photographic-image-quality print is drawn out and fed to the manual feeding unit 26 as the recording sheet A to supply the sheet A from the supplying unit 12.

In a case of producing the one-side print, the recording sheet A thus supplied from the supplying unit 12 is transported to the image recording unit 14. During the transportation, the front/back surface discriminating means 28 discriminates whether or not directions of the front and back surfaces of the recording sheet A are appropriate (i.e., whether or not the transparent resin layer faces the front/back surface discriminating means 28).

Herein, in a case where the front/back surface discriminating means 28 determines that the directions of the front and back surfaces of the recording sheet A are appropriate (i.e., the transparent resin layer faces the front/back surface discriminating means 28), the recording sheet A is allowed to pass through the second reversing unit 152 and directly supplied to the image recording unit 14 based on the control by the control unit 40. Therefore, in a case of producing the one-side print, the recording sheet A is preferably contained and loaded such that a surface (i.e., front surface) on the transparent resin layer side faces an outside of the roll in the magazines 20, and the front surface of the recording sheet A faces downward in the cassette 24. In this case, the recording sheet A is preferably fed to the manual feeding unit 26 with the surface (i.e., front surface) of the transparent resin layer side facing upward. Accordingly, when the one-side print is produced many times, it is preferable to set the above-mentioned conditions as a default.

If the recording sheet A is loaded such that the surface (i.e., front surface) on the transparent resin layer side of the recording sheet A faces the inner side of the roller in the magazines 20 and faces upward in the cassette 24, or if the sheet P is fed such that the front surface faces downward in the manual feeding unit 26, the front/back surface discriminating means 28 determines that the directions of the front and back surfaces of the recording sheet A are inappropriate (i.e., plain paper surface). In this case, the recording sheet A is reversed in the second reversing unit 152 as described above, and is supplied to the image recording unit 14. Thus, even when containing or loading of the recording sheet A into the magazines 20 or the cassette 24, and feeding of the recording sheet A into the manual feeding unit 26 are set differently from the default, it is possible to make the state of the recording sheet A to be supplied to the image recording unit 14 to be the same as the default by reversing the recording sheet A in the second reversing unit 152.

As described above, in any case, the transparent resin layer of the recording sheet A becomes the surface facing (i.e., abutted against) the transfer belt 60. As a result, in the image recording unit 14, a toner image is transferred onto the transparent resin layer of the recording sheet A while the recording sheet A is nipped and transported by the transfer belt 60 and the transfer roller 66. Then, the toner image is fixed on the transparent resin layer of the recording sheet A while the recording sheet A is nipped and transported by the primary fixing roller pair 36, thereby recording the image.

Next, after the position of the recording sheet A, which has been recorded with the image, in the width direction is adjusted by the position adjusting unit 15, the recording sheet A is transported to the surface treatment section 16 and is nipped and transported by the surface treatment belt 88 and the nip roller 92. Thus, the recording sheet A is heated to be pressed against/adhered to the surface treatment belt 88, is cooled by the cooler unit 90, and is then detached from the surface treatment belt 88, thereby performing the surface treatment (i.e., gloss treatment) on the transparent resin layer of the recording sheet A.

Further, the recording sheet A subjected to the surface treatment is transported to the cutting unit 102, where the first slitter 110 and optionally the second slitter 112 cut the recording sheet A into the print size in the width direction as described above. Then, the guillotine cutter 114 cuts the recording sheet A into the print size in the transport direction whereby individual prints P are obtained. In the arranging unit 104, the prints P are rearranged in a single line if needed, and are discharged to the discharge unit 106.

Note that the each individual part used in producing the above-mentioned one-side print is operated under the control by the control unit 40.

On the other hand, in a case of producing the two-side print using the sheet for a photographic-image-quality print as the recording sheet A, in a similar manner as in the one-side printing, the recording sheet A is supplied from the supplying unit 12, and the front/back surface discriminating means 28 discriminates whether or not the directions of the front and back surfaces of the recording sheet A are appropriate.

Next, when the front/back surface discriminating means 28 determines that the directions of the front and back surfaces of the recording sheet A are appropriate, the recording sheet A is reversed in the second reversing unit 152 to set the back surface (i.e., plain paper surface) as the side (which faces the transfer belt 60) adapted for the image recording, and then the recording sheet A is supplied to the image recording unit 14, as described above.

Note that when the front/back surface discriminating means 28 determines that the directions of the front and back surfaces of the recording sheet A are inappropriate, the recording sheet A is supplied to the image recording unit 14 without reversing the recording sheet A.

In the image recording unit 14, in the same manner as described above, the toner image is transferred onto the back surface (i.e., plain paper surface) of the recording sheet A in the transferring unit 34, and the toner image is fixed thereon while the recording sheet A is nipped and transported by the primary fixing roller pair 36, thereby recording the image on the back surface of the recording sheet A first.

In this case, since the two-side printing is performed, the recording sheet A is transported to the first reversing unit 150 to reverse the recording sheet A, and is delivered to the registration roller pair 70 as described above, thereby setting the front surface (i.e., image recording layer such as a transparent resin layer) of the recording sheet A as a transfer surface side adapted for the image recording.

Thus, the recording sheet A whose back surface has been first recorded with an image is reversed in the first reversing unit 150, and the recording sheet A is supplied to the image recording unit 14. In the same manner as described above, in the transferring unit 34, the toner image is transferred onto the front surface (i.e., transparent resin layer) of the recording sheet A, and the toner image is fixed thereon while the recording sheet A is nipped and transported by the primary fixing roller pair 36, thereby recording images on both surfaces, that is, the front surface (i.e., transparent resin layer) and the back surface (i.e., pain-paper surface).

After the images have been recorded on both surfaces of the recording sheet A, the position of the recording sheet A in the width direction is adjusted by the position adjusting unit 15 before the recording sheet A is transported to the surface treatment section 16, in the same manner as described above.

As described above, since the front surface (i.e., transparent resin layer) is last recorded with the image in the image recording unit 14, in the surface treatment section 16, the transparent resin layer of the image recording sheet A faces the surface treatment belt 88. Thus, in the surface treatment section 16, the transparent resin layer of the recording sheet A is heated/pressed against the surface treatment belt 88 to be adhered thereto, is cooled while the recording sheet A is transported, and is detached from the transfer belt, thereby performing the surface treatment on the transparent resin layer.

Next, in the same manner as described above, the recording sheet A is cut in the width direction and in the transport direction in the cutting unit 102 to be produced as separate prints P. Then, the prints P are rearranged in a single line in the arranging unit 104 if needed, and are discharged to the discharge unit 106.

As is apparent from the above description, the printer 10 includes the second reversing unit 152 in addition to the first reversing unit 150 for recording images on both surfaces of the recording sheet A. Thus, an operation of loading the recording sheet A in the cassette 24 again after reversing the recording sheet A becomes unnecessary, even when both the one-side printing and the two-side printing are performed using the sheet for a photographic-image-quality print. In addition, even when the sheet for a photographic-image-quality print (i.e., recording sheet A having the transparent resin layer (i.e., image recording layer) which is adapted for the surface treatment formed only on one surface thereof) is supplied as the recording sheet roll 20a, it is possible to produce, with efficiency, not only the one-side print in which the image has been recorded only on the front surface (i.e., transparent resin layer) and the surface treatment has been performed on the transparent resin layer, but also the two-side print in which images have been recorded on both the front surface (i.e., transparent resin layer) and the back surface (i.e., plain paper surface), and the surface treatment has been performed on the transparent resin layer.

The printer 10 shown in FIG. 1 has a structure in which the second reversing unit 152 is provided upstream of the image recording unit 14 (i.e., first reversing unit 150), but the present invention is not limited thereto. Alternatively, various structures can be adopted.

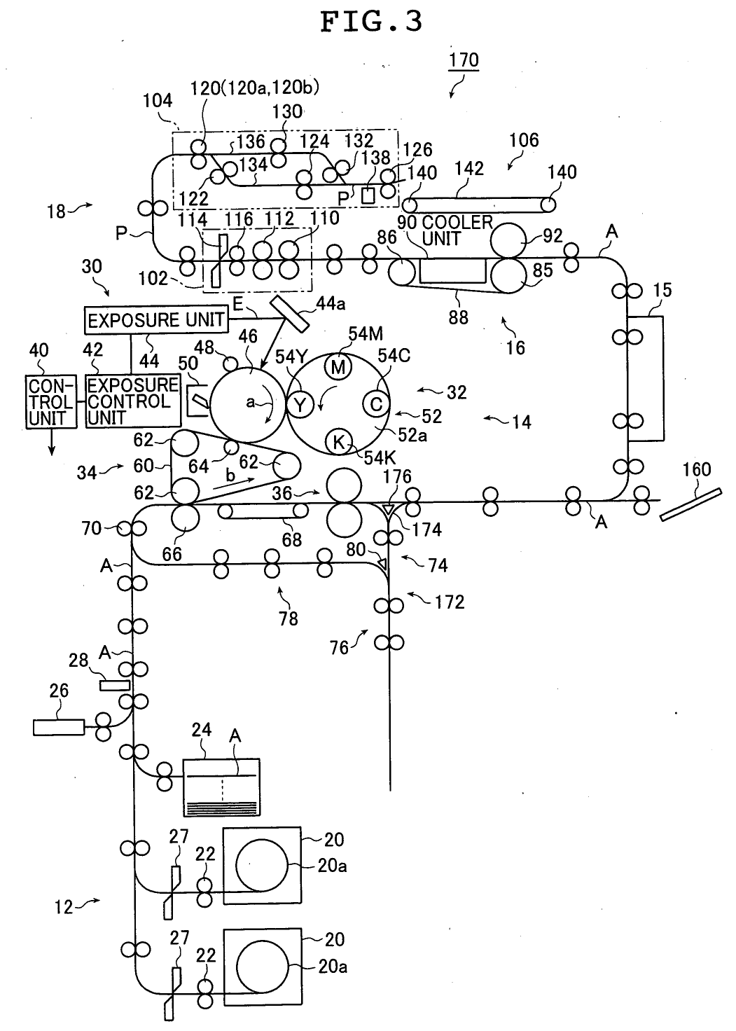

FIG. 3 is a schematic diagram showing another embodiment of a printer according to the present invention.

In a printer 170 shown in FIG. 3, a part of transport paths and the like are commonly used by first reversing means and second reversing means. The first reversing means reverses the recording sheet A, one surface of which has been recorded with an image to produce the two-side print, and supplies the recording sheet A to the image recording unit 14 again. The second reversing means is another reversing means for reversing the recording sheet A.

The printer 170 shown in FIG. 3 has a structure basically similar to the printer 10 shown in FIG. 1 except for the following points. That is, the printer 170 does not include the second reversing unit 152, and includes a reversing unit 172 which has a structure different from the first reversing unit 150 but has a function of the first reversing unit 150 and a function of reversing the recording sheet A. Accordingly, the same components are denoted by the same reference symbols, detailed descriptions thereof are omitted, and different parts are mainly described below.

The reversing unit 172 of the printer 170 shown in FIG. 3 includes a second return transport path 174 for connecting the transport path toward the position adjusting means 15 and the branch transport path 74 of the reversing unit 172 in the first revering unit 150 of the printer 10.

In addition, the reversing unit 172 includes, instead of the first switching means 72 in the first reversing unit 150 of the printer 10, a first switching means 176 which operates on the transport path from the primary fixing roller pair 36 to guide the recording sheet A to the branch transport path 74, and operates on the branch transport path 74 to guide the recording sheet A to the second return transport path 174.

In other words, in the reversing unit 172, the first reversing means includes the first reversing unit 176, the branch transport path 74, the reverse transport path 76, the second switching means 80, and the return transport path 78, and the second reversing means includes the first switching means 176, the branch transport path 74, the reverse transport path 76, and the second return transport path 174.

The operation of the printer 170 in a case of producing the one-side print using the sheet for a photographic-image-quality print as the recording sheet A, is similar to that of the above-mentioned printer 10. This is because, when the front/back surface discriminating means 28 determines that the directions of the front and back surfaces of the recording sheet A are appropriate, the recording sheet A supplied from the supplying unit 12 is directly transported to the image recording unit 14.

Note that when the front/back surface discriminating means 28 determines that the directions of the front and back surfaces of the recording sheet A are inappropriate, unlike the above-mentioned printer 10, the recording sheet A may be allowed to pass through the transferring unit 34 and the primary fixing roller pair 36 without performing image recording, the recording sheet A may be reversed in the reversing means 172 in exactly the same manner as the first reversing means 150 of the printer 10, and the recording sheet A may be supplied to the registration roller pair 70, to thereby record an image on the transparent resin layer of the recording sheet A. Alternatively, the recording sheet A may be directly discharged to the plain paper discharge tray 160 by allowing the recording sheet A to pass through the image recording unit 14 without performing the image recording.

On the other hand, in the printer 170, when the two-side print is produced using the sheet for a photographic-image-quality print as the recording sheet A, in the same manner as in the printer 10, the recording sheet A is supplied from the supplying unit 12, the front/back surface discriminating means 28 determines whether or not the directions of the front and back surfaces of the recording sheet A are appropriate, and then the recording sheet A is transported to the image recording unit 14.

When the front/back surface discriminating means 28 determines that the directions of the front and back surfaces of the recording sheet A are appropriate, in the image recording unit 14, in the same manner as described above, the toner image is transferred onto the front surface (i.e., transparent resin layer) of the recording sheet A, and the toner image is fixed thereon while the recording sheet A is nipped and transported by the primary fixing roller pair 36, thereby recording the image on the transparent resin layer of the recording sheet A first.

When the two-side printing is performed, the recording sheet A is reversed in the reversing unit 172 in the same manner as in the prior example, and then the recording sheet A is transported to the registration roller pair 70 with the back surface (i.e., pain-paper surface) being set as the side (facing the transfer belt 60) adapted for the image recording.

As described above, the recording sheet A whose transparent resin layer has been first recorded with an image is reversed, and the recording sheet A is supplied to the image recording unit 14. Then, in the same manner as described above, in the transferring unit 34, the toner image is transferred onto the back surface of the recording sheet A, and the toner image is fixed thereon while the recording sheet A is nipped and transported by the primary fixing roller pair 36, thereby recording images on both surfaces, that is, the transparent resin layer and the back surface.

Herein, in the printer 170, when the two-side print is produced using the sheet for a photographic-image-quality print, in a case of recording the image on the back surface thereof, the recording sheet A having images formed on both surfaces thereof is delivered to the branch transport path 74 while the first switching means 176 of the reversing unit 172 is caused to operate on the transport path from the primary fixing roller pair 36, and the recording sheet A is further transported from the branch transport path 74 to the reverse transport path 76.

The transportation of the recording sheet A is stopped at a time point when the trailing edge of the recording sheet A reaches the downstream of the second return transport path 174, and then the first switching means 176 is switched so as to guide the recording sheet A from the branch transport path 74 to the second return transport path 174.

After the first switching means 176 has been switched, the recording sheet A is transported in a direction opposite to the former direction in the reverse transport path 76 and the branch transport path 74, is delivered to the second return transport path 174 by being guided by the first switching means 176, and is then transported from the second return transport path 174 to the position adjusting unit 15. As described above, since the back surface of the recording sheet A is last recorded with the image, the recording sheet A is reversed to set the transparent resin layer as the side adapted for the surface treatment in the surface treatment section 16 (i.e., the transparent resin layer faces the surface treatment belt 88), and then transported to the position adjusting unit 15.

Note that when the front/back surface discriminating means 28 first determines that the directions of the front and back surfaces of the recording sheet A are inappropriate, the recording sheet A may be transported to the image recording unit 14 to thereby first record an image on the back surface thereof. Then, in the same manner as described above, the recording sheet A may be reversed in the reversing unit 172, transported again from the registration roller pair 70 to the image recording unit 14 to record the image on the transport resin layer, and then transported to the position adjusting unit 15 without performing a second reversal of the recording sheet.

After the images are recorded on both surfaces of the recording sheet A, and the recording sheet A is reversed if needed to set the front surface (i.e., transparent resin layer) of the recording sheet A as the surface adapted for the surface treatment, in the same manner as described above, the position of the recording sheet A in the width direction is adjusted in the position adjusting unit 15, and then the transparent resin layer is heated/pressed against the surface treatment belt 88 to adhere the recording sheet A thereto in the surface treatment section 16. Further, the transparent resin layer is cooled while the recording sheet A is transported, and the recording sheet A is detached from the transfer belt, thereby performing the surface treatment on the transparent resin layer.

Next, in the same manner as described above, the recording sheet A is cut in the width direction and in the transport direction in the cutting unit 102 to be produced as separate prints P, the prints P are rearranged in a single line in the arranging unit 104 if needed, and then are discharged to the discharge unit 106.

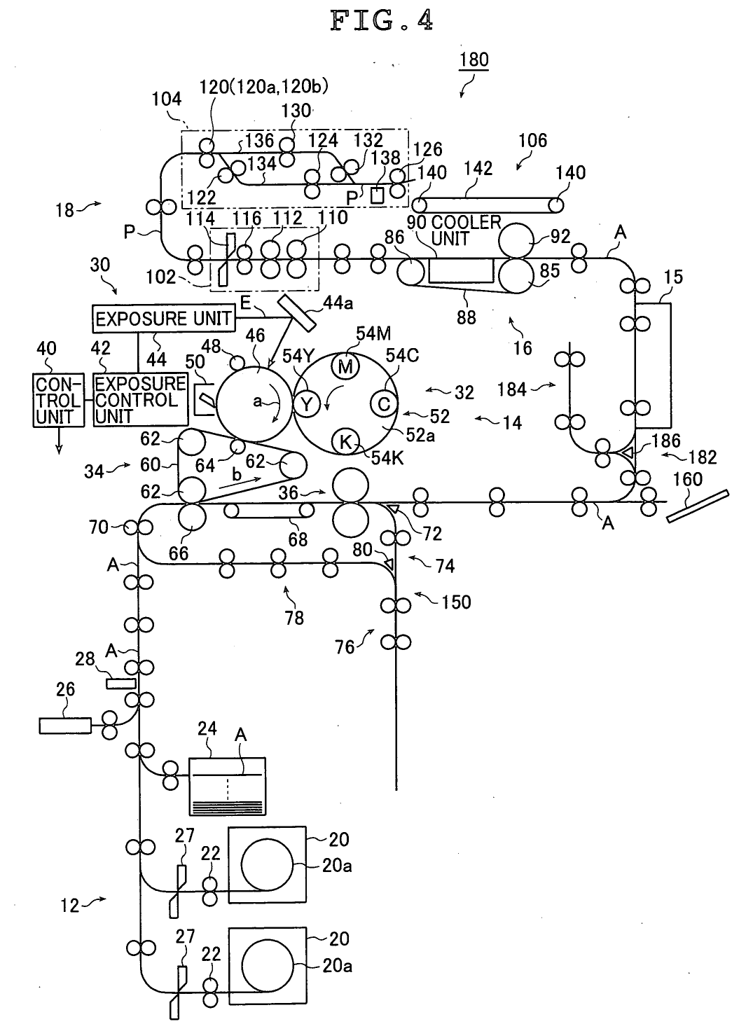

FIG. 4 is a schematic diagram showing another embodiment of the printer according the present invention.

A printer 180 shown in FIG. 4 has a structure basically similar to the printer 10 shown in FIG. 1 except for the following points. That is, in the printer 180, the second reversing unit 152 is not provided, and a second reversing unit 182 serving as the second reversing means is arranged between the image recording unit 14 and the position adjusting unit 15. Accordingly, the same components are denoted by the same reference symbols, detailed descriptions thereof are omitted, and different parts are mainly described below.

The reversing unit 182 serves as, similarly to the second reversing unit 152 of the printer 10 shown in FIG. 1, reversing means for reversing the recording sheet A by so-called switch-back, and includes a reverse transport path 184 and switching means 186 for switching the transport paths for the recording sheet A.

The reverse transport path 184 has a substantial Y-shape similar to the reverse transport path 154 and is capable of reversely transporting the recording sheet A. The reverse transport path 184 is arranged such that a branch side end portion (i.e., upper portion of the Y-shape) is connected to the transport path for the recording sheet A which extends from the image recording unit 14 to the position adjusting unit 15. In the illustrated example, the reverse transport path 184 is bent due to a limited installation space within the apparatus.

The switching means 186 is also known switching means, such as a flapper, provided for a transport path for the sheet-like material, which operates on a transport path to guide the recording sheet A to a predetermined transport path.

The operation of the printer 180 in a case of producing the one-side print using the sheet for a photographic-image-quality print as the recording sheet A, is similar to that of the above-mentioned printers 10 or 170. This is because, when the front/back surface discriminating means 28 determines that the directions of the front and back surfaces of the recording sheet A are appropriate, the recording sheet A supplied from the supplying unit 12 is directly transported to the image recording unit 14.

In this case, treatment performed when the front/back surface discriminating means 28 determines that the directions of the front and back surfaces of the recording sheet A are inappropriate, may be also performed in the same manner as in the above-mentioned printer 170.

On the other hand, in the printer 180, when the two-side print is produced by using the sheet for a photographic-image-quality print as the recording sheet A, the recording sheet A is supplied from the supplying unit 12, as in the case of the above-mentioned printer 10, and the front/back surface discriminating means 28 discriminates whether or not the directions of the front and back surfaces of the recording sheet A are appropriate. After that, the recording sheet A is transported to the image recording unit 14.

When the front/back surface discriminating means 28 determines that the directions of the front and back surfaces of the recording sheet A are appropriate, in the image recording unit 14, the toner image is transferred onto the transparent resin layer of the front surface of the recording sheet A, and the toner image is fixed thereon while the recording sheet A is nipped and transported by the primary fixing roller pair 36, thereby first recording the image on the transparent resin layer (i.e., image recording layer) of the recording sheet A, in the same manner as described above.

Next, the recording sheet A is reversed in the first reversing unit 150, and the recording sheet A is supplied to the registration roller pair 70 with the plain paper surface, which is the back surface thereof, being set as the side (facing the transfer belt 60) adapted for the image recording. Thus, the recording sheet A whose transparent resin layer has been first recorded with the image is reversed, and the recording sheet A is supplied to the image recording unit 14. Then, in the transferring unit 34, the toner image is transferred onto the back surface of the recording sheet A, and the toner image is fixed thereon while the recording sheet A is nipped and transported by the primary fixing roller pair 36, thereby recording images on both surfaces, that is, the transparent resin layer and the back surface.

In the printer 180, when the two-side print is produced using the sheet for a photographic-image-quality print as the recording sheet A, the recording sheet A whose both surfaces have been recorded with images is reversed in the second reversing unit 182.

In other words, before the recording sheet A is transported to the second reversing unit 182, in the second reversing unit 182, the recording sheet A both surfaces of which have been recorded with images is drawn into the reverse transport path 184 while the switching means 186 is caused to operate on the transport path from the image recording unit 14.

At a time point when the trailing edge of the recording sheet A reaches the downstream of the branch point of the reverse transport path 184, the transportation of the recording sheet A on the reverse transport path 184 is stopped, and then the switching means 186 is switched so as to guide the recording sheet A into the transport path from the reverse transport path 184 to the position adjusting unit 15.

After the switching means 186 has been switched, the recording sheet A is transported in a direction opposite to the former direction on the reverse transport path 184, and is further transported to the transport path from the reverse transport path 154 to the image recording unit 154. Then, the recording sheet A is reversed, and the recording sheet A is supplied to the position adjusting unit 15.

As described above, with regard to the recording sheet A, since the back surface of the recording sheet A is last recorded with the image, the transparent resin layer of the recording sheet A which is the sheet for a photographic-image-quality print can be set as the side (facing the surface treatment belt 88) adapted for the surface treatment by thus reversing the recording sheet A.

Note that, also in this example, when the front/back surface discriminating means 28 determines that the directions of the front and back surfaces of the recording sheet A are inappropriate, the recording sheet A is transported to the image recording unit 14, and image recording is performed first on the back surface thereof. Then, in the same manner as described above, the sheet A may be reversed in the first reverse transport path 150, may be transported from the registration roller pair 70 to the image recording unit 14 again to record an image on the transparent resin layer, and may be transported to the position adjusting unit 15 without reversing the recording sheet A in the second reversing unit 182.

After the images have been recorded on both surfaces of the recording sheet A, and the recording sheet A has been reversed if needed to set the front surface (i.e., transparent resin layer) of the recording sheet A as the surface adapted for the surface treatment, in the same manner as described above, the position of the recording sheet A in the width direction is adjusted in the position adjusting unit 15, and then the transparent resin layer is heated/pressed against the surface treatment belt 88 to adhere the recording sheet A thereto in the surface treatment section 16. Further, the transparent resin layer is cooled while the recording sheet A is transported, and the recording sheet A is detached from the transfer belt, thereby performing the surface treatment on the transparent resin layer.

Next, in the same manner as described above, the recording sheet A is cut in the width direction and in the transport direction in the cutting unit 102 to be produced as separate prints P. Then, the prints P are rearranged in a single line in the arranging unit 104 if needed, and are discharged to the discharge unit 106.

In any of the printer 10 shown in FIG. 1, the printer 170 shown in FIG. 3, and the printer 180 shown in FIG. 4, the front/back surface discriminating means 28 is arranged immediately downstream of the supplying position of the recording sheet A from the cassette 24 and the manual feeding unit 26, but the present invention is not limited thereto. Alternatively, the front/back surface discriminating means 28 can be arranged in various positions.

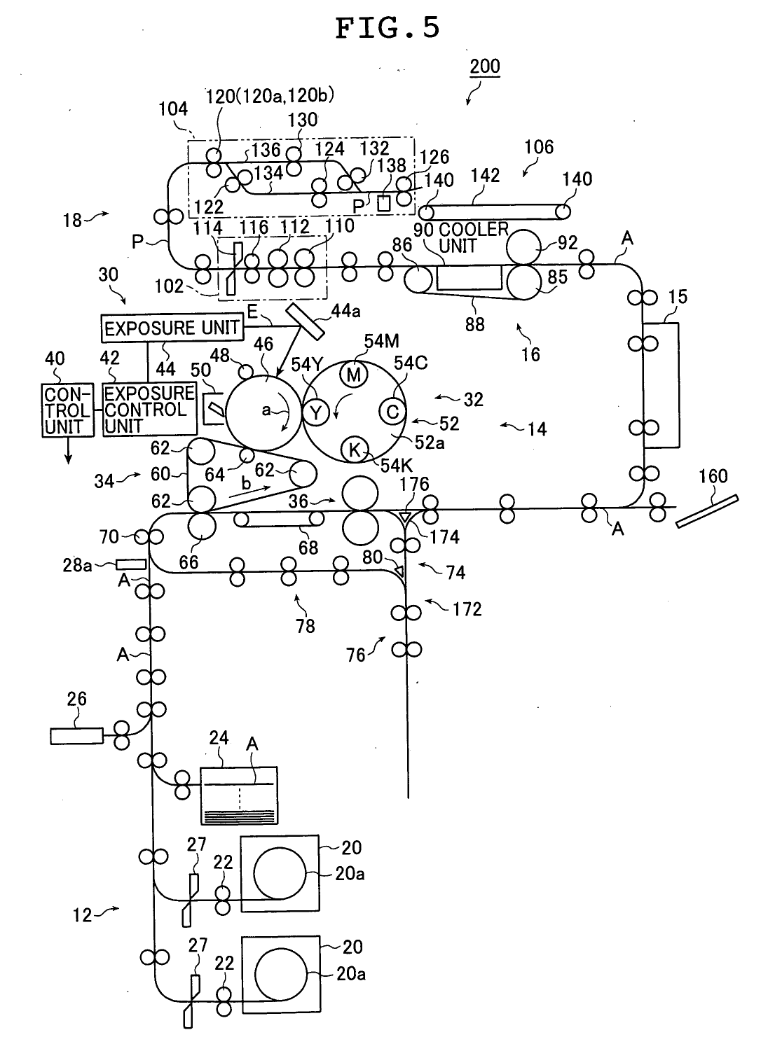

FIG. 5 is a schematic diagram showing another embodiment of the printer according to the present invention as an example.

In a printer 200 shown in FIG. 5, the front/back surface discriminating means 28 is not arranged immediately downstream of the supplying position of the recording sheet A from the manual feeding unit 26 as in the printer 170 shown in FIG. 3, but a front/back surface discriminating means 28a is arranged immediately upstream of the registration roller pair 70. The printer 200 shown in FIG. 5 has a structure basically similar to the printer 170 shown in FIG. 3 except that the positions of the front/back surface discriminating means 28 and 28a are different from each other. Accordingly, the same components are denoted by the same reference symbols, detailed descriptions thereof are omitted, and different parts are mainly described below.

Also in the printer 200, registration of the recording sheet A is performed to appropriately transfer an image thereon by using the registration roller pair 70, as in the above-mentioned printer 170. The recording sheet A is once stopped in a state where the leading edge thereof is abutted against the registration roller pair 70.

Thus, in the printer 200, by arranging the front/back surface discriminating means 28a immediately upstream of the registration roller pair 70, the front/back surface discriminating means 28a can perform discrimination of the front and back surface of the recording sheet A while the recording sheet A is stopped for the registration. As a result, accuracy of the discrimination of the front and back surfaces of the recording sheet A can be improved, and there is no need to stop the recording sheet A to perform the discrimination of the front and back surfaces, thereby making it possible to improve the accuracy of the discrimination of the front and back surfaces of the recording sheet A without deteriorating a low treatment capability, in other words, while maintaining the productivity, and without providing a large number of front/back surface discriminating means.

Various printing processes of the printer 200 performed based on the discrimination result as to the front and back surfaces of the recording sheet A by the front/back surface discriminating means 28a, for example, one-side print and two-side print producing patterns, are basically similar to those of the printer 170. Even when the recording sheet A is loaded into the cassette 24 or is fed into the manual feeding unit 26 in the same state as the default or in the state different from the default, the recording sheet A is reversed using the reversing unit 172 if needed, thereby making it possible to produce the one-side print and the two-side print in the same manner. In other words, the recording sheet A is reversed if needed, an image is first recorded on the back surface of the recording sheet A when images are formed on both surfaces thereof, or an image is formed on the front surface of the recording sheet A when an image is formed on one surface thereof, thereby making it possible to produce the one-side print and the two-side print with efficiency.

The structure in which the front/back surface discriminating means 28a is arranged immediately upstream of the registration roller pair 70 as described above, is not limited to the printer 200. Alternatively, in the printer 10 shown in FIG. 1 and the printer 180 shown in FIG. 4, front/back surface discriminating means may be arranged, instead of the front/back surface discriminating means 28, at the same position as the front/back surface discriminating means 28a in the printer 200.

In the printer 10 shown in FIG. 1, when the front/back surface discriminating means is arranged immediately upstream of the registration roller pair 70, the recording sheet A cannot be reversed in the second reversing unit 152. As a result, in this case, when the recording sheet A is required to be reversed prior to image recording, the recording sheet A is allowed to pass through the image recording unit 14 without performing the image recording, and the image recording may be performed after the recording sheet A is reversed in the first reversing unit 150.

Further, in the printers 10, 170, 180, and 200 according to the present invention, the front/back surface discriminating means is not limited to one provided in transport paths for the recording sheet A. Alternatively, the front/back surface discriminating means may be provided in the cassette 24 and/or the manual feeding unit 26 though the number of the front/back surface discriminating means is increased, or both the front/back surface discriminating means 28 and 28a may be provided.

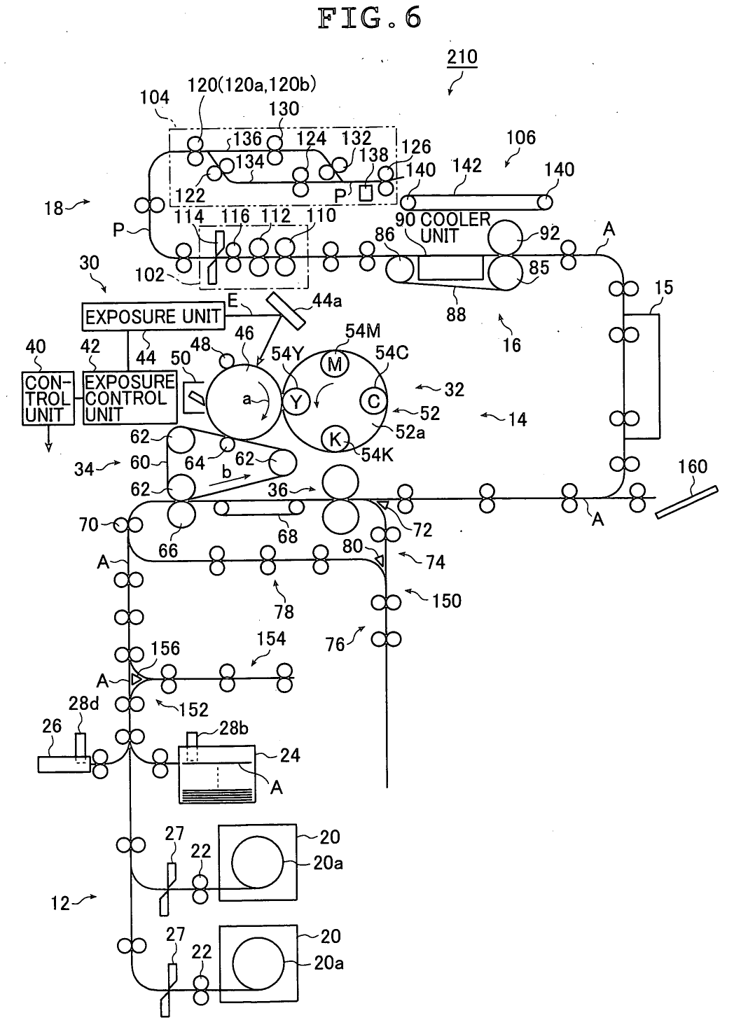

FIG. 6 is a schematic diagram showing another embodiment of the printer according to the present invention as an example.

In a printer 210 shown in FIG. 6, there are provided front/back surface discriminating means 28b and 28d, instead of the front/back surface discriminating means 28 arranged immediately upstream of the supplying position of the recording sheet A from the cassette 24 or the manual feeding unit 26 provided in the printer 10 shown in FIG. 6. The front/back surface discriminating means 28b discriminates the front and back surfaces of the recording sheet A contained in the loaded cassette 24. The front/back surface discriminating means 28d discriminates the front and back surfaces of the recording sheet A fed in the manual feeding unit 26.

Also in the structure of the printer 210, similarly to the case of the printer 210, the front/back surface discriminating means 28b and 28d can discriminate the front and back surfaces of the recording sheet A while the recording sheet A is stopped, thereby making it possible to improve the accuracy of the discrimination of the front and back surfaces thereof while maintaining the treatment capability. In addition, before the recording sheet A is supplied to the transport path, it is possible to discriminate the front and back surfaces of the recording sheet A in a state of being contained in the loading cassette 24 or in a state of being stacked or fed in the manual feeding unit 26. As a result, it is possible to detect whether the recording sheets A are appropriate for the print producing pattern or the image forming pattern such as the one-side printing or the two-side printing. Further, it is possible to detect in advance whether the recording sheet A which is appropriate for any one of the cassette 24, the manual feeding unit 26, and the magazines 20 is present or not. If such recording sheet A is present, the appropriate sheet A can be supplied. Thus, it is possible to produce a print or prints with efficiency without unnecessarily reversing the recording sheet A. Also when the appropriate recording sheet A is not present, it is possible to select between: a reversal of the recording sheet A contained in the cassette 24 or the recording sheet A fed in the manual feeding unit 26, which is performed by an operator through loading of the recording sheet A therein; and a reversal of the recording sheet A in the second reversing unit 152 or the first reversing unit 150 in the printer 210.

As described above, in the structure of the printer 210 in which the front/back surface discriminating means 28b and 28d are respectively provided in the cassette 24 and the manual feeding unit 26, an operation such as the reversal of the recording sheet A, which is performed in the second reversing unit 152 or the first reversing unit 150 in the printer 210 based on the discrimination result as to the front and back surfaces of the recording sheet A, may be performed in a similar manner as in the above-mentioned printer 10.

Further, as described above, the structure in which the front/back surface discriminating means 28b and 28d are respectively provided in the cassette 24 and the manual feeding unit 26 is not limited to the printer 200. Alternatively, such structure can be also utilized in the printer 170 shown in FIG. 3 or in the printer 180 shown in FIG. 4.

Note that in the printer 210, at least one of the front/back surface discriminating means 28 of the printers 10, 170, and 180, and the front/back surface discriminating means 28a of the printer 200 may be provided. Alternatively, in the printers 10, 170, 180, and 200, the front/back surface discriminating means 28b and 28d of the printer 210 may be provided in addition to the front/back surface discriminating means 28 and/or 28a. In this case, the front/back surface discriminating means 28b and 28d are not limited to be provided in both the cassette 24 and the manual feeding unit 26. Alternatively, the front/back surface discriminating means 28b and 28d may be provided in one of the cassette 24 and the manual feeding unit 26.

The printer 10 shown in FIG. 1, the printer 170 shown in FIG. 3, the printer shown in FIG. 4, the printer 200 shown in FIG. 5, and the printer 210 shown in FIG. 6 are each provided with one cassette 24 (i.e., loading unit of the cassette 24) containing the recording cut-sheets A, but the present invention is not limited thereto. Alternatively, those printers may be provided with two or more cassettes.

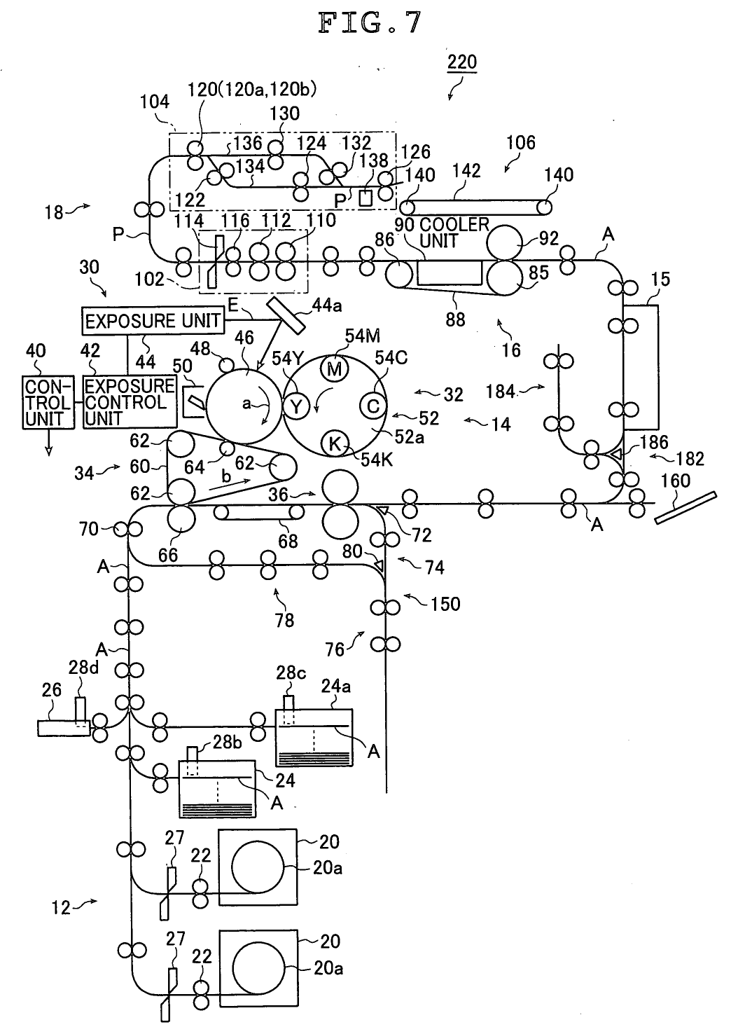

FIG. 7 is a schematic diagram showing another embodiment of the printer according to the present invention as an example.

A printer 220 shown in FIG. 7 has the structure similar to that of the printer 180 shown in FIG. 4 with a second cassette 24a provided in addition to the cassette 24. The printer 220 shown in FIG. 7 has a structure basically similar to the above-mentioned printer 180 except that the second cassette 24a is provided. Accordingly, the same components are denoted by the same reference symbols, detailed descriptions thereof are omitted, and different parts are mainly described below.

Further, the printer 220 includes the cassette 24 provided with the front/back surface discriminating means 28b, the cassette 24a provided with the front/back surface discriminating means 28c, and the manual feeding unit 26 provided with the front/back surface discriminating means 28d. Also in such structure in which a plurality of cassettes are provided, similarly to the printer 200 shown in FIG. 5, it is possible to employ the structure in which the front/back surface discriminating means is provided immediately downstream of the cassette 24 and the like, and the structure in which the front/back surface discriminating means is provided immediately upstream of the registration roller pair 70.

In the printer 220, when the sheet for a photographic-image-quality print is used, the cassette 24 contains the recording sheet A, for example, such that the transparent resin layer faces downward in the drawing, similarly to the above-mentioned printer 180, but another cassette 24a preferably contains the recording sheet A such that the transparent resin layer faces upward in the drawing. In other words, the cassette 24 may contain the recording sheet A with the transparent resin layer facing the image transfer surface side of the transferring unit 34, and the cassette 24a may contain the recording sheet A with the back surface (i.e., plain paper surface which is opposite to the transparent resin layer) facing the image transfer side of the transferring unit 34.

Thus, the front/back surface discriminating means 28c determines that the state where the transparent resin layer faces upward is an appropriate state.

With such structure, it is possible to select the cassette for supplying the recording sheet A according to the image forming pattern to produce a print or prints with efficiency.

In other words, also in the printer 220, or in the printers 10, 170, 180, 200 and 210, as described above, when the sheet for a photographic-image-quality print is used to produce a print or prints, it is necessary to transport the recording sheet A to the surface treatment section 16 with the transparent resin layer facing the surface treatment belt 88. That is, it is necessary to direct the transparent resin layer to the image transfer side of the transferring unit 34.

Accordingly, for example, in the printer 180, when the recording sheet A is supplied from the cassette 24, which contains the recording sheet A with the transparent resin layer facing downward in the drawing to produce a two-side print, an image is first recorded on the transparent resin layer, and the recording sheet A is reversed in the first reversing unit 150. After that, an image is recorded on the back surface, and then the recording sheet A is to be reversed again in the second reversing unit 182 to direct the transparent resin layer to face the surface treatment belt 88. When such cassette 24 is used, the process is to be performed also in the printer 220, and in the printers 10, 170, 200 and 210.

Meanwhile, when the cassette 24a containing the recording sheet A whose front and back surfaces are arranged reversely to those of the cassette 24, as in the printer 220, in a case of producing a two-side print, the recording sheet A is supplied from the cassette 24a to first record an image on the back surface thereof. After that, the recording sheet A is reversed in the first reversing unit 150, thereby making it possible to record an image on the transparent resin layer. Thus, it is possible to deliver the recording sheet A directly to the surface treatment section 16 without reversing the recording sheet A.

Accordingly, in the printer 220, the recording sheet A is supplied from the cassette 24 (or the magazines 20) when the one-side print is produced, and the recording sheet A is supplied from the cassette 24a when the two-side print is produced, respectively. As a result, it is possible to decrease the number of reversal of the recording sheet A in a case of producing the two-side print, thereby performing printing with efficiency.

Such structure in which a plurality of cassettes are provided, and at least one of the cassettes contains the recording sheet A which has been reversed is not limited to the printer 220 shown in FIG. 7. The structure may be also employed in the printers 10, 170, 180, 200, and 210 which are respectively shown in FIGS. 1, 3, 4, 5, and 7.

In the printer 10 shown in FIG. 1, the recording sheet A does not pass through the primary fixing roller pair after the image is formed on the transparent resin layer (i.e., image recording layer), and in addition, the recording sheet A is not reversed. As a result, it is possible to prevent deterioration of qualities of an image or a product caused by such procedure, so the printer 10 is advantageous in terms of the image quality.

Further, in the printer 170 shown in FIG. 3, the first reversing means and the second reversing means are integrated with each other. As a result, the printer 170 is advantageous in terms of costs, apparatus size, and simple structure.

Further, in the printer 180 shown in FIG. 4, the image recording unit 14 including the first reversing unit 150 (i.e., first reversing means) has the structure similar to that of a normal printer. As a result, the parts and software of the printer 180 are commonly used with other types of printers, so the printer 180 is also advantageous in terms of costs or the like.

Further, in the printer 200 shown in FIG. 5, it is possible to discriminate the front and back surfaces of the recording sheet A which has been stopped once while the leading edge thereof is abutted against the registration roller pair for registration, by using the front/back surface discriminating means 28a provided immediately upstream of the registration roller pair 70. Thus, it is possible to improve the accuracy of the discrimination of the front and back surfaces of the recording sheet A while maintaining the treatment capability of the printer 200. In addition, the printer 200 is advantageous in that it is possible to achieve those effects without increasing the number of the front/back surface discriminating means.

Further, in the printer 210 shown in FIG. 6, the discrimination of the front and back surfaces of the recording sheet A is performed on the recording sheet A which is contained in the loaded cassette 24, or the recording sheet A which is stacked or fed in the manual feeding unit 26 and is stopped. Thus, it is possible to improve the accuracy of the discrimination of the front and back surfaces of the recording sheet A while maintaining the treatment capability of the printer 210. In addition, the front and back surfaces of the recording sheet A can be discriminated before the recording sheet A is supplied to the transport path, thereby making it possible to select the recording sheet A which is appropriate for the image forming pattern. As a result, the printer 210 is advantageous in that it is possible to produce a print or prints with efficiency without unnecessarily reversing the recording sheet A.

Further, in the printer 220 shown in FIG. 7, the recording sheet A is contained in the cassette 24a with the transparent resin layer facing upward, and when the two-side print is produced, the recording sheet A is supplied from the cassette 24a. As a result, the printer 220 is advantageous in that it is possible to eliminate a process of reversing the recording sheet A after recording an image on the transparent resin layer of the recording sheet A.

Accordingly, the structure to be employed may be appropriately determined according to the performance required for the printer, the costs, and the like.

Further, as in the printer 180 shown in FIG. 4, in the structure in which the second reversing means (i.e., second reversing unit 182) is provided immediately downstream of the image recording unit 14, the second reversing means may be provided, for example, between the position adjusting unit 15 and the surface treatment section 16.

While this structure is further advantageous in that the position adjusting unit 15 of the printer 180 is commonly used with other types of printers, the structure is disadvantageous in terms of the accuracy in position of the recording sheet A in the width direction when the recording sheet A is cut by the cutting unit 102 because the recording sheet A is reversed after the position adjustment thereof in the width direction is performed.

The printer and the image forming method according to the first aspect of the present invention are basically structured as described above.

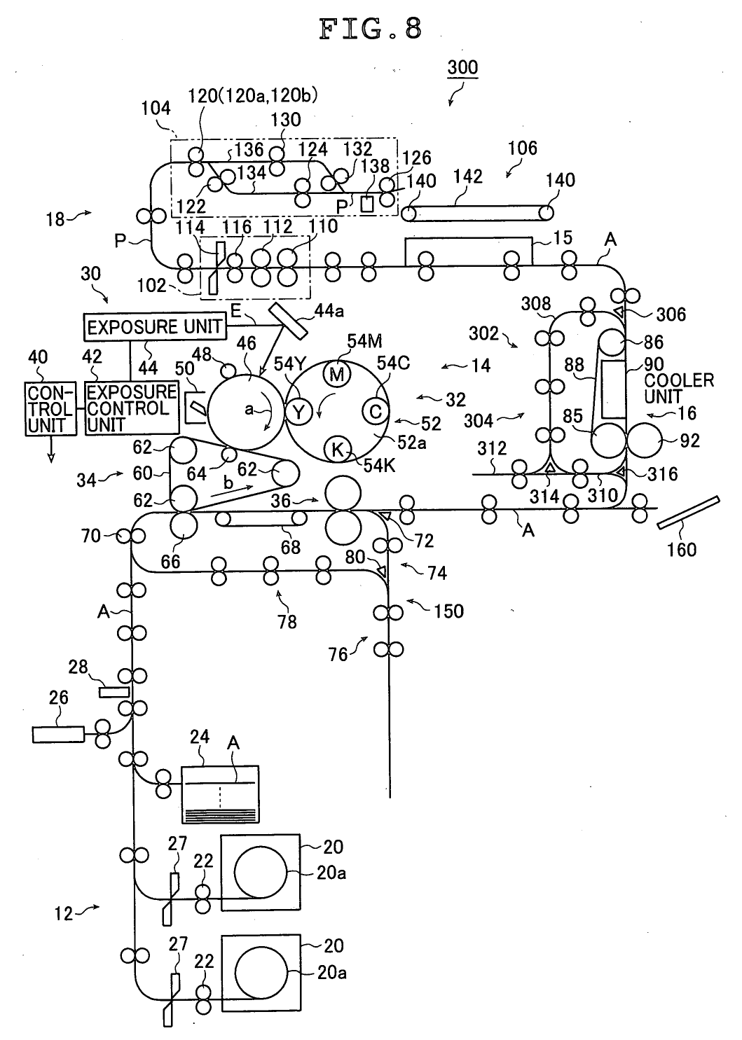

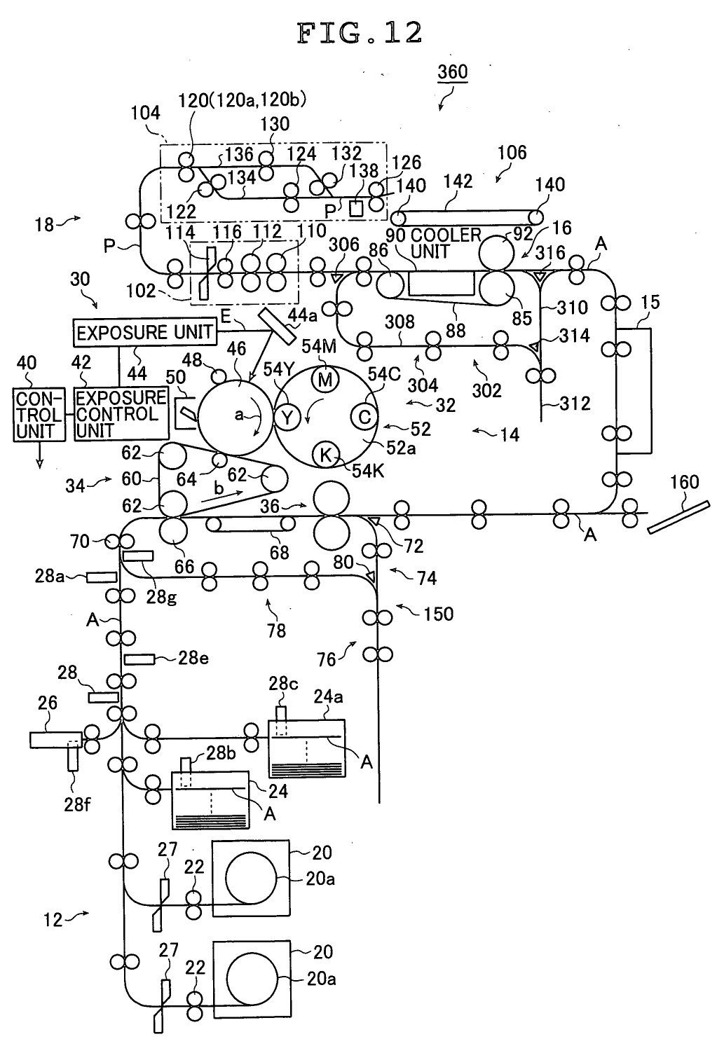

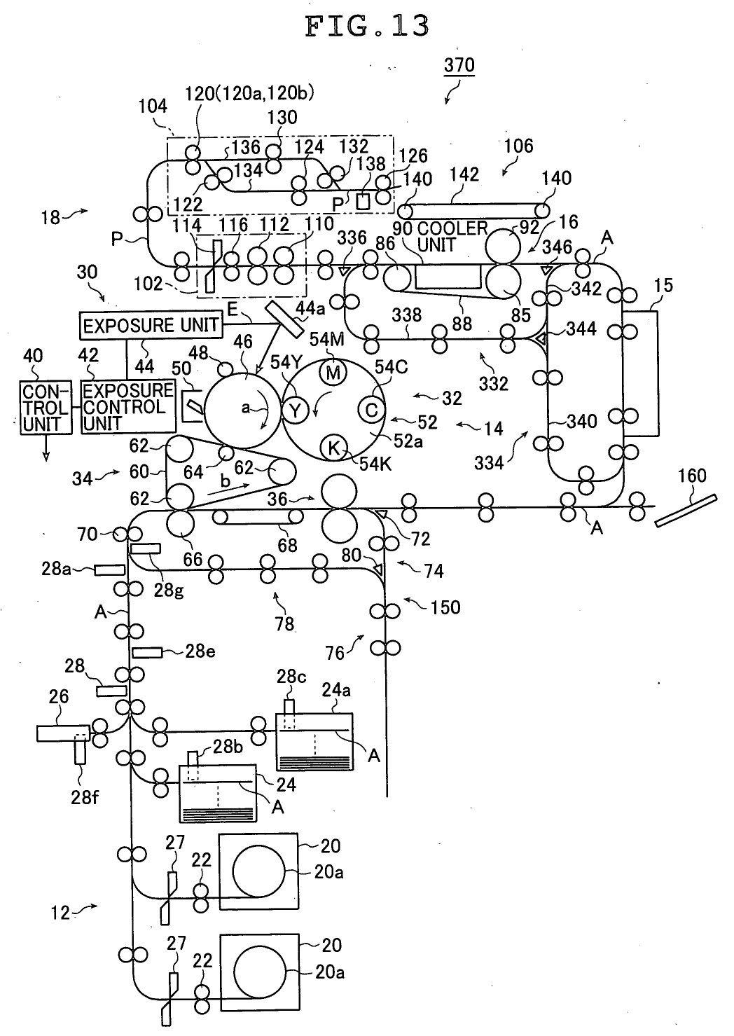

Next, with reference to FIGS. 8 to 13, a description is made of a printer and an image forming method according to a second aspect of the present invention.

FIG. 8 is a schematic diagram showing an embodiment of a printer according to the second aspect of the present invention for carrying out the image forming method according to the second aspect of the present invention.

A printer 300 shown in FIG. 8 has a structure basically similar to that of the printer 10 shown in FIG. 1 except for the following points. That is, the printer 300 includes a surface treatment unit 302 provided with the surface treatment section 16 and a second reversing unit 304 instead of the surface treatment section 16 and the second reversing unit 154, a surface treatment unit 302 and the position adjusting unit 15 are reversely arranged, and the position adjusting unit 15 is arranged on the downstream side of the surface treatment section 16, that is, the surface treatment unit 302. Accordingly, the same components are denoted by the same reference symbols, detailed descriptions thereof are omitted, and different parts are mainly described below.

Note that, according to the above-mentioned first aspect, for the recording sheet A to be used, used are the plain paper or the sheet for the one-side photographic-image-quality print which has the image recording layer, such as the transparent resin layer adapted for the surface treatment by the surface treatment section 16, formed on only one surface (i.e., one side) thereof. However, according to the second aspect, for the recording sheet A to be used, a sheet for a two-side photographic-image-quality print having image recording layers for surface treatment formed on both surfaces thereof can be used in addition to those sheets. Thus, according to the above-mentioned first aspect, also in a case of producing a finished photographic-image-quality print, the one-side photographic-image-quality print and the two-side photographic-image-quality print are produced using the sheet for the one-side photographic-image-quality print. On the other hand, according to the second aspect, a one-side-processed one-side print and a two-side-processed two-side print can be produced using a sheet for a two-side photographic-image-quality print in addition to those sheets.

The printer 300 shown in FIG. 8 records an image on the recording sheet A by electrophotographic process to produce a print P similarly to the printer 10 shown in FIG. 1. The printer 300 mainly includes the supplying unit 12, the image recording unit 14 provided with the first reversing unit 150, the surface treatment unit 302 provided with the surface treatment section 16 and the second reversing unit 304, the position adjusting unit 15, the cutting/arranging unit 18, and the control unit 40.

Note that, also in the printer 300, the control unit 40 controls the entirety of the printer 300 including the respective parts, such as the first reversing unit 150 of the image recording unit 14 and the second reversing unit 304 of the surface treatment unit 302 which characterize the present invention, components, and operations thereof in order to cause the respective parts thereof to perform the image forming method or the like according to the present invention.

The supplying unit 12 includes two loading units for loading the magazines 20, a loading unit for the cassette 24, the manual feeding unit 26, and the front/back surface discriminating means 28.

Note that, also in the printer 300 according to this aspect, the arrangement of the magazines 20, the cassette 24, and the manual feeding unit 26 is not limited to the illustrated example, but any arrangement thereof may be adopted.

As described above, in the printer 300 according to this embodiment, the sheet for a photographic-image-quality print having the image recording layer on which the surface treatment is performed on at least one surface, particularly, on both surfaces thereof, is preferably used as the recording sheet A. In particular, the sheet for a photographic-image-quality print is preferably used as the recording sheet A. Such sheet for a photographic-image-quality print has the transparent resin layer composed of a thermoplastic resin formed on at least one surface, particularly, on both surfaces of a base material made of paper or the like as the image recording layer. Further, with the sheet for a photographic-image-quality print, it is possible to obtain a print with a photographic image quality and with an excellent gloss by the surface treatment.

Note that, detecting means and reading means (not shown) of the recording sheet A are arranged in the respective loading units of the magazines 20 and the cassette 24. The detecting means detects a width (i.e., size) of the recording sheet rolls 20a contained in the magazines 20, a size (i.e., width×length) of the recording sheet A contained in the cassette 24, a type of the recording sheet A, such as, the sheet for one-side photographic-image-quality print having the image recording layer such as the transparent resin layer adapted for the surface treatment formed on one surface thereof, the sheet for two-side photographic-image-quality print having the image recording layer such as the transparent resin layer adapted for the surface treatment formed on both surfaces thereof, or normal plain paper. Further, the reading means reads out the type of the recording sheet.

In the printer 300, the recording sheet A having the image recording layer (e.g., transparent resin layer), which is formed only on one surface thereof and adapted for the surface treatment by the surface treatment unit 302, is preferably contained in the magazines 20 or the cassette 24 such that the image recording layer faces (i.e., state where surfaces are opposed to each other to be in contact with each other) the transferring unit 34 (i.e., transfer belt 60) (i.e., faces upward in the drawing) in the image recording unit 14. Thus, in the printer 300 of the illustrated example, it is set as a default that the recording sheet roll 20a having the image recording layer formed on one surface thereof is wound with the image recording layer being outside, and the recording sheet A having the image recording layer formed on one surface thereof is contained in the cassette 24 with the image recording layer facing downward. In a case of using the recording sheet A having the image recording layers formed on both surfaces thereof, such as the above-mentioned sheet for two-side photographic-image-quality print, the recording sheet A may be contained in the magazines 20 or the cassette 24 such that one of the surfaces faces (i.e., so as to face upward in the drawing) the transferring unit 34 (i.e., transfer belt 60) of the image recording unit 14.

As described above, with regard to the recording sheet rolls 20a contained in two magazines 20 loaded in the magazine loading units of the supplying unit 12, information such as types of surfaces, for example, plain paper, a sheet for a one-side photographic-image-quality print, a sheet for a two-side photographic-image-quality print, or sizes (i.e., widths) thereof is automatically read out to the control unit 40 from (a DIP switch, a bar-code, or a memory provided in) the magazines 20 at the time when the magazines are loaded by the above-mentioned detecting means or the reading means (not shown), or inputted to the control unit 40 by an operator. As a result, it is basically possible to select the recording sheet roll 20a adapted for a condition of the size of the print to be outputted or the surface type thereof according to a condition of finishing the print to be outputted, for example, whether the surface treatment such as gloss treatment for photographic image quality is to be performed, or which one of the one-side surface treatment and the two-side surface treatment is to be performed.

However, with respect to the recording sheet A contained in the cassette 24 loaded into the cassette loading unit or the recording sheet A fed from the manual feeding unit 26, it is usually difficult to acquire information on the type of the recording sheet A such as the surface type thereof. Also in the case the above-mentioned magazines 20, an error may be caused when the information is read out or inputted as described above.

As a result, in the printer 300 according to this aspect, the front/back surface discriminating means 28 is arranged on the transport path (i.e., the above-mentioned vertical transport path) for the recording sheet A of the supplying unit 12. In other words, the front/back surface discriminating means 28 is provided in the vertical transport path for the recording sheet A downstream (i.e., upward in the drawing) of the manual feeding unit 26 in the supplying unit 12, and also is arranged on a left side of the vertical transport path.

The front/back surface discriminating means 28 discriminates whether or not the transfer surface serving as the measuring surface of the recording sheet A is the image recording layer, that is, performs discrimination of the surface type only of the measuring surface of the recording sheet A as described above. When the type of the recording sheet A is discriminated in advance, the surface type of the non-transfer surface which is a non-measuring surface of the recording sheet A can also be discriminated.

In particular, in a case of using the sheet for the one-side photographic-image-quality print as the recording sheet A, when the front/back surface discriminating means 28 determines that the transfer surface of the recording sheet A is the front surface which is the image recording layer, the non-transfer surface of the recording sheet A can be determined to be the back surface which is the plain paper surface. When the front/back surface discriminating means 28 determines that the transfer surface of the recording sheet A is the back surface which is the plain paper surface, the non-transfer surface of the recording sheet A can be determined to be the front surface which is the image recording layer. Thus, the front/back surface discriminating means 28 discriminates the front and back surfaces of the recording sheet A. In a case where the front/back surface discriminating means 28 determines that the transfer surface of the recording sheet A is the image recording layer, when the sheet for the two-side photographic-image-quality print is used as the recording sheet A, the non-transfer surface of the recording sheet A can be also determined to be the same image recording layer. To the contrary, in a case where the front/back surface discriminating means 28 determines that the transfer surface of the recording sheet A is the plain-paper layer, when the plain paper is used as the recording sheet A, the non-transfer surface of the recording sheet A can be also determined to be the same plain paper surface.

Thus, the front/back surface discriminating means 28 can discriminate the types of both surfaces of the recording sheet A when the type of the recording sheet A is already known. As a result, according to this embodiment, similarly to the first aspect, the discrimination of the front and back surfaces of the recording sheet A means the discrimination of the surface type of the recording sheet by taking the case of the sheet for the one-side photographic-image-quality print into consideration.

When the front/back surface discriminating means 28 determines that the transfer surface of the recording sheet A is the image recording surface, or when the front/back surface discriminating means 28 determines that the transfer surface is the plain paper surface in a case of performing one-side-processed two-side printing or plain paper printing, the recording sheet A cut in a predetermined size by the cutters 27, the recording sheet A drawn out from the cassette 24, and the recording sheet A supplied from the manual feeding unit 26 are directly transported to the image recording unit 14 provided above, by the transport roller pair constituting the vertical transport path. Then, the recording sheet A stands by, for example, at the registration roller pair 70 provided immediately upstream of the transfer roller 66 for registration.

The image recording unit 14 is a portion for forming an image on the recording sheet A by the electrophotographic process as described above. The image recording unit 14 includes the exposure unit 30, the toner image forming unit 32, the transferring unit 34, the primary fixing roller pair 36, and the first reversing unit 150.

In the image recording unit 14, a latent image is formed on the photosensitive drum 46 of the toner image forming unit 32 with a light beam which is emitted from the exposure unit 30 and carries an image, and the formed latent image is developed with toner of the predetermined color, thereby forming a toner image on the photosensitive drum 46. The formed toner image is repeatedly transferred onto the transfer belt 60 of the transferring unit 34 while performing registration on the transfer belt 60 to form a color toner image. Then, the recording sheet A which is on standby at the registration roller pair 70 is transported in accordance with the movement of the transfer belt 60, the color toner image formed on the transfer belt 60 is transferred onto the recording sheet A to form a color image, and the color image is fixed by the primary fixing roller pair 36. After that, in a case of performing two-side printing, the recording sheet A is reversed in the first reversing unit 150, and the recording sheet A is subjected to the image formation again. Then, similarly, the color image is formed on an opposite surface and the image is fixed thereon.

Also in the printer 300 according to this aspect, the image forming method is not limited to the electrophotographic process, and various known image forming methods similar to that of the first aspect can be employed. The recording sheet A having the image recording layer (e.g., image receiving layer for ink jet recording) in which those image recording methods are applied on at least one surface, particularly, on both surfaces thereof, with the image recording layer being subjected to the surface treatment if needed, is preferably used as the recording sheet A (i.e., image recording medium of an image receiving medium or the like).

In a case where the front/back surface discriminating means 28 determines that the transfer surface of the recording sheet A is the plain paper surface when the one-side-processed one-side printing is performed, which will be described in detail later, the recording sheet A supplied from the supplying unit 12 may be transported to the image recording unit 14 to pass through the image recording unit 14 without recording an image or fixing the image thereon. Then, the recording sheet A may be reversed in the first reversing unit 150, and the recording sheet A may be supplied to the registration roller pair 70, to thereby record the image on the image recording surface of the recording sheet A which has been reversed, in the image recording unit 14 (i.e., transferring unit 34) and fix the image thereon.

In a case where surface types of both surfaces of the recording sheet A are inappropriate with respect to the finished state of both surfaces of the print P to be produced, which is determined based on the discrimination result of the transfer surface of the recording sheet A by the front/back surface discriminating means 28, for example, in producing a two-side-processed two-side print, when the type of the recording sheet A is determined to be the sheet for the one-side photographic-image-print or the plain paper, the recording sheet A supplied from the supplying unit 12 may be transported to the image recording unit 14 to allow the recording sheet A to pass through the image recording unit 14 without recording an image and fixing the image thereon, and may be outputted as an inappropriate recording sheet to the plain paper discharge tray 160 without reversing the recording sheet A in the first reversing unit 150.

According to this aspect, the recording sheet A on which the image is fixed by the primary fixing roller pair 36 of the image recording unit 14, is transported to the surface treatment unit 302, and is then transported to the position adjusting unit 15.

In the illustrated example, the surface treatment unit 302 includes the surface treatment section 16 and the second reversing unit 304.

The surface treatment section 16 includes the heating roller 85, the roller 86, the surface treatment belt 88 which is an endless belt suspended by the heating roller 85 and the roller 86, the cooler unit 90, and the nip roller 92.

As is apparent from FIG. 8, the recording sheet A on which the image has been recorded (i.e., transferred)/fixed is transported to the surface treatment section 16 of the surface treatment unit 302 such that the transfer surface on which the image has been last recorded faces the surface treatment belt 88.

In the surface treatment section 16, the recording sheet A is first nipped and transported by the surface treatment belt 88 (i.e., heating roller 85) and the nip roller 92, and the transfer surface on which the image is last recorded of the recording sheet A is allowed to abut against the surface of the surface treatment belt 88 to be pressed thereagainst, thereby heating the recording sheet A by the heating roller 85. As a result, the recording sheet A is transported by the surface treatment belt 88 in a state where the transparent resin layer thereof is melted to be slightly adhered to the surface treatment belt 88. During the transportation, the melted transparent resin layer of the recording sheet A is cooled by the cooler unit 90 to be coagulated.

The cooled recording sheet A is detached from the surface treatment belt 88 at a returning portion of the surface treatment belt 88 by the roller 86. Then, the recording sheet A is supplied to a downstream, specifically, to the second reversing unit 304 in a case of producing the two-side-processed two-side print, or is transported to the position adjusting unit 15 in other cases.

The second reversing unit 304 reverses the recording sheet A to perform the surface treatment for producing the so-called two-side-processed two-side print in which images have been recorded on both surfaces thereof.

In the illustrated example, the second reversing unit 304 includes a first switching means 306, a branch transport path 308, a return transport path 310, a reverse transport path 312, a second switching means 314, and a third switching means 316. The first switching means 306 is arranged downstream of the surface treatment section 16 (i.e., roller 86). The branch transport path 308 is provided by being branched from the transport path extending from the surface treatment section 16. The return transport path 310 is branched into two from the branch transport path 308 in the vicinity of the downstream end, and reaches upstream of the surface treatment section 16. The reverse transport path 312 branches to an opposite side of the return transport path 310 from the branch transport path 308. The second switching means 314 is provided at a branch point between the return transport path 310 and the reverse transport path 312. The third switching means 316 is provided at a merging point of a branch point between the transport path to the surface treatment section 16 and the return transport path 310.

The first switching means 306 and the second switching means 314 are known switching means for switching the transport path for sheet-like materials, such as a flapper, for operating on transport paths to guide the recording sheet A to a predetermined transport path.

In addition, respective transport paths are known transporting means for sheet-like materials, which are each provided with a transport roller pair and a transport guide. The reverse transport path 312 is a transport path capable of transporting the recording sheet A in forward and backward directions. Further, the return transport path 310, which is to be described in detail later, operates as the reverse transport path, so the return transport path 310 is also capable of transporting the recording sheet A in forward and backward directions.

Similarly to the first reversing unit 150, the second reversing unit 304 also reverses the recording sheet A by so-called switch-back. An operation of the second reversing unit 304 will be described in detail later.

The recording sheet A whose one surface or both surfaces are subjected to the surface treatment in the surface treatment unit 302 is transported to the position adjusting unit 15.

The position adjusting unit 15 moves the recording sheet A, which has been subjected to the surface treatment in the surface treatment unit 302, in the width direction if needed, and, for example, changes the position of the recording sheet A in the width direction which is supplied to the cutting/arranging unit 18 for each order.

The recording sheet A whose position in the width direction is set to the predetermined position by the position adjusting unit 15, is subsequently transported to the cutting unit 102 of the cutting/arranging unit 18.

The cutting/arranging unit 18 includes the cutting unit 102, the arranging unit 104, and the discharge unit 106.

The recording sheet A transported to the cutting/arranging unit 18 from the position adjusting unit 15 is first cut in the cutting unit 102 into one or more print sizes to produce prints P (i.e., hard copies) to be outputted as products.

Next, the prints P cut (i.e., obtained from the recording sheet A) in the cutting unit 102 are subsequently transported to the arranging unit 104, are rearranged in a single line in the arranging unit 104 if needed, are transported from the arranging unit 104, and then are discharged to the discharge unit 106.

The printer 300 shown in FIG. 8 according to the second aspect of the present invention is basically structured as described above.

Hereinafter, a description is made of the operation of the printer 300 and the image forming method according to the second aspect of the present invention.

The printer 300 has a mode of producing a so-called one-side print in which an image is formed only on one surface, and the recorded image is subjected to the surface treatment such as gloss treatment, for example, by using a sheet for a photographic-image-quality print having an image recording layer (hereinafter, represented by the transparent resin layer) formed on one surface or on both surfaces thereof. In the printer 300, in the one-side printing mode, the recording sheet A is first drawn out from the magazines 20 containing the sheet for a photographic-image-quality print in the supplying unit 12 based on the control by the control unit 40, and is cut in a predetermined size by the cutters 27. Alternatively, the recording sheet A is taken out from the cassette 24 containing the sheet for a photographic-image-quality print, or the sheet for a photographic-image-quality print is taken out to be fed in the manual feeding unit 26 as the recording sheet A, and then the recording sheet A is supplied from the supplying unit 12.

The recording sheet A supplied from the supplying unit 12 is transported to the image recording unit 14, and the front/back surface discriminating means 28 discriminates whether or not the directions of the front and back surfaces of the recording sheet A are appropriate (i.e., whether or not the transparent resin layer of the recording sheet A faces the front/back surface discriminating means 28) while the recording sheet A is being transported.

Herein, when the front/back surface discriminating means 28 determines that the directions of the front and back surfaces of the recording sheet A are appropriate, image formation is directly performed on the transparent resin layer of the supplied recording sheet A in the image recording unit 14 based on the control by the control unit 40. On the other hand, when the front/back surface discriminating means 28 determines that the directions of the front and back surfaces of the recording sheet A are inappropriate, based on the control by the control unit 40, in the image recording unit 14, the transfer roller 66 of the transferring unit 34 is caused to move to a position at which the transfer roller 66 is spaced apart from the transfer belt 60. Further, image fixing is not performed by the primary fixing roller pair 36, and preferably, the supplied recording sheet A is allowed to pass through the transferring unit 34 and the primary fixing roller pair 36 without performing image formation thereon in a state where the rollers are spaced apart from each other to be released from nipping. Then, after the recording sheet A is reversed in the first reversing unit 150 of the image recording unit 14, the recording sheet A is supplied again to the registration roller pair 70 provided upstream of the image recording unit 14, and the image recording is performed on the transparent resin layer of the supplied recording sheet A in the image recording unit 14. When the front/back surface discriminating means 28 determines that the directions of the front and back surfaces of the recording sheet A are inappropriate, the recording sheet A may be loaded again in the cassette 24 after being reversed to provide the recording sheet A to the image recording unit 14. When the sheet for a photographic-image-quality print having transparent resin layers on both surfaces thereof is used as the recording sheet A, the result of the discrimination by the front/back surface discriminating means 28 does not indicate that the direction of the recording sheet A is inappropriate.

Thus, in any case, since the transparent resin layer of the recording sheet A becomes a surface facing (abutting against) the transfer belt 60, in the image recording unit 14, the toner image is transferred onto the transparent resin layer of the recording sheet A while the recording sheet A is nipped and transported by the transfer belt 60 and the transfer roller 66, and then the recording sheet A is nipped and transported by the primary fixing roller pair 36 to fix the toner image thereon and record the image thereon.

Next, the recording sheet A on which the image has been recorded is directly transported to the surface treatment section 16 of the surface treatment unit 302 without reversing the recording sheet A in the second reversing unit 304 of the surface treatment unit 302, and is further nipped and transported by the surface treatment belt 88 and the nip roller 92. Then, the recording sheet A is heated and pressed against/adhered to the surface treatment belt 88. Further, the recording sheet A is cooled by the cooler unit 90 and is detached from the surface treatment belt 88, thereby performing the surface treatment (i.e., gloss treatment) on the transparent resin layer of the recording sheet A.

Further, the recording sheet A subjected to the surface treatment is transported to the position adjusting unit 15 to adjust the position of the recording sheet A in the width direction, and is then transported to the cutting unit 102. In the cutting unit 102, the first slitter 110 and optionally the second slitter 112 cut the recording sheet A whose position has been adjusted into the print size in the width direction. Then, the guillotine cutter 114 cuts the sheet into the print size in the transport direction thereby obtaining individual prints P. In the arranging unit 104, the prints P are rearranged in a single line if needed and then discharged to the discharge unit 106.

Note that the respective parts used in producing the above-mentioned one-side print are operated based on the control by the control unit 40.

Further, the printer 300 has a mode of producing a one-side-processed two-side print by using a sheet for a photographic-image-quality print, which has a transparent resin layer (i.e., image recording layer) formed only on one surface (i.e., one side), as the recording sheet A. In the printer 300, in the one-side-processed two-side printing mode, the recording sheet A is supplied from the supplying unit 12 to the image recording unit 14 in a similar manner as in the one-side printing, and the front/back surface discriminating means 28 discriminates whether or not the directions of the front and back surfaces of the recording sheet A are appropriate.

Herein, when the front/back surface discriminating means 28 determines that the directions of the front and back surfaces of the recording sheet A are appropriate, as in the case of the above-mentioned one-side printing, image recording in which the transparent resin layer (i.e., front surface) of the supplied recording sheet A is required to be directly subjected to the surface treatment is performed in the image recording unit 14 based on the control by the control unit 40. On the other hand, when the front/back surface discriminating means 28 determines that the directions of the front and back surfaces of the recording sheet A are inappropriate, differently from the case of the above-mentioned one-side printing, image recording in which a surface (hereinafter, referred to as “plain paper surface”) (i.e., back surface) opposite to the transparent resin layer of the supplied recording sheet A supplied to the image recording unit 14 is not required to be directly subjected to the surface treatment is performed based on the control by the control unit 40.

In other words, in any case, in the image recording unit 14, the toner image is transferred onto the transparent resin layer (i.e., front surface) or the plain paper surface (i.e., back surface) of the recording sheet A in the transferring unit 34. Then, the recording sheet A is nipped and transported by the primary fixing roller pair 36, and the toner image is fixed thereon. Thus, the image is first recorded on the transparent resin layer (i.e., front surface) or the plain paper surface (i.e., back surface) of the recording sheet A.

Herein, since the two-side printing is performed, the recording sheet A is delivered to the first reversing unit 150, is reversed in the same manner as described above, and is then transported to the registration roller pair 70. As a result, the transparent resin layer (i.e., front surface) or the plain paper surface (i.e., back surface) of the recording sheet A is set as a transfer surface of a side (i.e., surface facing the transfer-belt 60) to be recorded (i.e., transferred) with the image.

As described above, the recording sheet A whose transparent resin layer (i.e., front surface), which is the image recording layer, or plain paper surface (i.e., back surface) has been recorded with the image is reversed, and is supplied to the image recording unit 14. Then, in the same manner as described above, the toner image is transferred on the transparent resin layer (i.e., front surface) or the plain paper surface (i.e., back surface) of the recording sheet A in the transferring unit 34, and the recording sheet A is nipped and transported by the primary fixing roller pair 36 to fix the toner image thereon, thereby recording the image on both the transparent resin layer (i.e., front surface) and the plain paper surface (i.e., back surface).

Then, when the directions of the front and back surfaces of the recording sheet A are appropriate, the image is first recorded on the transparent resin layer (i.e., front surface) of the recording sheet A, and the recording sheet A is reversed to subsequently perform the image recording on the plain paper surface (i.e., back surface). On the contrary, when the directions of the front and back surfaces of the recording sheet A are inappropriate, the image is first recorded on the plain paper surface (i.e., back surface) of the recording sheet A, and the recording sheet A is reversed to subsequently perform the image recording on the transparent resin layer (i.e., front surface). In any case, the image which is not required to be subjected to the surface treatment is recorded on the plain paper surface (i.e., back surface) of the recording sheet A.

After images has been recorded on both surfaces of the recording sheet A, the recording sheet A is transported to the surface treatment section 16 of the surface treatment unit 302.

First, when the directions of the front and back surfaces of the recording sheet A are appropriate, the image is last recorded on the plain paper surface (i.e., back surface) in the image recording unit 14 as described above. When the recording sheet A is transported in such state, the plain paper surface of the recording sheet A faces the surface treatment belt 88 in the surface treatment section 16.

Accordingly, the recording sheet A is reversed in the second reversing unit 304 to set the transparent resin layer as the surface to be subjected to the surface treatment, and is then supplied to the surface treatment section 16 of the surface treatment unit 302.

To be specific, in order to reverse the recording sheet A in the second reversing unit 304, the above-mentioned third switching means 316 is caused to operate on the transport path from the image recording unit 14 to the surface treatment section 16 to draw the recording sheet A into the return transport path 310.

At a time point when the trailing edge of the recording sheet A reaches the downstream of the third switching means 316, transportation of the recording sheet A on the return transport path 310 (i.e., reverse transport path 312) is stopped, and then the third switching means 316 is switched to guide the recording sheet A from the return transport path 310 (i.e., reverse transport path 312) to the surface treatment section 16.

After the third switching means 316 has been switched, the recording sheet A is transported on the return transport path 310 (i.e., reverse transport path 312) in a direction opposite to the former direction, and is further transported on the transport path extending from the image recording unit 14 to the surface treatment section 16. Then, the recording sheet A is reversed, and is supplied to the surface treatment section 16.

Accordingly, the recording sheet A is supplied to the surface treatment section 16 with the transparent resin layer thereof being the surface adapted for the surface treatment.

On the other hand, when the directions of the front and back surfaces of the recording sheet A are inappropriate, as described above, in the image recording unit 14, the transparent resin layer (i.e., front surface) of the recording sheet A is last recorded with the image. Thus, even when the recording sheet A is transported to the surface treatment unit 302 in such state, in the surface treatment section 16, the transparent resin layer of the recording sheet A faces the surface treatment belt 88. Accordingly, even when the recording sheet A is directly transported without being reversed in the second reversing unit 304 of the surface treatment unit 302, the recording sheet A can be supplied to the surface treatment section 16 with the transparent resin layer being the surface to be subjected to the surface treatment.

In the surface treatment section 16 of the surface treatment unit 302, in any case, as described above, the transparent resin layer (i.e., front surface) of the recording sheet A is heated/pressed against the surface treatment belt 88 to thereby be adhered thereto. Then, the recording sheet A is cooled while being transported, is detached from the surface treatment belt 88, thereby performing the surface treatment on the transparent resin layer.

In addition, in the same manner as described above, the recording sheet A subjected to the surface treatment is transported to the position adjusting unit 15 to adjust the position of the recording sheet A in the width direction, and is then transported to the cutting unit 102. In the cutting unit 102, the recording sheet A is cut in the width direction and transport direction to be produced as separate prints P. Further, in the arranging unit 104, the prints P are rearranged in a single line if needed and then discharged to the discharge unit 106.

Note that the respective parts used in producing the above-mentioned one-side-processed two-side print are operated based on the control by the control unit 40.

Further, the printer 300 has a mode of producing a two-side-processed two-side print in which the surface treatment is performed on both surfaces by using a sheet for a photographic-image-quality print, which has transparent resin layers, which serve as image recording layers, formed on both surfaces, as the recording sheet A. In the printer 300, in the two-side-processed two-side printing mode, the recording sheet A is supplied from the supplying unit 12 to the image recording unit 14 in a similar manner as in the one-side-processed two-side printing.

In the image recording unit 14, the toner image is transferred onto the image recording layer of the front surface of the recording sheet A in the transferring unit 34, and the toner image is fixed thereon while the recording sheet A is nipped and transported by the primary fixing roller pair 36, thereby first recording the image on the transparent resin layer of the front surface of the recording sheet A. Herein, with regard to the recording sheet A, the surface to be first recorded with the image is set as a first surface, and the surface to be subsequently recorded with the image is set as a second surface.

When the two-side printing is performed, as described above, the recording sheet A is delivered to the first reversing unit 150, is reversed, and is then transported to the registration roller pair 70 to set the second surface of the recording sheet A as the surface (i.e., surface facing the transfer belt 60) adapted for the image recording.

Thus, the recording sheet A whose transparent resin layer of the first surface has been thus recorded with the image is reversed, and is supplied to the image recording unit 14. Then, in the same manner as described above, the toner image is transferred onto the second surface of the recording sheet A in the transferring unit 34, and the toner image is fixed thereon while the recording sheet A is nipped and transported by the primary fixing roller pair 36, thereby recording images on both the first surface which is the transparent resin layer and the second surface which is also the transparent resin layer.

In the image recording unit 14, after the images are recorded on both surfaces of the recording sheet A, the recording sheet A is transported to the surface treatment unit 302.

In the image recording unit 14, since the second surface is last recorded with the image, when the recording sheet A is transported in such state, the second surface of the recording sheet A faces the surface treatment belt 88 in the surface treatment section 16 of the surface treatment unit 302.

In the surface treatment section 16, as described above, the transparent resin layer of the second surface of the recording sheet A is heated/pressed against the surface treatment belt 88 thereby to be adhered thereto. Then, the recording sheet A is cooled while being transported, is detached from the surface treatment belt 88, thereby performing the surface treatment on the second surface.

Herein, when the two-side print is produced by using a sheet for a photographic-image-quality print, which has transparent resin layers that are image recording layers formed on both surfaces, as the recording sheet A, the recording sheet A is delivered to the second reversing unit 304, and then the recording sheet A is reversed. Further, the recording sheet A is supplied again to the upstream of the surface treatment section 16 (i.e., surface treatment unit 302). As a result, the transparent resin layer of the first surface of the recording sheet A faces the surface treatment belt 88.

In the printer 300, when the surface treatment is performed on both surfaces of the two-side print, the first switching means 306 is caused to operate on the transport path from the surface treatment section 16 to perform the surface treatment in the surface treatment section 16. Then, the detached recording sheet A is delivered to the branch transport path 308, and is then transported to the second switching means 314. Subsequently, the second switching means 314 is caused to operate on the branch transport path 308 to draw the recording sheet A into the reverse transport path 312.

At a time point when the trailing edge of the recording sheet A passes through the second switching means 314 and is drawn into the reverse transport path 312, the transportation of the recording sheet A on the reverse transport path 312 is stopped. Then, the second switching means 314 is switched to guide the recording sheet A from the reverse transport path 312 to the return transport path 310. Finally, the third switching means 316 is caused to operate on the return transport path 310 to transport the recording sheet A to the upstream of the surface treatment section 16.

Thus, the recording sheet A which has been reversed is supplied again to the surface treatment section 16, thereby performing the surface treatment on both surfaces of the recording sheet A.

Next, the transparent resin layer of the front surface of the recording sheet A is heated/pressed against the surface treatment belt 88 thereby to be adhered thereto. Then, the recording sheet A is cooled while being transported, is detached from the surface treatment belt 88, thereby performing the surface treatment on the first surface of the recording sheet A. In other words, the surface treatment for the image recording layers formed on both surfaces of the recording sheet A is completed.

In the above-mentioned example, the second surface of the recording sheet A both surfaces of which have images recorded thereon in the image recording unit 14 is first subjected to the surface treatment in the surface treatment unit 302, the recording sheet A is reversed in the second reversing unit 304, and the first surface thereof is subjected to the surface treatment in the surface treatment unit 302. Alternatively, the recording sheet A both surfaces of which have images recorded thereon, and which is transported to the surface treatment unit 302 may be directly drawn into the return transport path 310 and the reverse transport path 312 or the branch transport path 308 by causing the third switching means 316 to operate on the transport path. Then, the transportation of the recording sheet A may be stopped at a time point when the trailing edge thereof passes through the third switching means 316, and the third switching means 316 may be caused to operate on the return transport path 310 to return the recording sheet A to the transport path of the surface treatment unit 302. Thus, the front and back surfaces of the recording sheet A may be first reversed to first perform the surface treatment on the first surface thereof in the surface treatment unit 302, and then the recording sheet A may be reversed in the second reversing unit 304, to thereby perform the surface treatment on the second surface thereof in the surface treatment unit 302.

Further, in the same manner as described above, the recording sheet A subjected to the surface treatment is transported to the position adjusting unit 15 to adjust the position of the recording sheet A in the width direction, and is then transported to the cutting unit 102. In the cutting unit 102, the recording sheet A is cut in the width direction and transport direction to be produced as separate prints P. Further, in the arranging unit 104, the prints P are rearranged in a single line if needed and then discharged to the discharge unit 106.

As is apparent from the above description, the printer 300 includes, in addition to the first reversing unit 150 for recording images on both surfaces of the recording sheet A, the second reversing unit 304 for reversing the recording sheet A one surface of which has been subjected to the surface treatment after images are recorded on both surfaces thereof, and supplying the recording sheet A to the upstream of the surface treatment section 16. As a result, even when the recording sheet A having image recording layers (i.e., transparent layers) formed on both surfaces thereof is supplied, it is possible to produce a two-side print having high-quality images formed on both surfaces thereof, in which image recording layers of both surfaces have been recorded with images and have been subjected to surface treatment, without providing two surface treatment means with respect to one apparatus, in other words, without increasing the size, the manufacturing costs, and the power consumption of the apparatus, which may be caused by providing two surface treatment means.

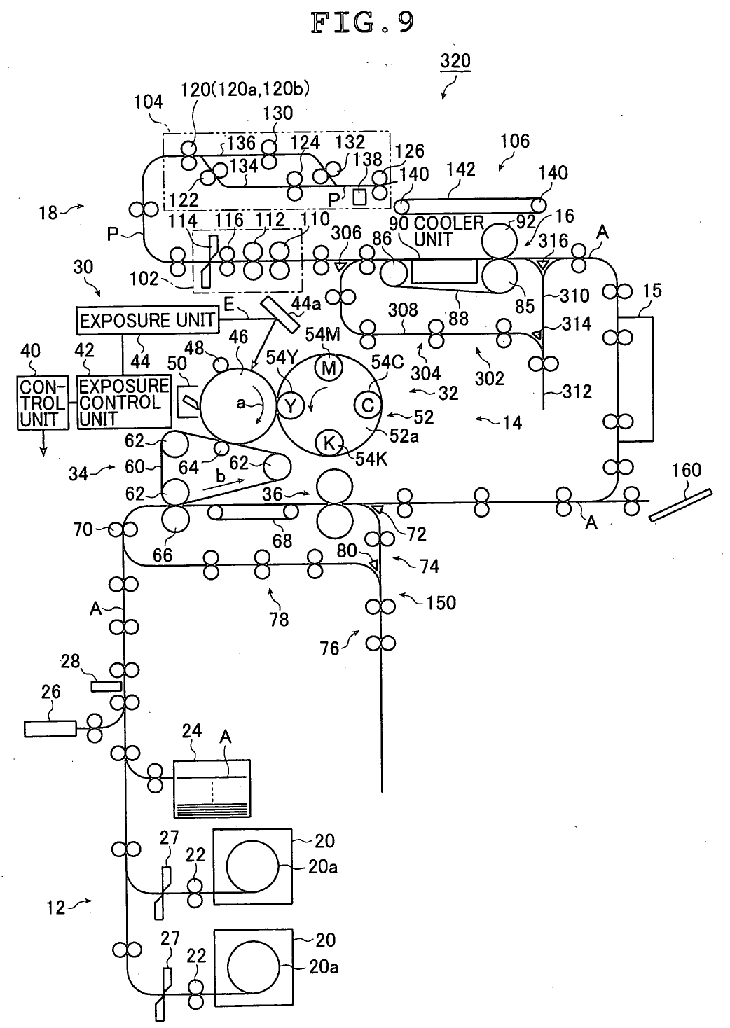

FIG. 9 is a schematic diagram showing another embodiment of a printer according to the present invention.

A printer 320 shown in FIG. 9 has a structure basically similar to that of the printer 300 shown in FIG. 8 except for the following points. That is, the surface treatment unit 302 and the position adjusting unit 15 are reversely arranged, and the surface treatment unit 302 is arranged downstream of the position adjusting unit 15. In addition, the operations and effects of the printer 320 are substantially equivalent to those of the printer 300. Accordingly, the same components are denoted by the same reference symbols, and detailed descriptions thereof are omitted. In the following, a description is made of only the operations of the printer 320 controlled by the control unit 40.

In the printer 320, the operation in the one-side printing mode in which a one-side print is produced under the control of the control unit 40 by using a sheet for a photographic-image-quality print as the recording sheet A is the same as that of the printer 300 except that the position adjustment of the recording sheet A is performed prior to the surface treatment. The image recording unit 14 records an image on the image recording layer of the recording sheet A, and the position adjusting unit 15 sets the position in the width direction of the recording sheet A having images recorded thereon to the predetermined position. Then, the surface treatment unit 302 subjects the image recording layer of the recording sheet A to surface treatment, and the cutting unit 102 cuts the recording sheet A into the size in the width direction of a print to be produced. Further, the cut prints are rearranged in a single line in the arranging unit 104, and then the arranged prints are discharged to the discharge unit 106.

Further, in the printer 320, also in the mode of producing the one-side-processed two-side print based on the control by the control unit 40 by using a sheet for a photographic-image-quality print, which has an image recording layer (i.e., transparent resin layer) formed on only one surface thereof, as the recording sheet A, the operation of the printer 320 is similar to that of the printer 300 except that the position adjustment of the recording sheet A is performed prior to the surface treatment. That is, the recording sheet A is first supplied from the supplying unit 12, and the front/back surface discriminating means 28 discriminates whether or not the directions of the front and back surfaces of the recording sheet A are appropriate. Then, the recording sheet A is transported to the image recording unit 14.

Herein, when the front/back surface discriminating means 28 determines that the directions of the front and back surfaces of the recording sheet A are inappropriate, the plain paper surface that is the back surface is first recorded with an image, and the recording sheet A is reversed in the first reversing unit 150. Then, the image recording is subsequently performed on the image recording layer of the front surface, thereby performing the image recording on both surfaces of the recording sheet A. On the other hand, when the front/back surface discriminating means 28 determines that the directions of the front and back surfaces of the recording sheet A are appropriate, the image recording layer of the front surface is first recorded with an image, and the recording sheet A is reversed in the first reversing unit 150. Then, the image recording is subsequently performed on the plain paper surface that is the back surface, thereby performing the image recording oh both surfaces.

In the image recording unit 14, as in the printer 300, images are recorded on both the image recording layer (i.e., front surface) and the normal plain paper surface (i.e., back surface) of the recording sheet A.

As described above, in the image recording unit 14, an image is last recorded on the image recording layer (in a case where the directions of the surfaces of the recording sheet A are inappropriate) of the front surface of the recording sheet A or the plain paper surface (in a case where the directions of the surfaces of the recording sheet A are appropriate) that is the back surface thereof. In the printer 320, the recording sheet A is transported to the position adjusting unit 15 in such state.

In the position adjusting unit 15, the position of the recording sheet A in the width direction is adjusted, and then the recording sheet A is transported to the surface treatment unit 302.

When the recording sheet A is transported from the position adjusting unit 15 in such state, in a case where the discrimination result as to the front and back surfaces of the recording sheet A by the front/back surface discriminating means 28 indicates the appropriate directions, in the surface treatment unit 302, the plain paper surface (i.e., back surface) of the recording sheet A faces the surface treatment belt 88.

Then, in the same manner as described above, in the second reversing unit 304, the recording sheet A is reversed, and the recording sheet A is supplied to the surface treatment unit 302 with the image recording layer (i.e., front surface) being the surface to be subjected to the surface treatment.

On the other hand, when the discrimination result as to the front and back surfaces of the recording sheet A by the front/back surface discriminating means 28 indicates the inappropriate directions, since the image recording layer (i.e., front surface) of the recording sheet A faces the surface treatment belt 88, the recording sheet A is supplied to the surface treatment unit 302 without being reversed in the second reversing unit 304 of the surface treatment unit 302.

In the surface treatment unit 302, in any case, as in the above-mentioned illustrated example, the image recording layer of the recording sheet A is heated/pressed against the surface treatment belt 88 to be adhered thereto, is cooled while the recording sheet A is transported, and is detached from the transfer belt, thereby performing the surface treatment on the image recording layer.

Next, in the same manner as described above, the recording sheet A is cut in the width direction and in the transport direction in the cutting unit 102 to be produced as separate prints P. Then, the prints P are rearranged in a single line in the arranging unit 104 if needed, and are discharged to the discharge unit 106.

Further, in the mode of producing a two-side print both surfaces of which are subjected to the surface treatment based on the control by the control unit 40 by using a sheet for a photographic-image-quality print, which has image recording layers (i.e., transparent resin layers) formed on both surfaces thereof, as the recording sheet A, the recording sheet A is supplied from the supplying unit 12 to the image recording unit 14.

In the image recording unit 14, as in the printer 300, images are recorded on image recording layers formed on both surfaces of the recording sheet A. Also in this case, with regard to the recording sheet A, the surface (i.e., image recording layer) to be first recorded with the image is set as a first surface, and the surface to be subsequently recorded with the image is set as a second surface.

As in the above-mentioned example, in the image recording unit 14, the second surface of the recording sheet A is last recorded with the image. In the printer 320, the recording sheet A is transported to the position adjusting unit 15 in such state. In other words, the recording sheet A is transported thereto with the second surface of the recording sheet A facing the position adjusting unit 15.

In the position adjusting unit 15, the position of the recording sheet A in the width direction is adjusted, and then the recording sheet A is transported to the surface treatment unit 302.

In the surface treatment section 16 of the surface treatment unit 302, the second surface of the recording sheet A faces the surface treatment belt 88. The image recording layer of the second surface of the recording sheet A is heated/pressed against the surface treatment belt 88 to be adhered thereto, is cooled while the recording sheet A is transported, and is detached from the surface treatment belt 88, thereby performing the surface treatment on the second surface of the recording sheet A.

Herein, in a case of producing a two-side print by using a sheet for a photographic-image-quality print, which has image recording layers (i.e., transparent resin layers) formed on both surfaces thereof, as the recording sheet A, similarly to the printer 300, the recording sheet A is delivered to the second reversing unit 304 to be reversed, and is again supplied to the upstream of the surface treatment unit 16. As a result, the image recording layer that is the first surface of the recording sheet A is heated/pressed against the surface treatment belt 88 to be adhered thereto, is cooled while the recording sheet A is transported, and is detached from the surface treatment belt 88, thereby performing the surface treatment on the first surface of the recording sheet A.

Then, in the same manner as described above, in the cutting unit 102, the recording sheet A is cut in the width direction and transport direction to be produced as separate prints P. Further, in the arranging unit 104, the prints P are rearranged in a single line if needed and then discharged to the discharge unit 106.

Note that, also in the printer 320, similarly to the printer 300, the recording sheet A may be reversed prior to the surface treatment, the first surface thereof may be first subjected to the surface treatment, the recording sheet A may be reversed again, and then the second surface thereof may be subjected to the surface treatment.

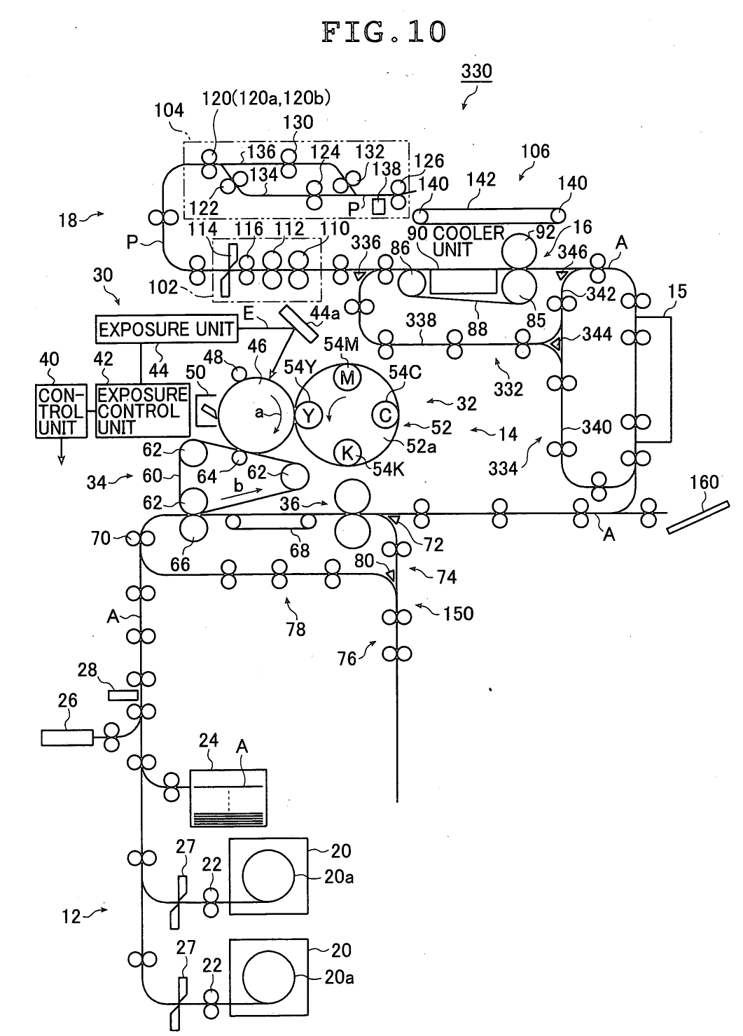

FIG. 10 is a schematic diagram showing another embodiment of the present invention.

A printer 330 shown in FIG. 10 has a structure basically similar to the printer 320 shown in FIG. 9 except for the following points. That is, the printer 330 includes a second reversing unit 334 having a structure different from the second reversing unit 304 of the printer 320. Accordingly, the same components are denoted by the same reference symbols, and detailed descriptions thereof are omitted. In the following, a description is mainly made of different parts. In the printer 330, the control unit 40 controls the first reversing unit 150 of the image recording unit 14 and the second reversing unit 334 of a surface treatment unit 332 instead of controlling the first reversing unit 150 of the image recording unit 14 and the second reversing unit 304 of the surface treatment unit 302.

In the printer 320 shown in FIG. 9, in a case of producing a two-side print, the recording sheet A is reversed after the position adjustment has been performed by the position adjusting means 15. As a result, an error may be caused in the position of the recording sheet A, which is supplied to the cutting unit 102, in the width direction.

In the printer 330 shown in FIG. 10, such inconvenience is resolved, and it is possible that the position adjustment is performed by the position adjusting unit 15 after reversing the recording sheet A, and then the recording sheet A is transported from the surface treatment unit 16 to the cutting unit 102 without further reversing the recording sheet A.

In the printer 330, the surface treatment unit 332 includes the surface treatment unit 16 and the second reversing unit 334. The second reversing unit 334 includes a first switching means 336, a branch transport path 338, a return transport path 340, a reverse transport path 342, a second switching means 344, and a third switching means 346. The first switching means 336 is arranged downstream of the surface treatment section 16. The branch transport path 338 branches from the transport path from the surface treatment section 16. The return transport path 340 is branched into two from the branch transport path 338 in the vicinity of the downstream end, and reaches the upstream of the position adjusting means 15. The reverse transport path 342 branches to an opposite side of the return transport path 340 from the branch transport path 338, and reaches the transport path downstream of the surface treatment unit 16. The second switching means 344 is provided at a branch point between the return transport path 340 and the reverse transport path 342. The third switching means 346 is provided at a merging point of a branch point between the transport path to the surface treatment section 16 and the reverse transport path 342.

Note that the branch transport path 338, the return transport path 340, and the reverse transport path 342 are transport paths capable of transporting the recording sheet A in forward and backward directions.

In the printer 330, the operation in the mode of producing the one-side print by using a sheet for a photographic-image-quality print as the recording sheet A is the same as that of the printer 320. The image recording unit 14 records an image on the recording sheet A, and the position adjusting unit 15 sets the position in the width direction of the recording sheet A having images recorded thereon to the predetermined position. Then, the surface treatment unit 332 subjects the image recording layer of the recording sheet A to surface treatment, and the cutting unit 102 cuts the recording sheet A into the size in the width direction of a print to be produced. Further, the cut prints are rearranged in a single line in the arranging unit 104, and then the arranged prints are discharged to the discharge unit 106.

Further, in the printer 330, in the mode of producing the one-side-processed two-side print by using a sheet for a photographic-image-quality print, which has an image recording layer (i.e., transparent resin layer) formed on only one surface thereof, as the recording sheet A, similarly to the printer 320, the recording sheet A is supplied from the supplying unit 12, and the front/back surface discriminating means 28 discriminates whether or not the directions of the front and back surfaces of the recording sheet A are appropriate. Then, the recording sheet A is transported to the image recording unit 14.

Herein, when the front/back surface discriminating means 28 determines that the directions of the front and back surfaces of the recording sheet A are inappropriate, image recording is first performed on the plain paper surface which is the back surface, the recording sheet A is reversed in the first reversing unit 150, and then image recording is again performed on the image recording layer of the front surface, thereby performing image recording on both surfaces thereof. On the other hand, when the front/back surface discriminating means 28 determines that the directions of the front and back surfaces of the recording sheet A are appropriate, image recording is first performed on the image recording layer of the front surface, the recording sheet A is reversed in the first reversing unit 150, and then image recording is again performed on the plain paper surface which is the back surface, thereby performing image recording on both surfaces thereof.

In the image recording unit 14, similarly to the printer 320, images are recorded on both the image recording layer (i.e., front surface) and the plain paper surface (i.e., back surface), which is opposite side thereof, of the recording sheet A.

As described above, in the image recording unit 14, an image is last recorded on the image recording layer (in a case where the directions of the surfaces of the recording sheet A are inappropriate) of the front surface of the recording sheet A or on the plain paper surface (in a case where the directions of the surfaces of the recording sheet A are appropriate) that is the back surface thereof. In the printer 330, the recording sheet A is transported from the image recording unit 14 to the position adjusting unit 15 in such state.

Herein, when the discrimination result as to the front and back surfaces of the recording sheet A by the front/back surface discriminating means 28 indicates the inappropriate directions, since the image recording layer (i.e., front surface) of the recording sheet A faces the surface treatment belt 88 in the surface treatment section 16, the recording sheet A is supplied to the surface treatment section 16 without reversing the recording sheet A in the second reversing unit 334 of the surface treatment unit 332. After that, the recording sheet A is subjected to the surface treatment in the surface treatment section 16, and is directly transported to the cutting unit 102.

On the other hand, when the discrimination result as to the front and back surfaces of the recording sheet A by the front/back surface discriminating means 28 indicates the appropriate directions, the recording sheet A is directly transported to the surface treatment section 16 of the surface treatment unit 332 without performing the position adjustment in the position adjusting unit 15.

In the surface treatment section 16, the surface treatment is performed on the image recording layer (i.e., front surface) of the recording sheet A.

When the recording sheet A is transported from the position adjusting unit 15 in such state, the recording sheet A is supplied to the surface treatment section 16 with the plain paper surface (i.e., back surface) thereof facing the surface treatment belt 88. Then, in the second reversing unit 334, the recording sheet A is reversed, and is supplied to the surface treatment unit 16 with the image recording layer (i.e., front surface) thereof being the surface to be subjected to the surface treatment.

To be specific, in order to reverse the recording sheet A in the second reversing unit 334, the third switching means 346 is caused to operate on the transport path from the position adjusting unit 15 to the surface treatment section 16 to draw the recording sheet A into the reverse transport path 342.

Then, the second switching means 344 is caused to operate on the reverse transport path 342 to draw the recording sheet A into the branch path 338. At a time point when the trailing edge of the recording sheet A passes through the second switching means 344 and is drawn into the branch transport path 338, transportation of the recording sheet A on the branch transport path 338 is stopped, and then the second switching means 344 is switched to guide the recording sheet A into the return transport path 340 from the branch transport path 338.

After the second switching means has been switched, the recording sheet A is transported in a direction opposite to the former direction on the branch transport path 338, and is further transported to the return transport path 340. At a time point when the trailing edge of the recording sheet A passes through the second switching means 344 and is drawn into the return transport path 340, transportation of the recording sheet A on the return transport path 340 is stopped, and then the recording sheet A is reversed such that the recording sheet A is transported from the return transport path 340 to the transport path which extends from the position adjusting unit 15 to the surface treatment section 16, thereby supplying the recording sheet A to the position adjusting unit 15. Similarly to the printer 320, the position adjusting unit 15 transports the recording sheet A to the surface treatment section 16 after adjusting the position of the recording sheet A in the width direction.

As a result, it is possible to supply the recording sheet A to the surface treatment section with the image recording layer (i.e., front surface) being the surface to be subjected to the surface treatment after the position of the recording sheet A has been adjusted in the position adjusting unit 15.

In the surface treatment section 16, in any case, in the same manner as described above, the image recording layer of the recording sheet A is heated/pressed against the surface treatment belt 88 to be adhered thereto, is cooled while the recording sheet A is transported, and is detached from the surface treatment belt, thereby performing the surface treatment on the image recording layer.

Then, in the same manner as described above, the recording sheet A is cut in the width direction and in the transport direction in the cutting unit 102 to be produced as separate prints P. Further, the prints P are rearranged in a single line in the arranging unit 104 if needed, and are discharged to the discharge unit 106.

Further, in the mode of producing the two-side-processed two-side print by using a sheet for a photographic-image-quality print, which has an image recording layer (i.e., transparent resin layer) formed on both surfaces, as the recording sheet A, in the same manner as described above, the recording sheet A is supplied from the supplying unit 12 to the image recording unit 14.

In the image recording unit 14, similarly to the printer 300, images are recorded on image recording layers formed on both surfaces of the recording sheet A. Also in this case, with regard to the recording sheet A, the surface (i.e., image recording layer) to be first recorded with the image is set as a first surface, and the surface to be subsequently recorded with the image is set as a second surface.

Also in the printer 330, in the image recording unit 14, the second surface of the recording sheet A is last recorded with the image, as in the printer 300.

Herein, in the printer 330, the recording sheet A is allowed to pass through the position adjusting unit 15 in a state (i.e., upward in the drawing) where the second surface thereof faces the transferring unit 34, and is transported to the surface treatment section 16.

In the surface treatment section 16, the image recording layer of the second surface of the recording sheet A is heated/pressed against the surface treatment belt 88 to be adhered thereto, is cooled while the recording sheet A is transported, and is detached from the surface treatment belt 88, thereby performing the surface treatment on the second surface of the recording sheet A.

Herein, in the printer 330, when a two-side print is produced by using a sheet for photographic-image-quality print, which has image recording layers (i.e., transparent resin layers) formed on both surfaces thereof, as the recording sheet A, the recording sheet A is delivered to the second reversing unit 334 to be reversed, and is supplied to the upstream of the position adjusting unit 15 again.

To be specific, in order to reverse the recording sheet A in the second reversing unit 334, the first switching means 336 is first caused to operate on the transport path from the surface treatment section 16 to the cutting/arranging unit 18 to draw the recording sheet A into the branch transport path 338.

Then, the second switching means 344 is caused to operate on the branch transport path 338 to draw the recording sheet A into the reverse transport path 342. At a time point when the trailing edge of the recording sheet A reaches the downstream of the second switching means 344, transportation of the recording sheet A on the reverse transport path 342 is stopped, and then the second switching means 344 is switched to guide the recording sheet A from the reverse transport path 342 to the return transport path 340.

After the second switching means 344 has been switched, the recording sheet A is reversed by being transported in a direction opposite to the former direction on the reverse transport path 342 and being further transported to the return transport path 340, and is supplied to the position adjusting unit 15.

As a result, the recording sheet A is supplied to the position adjusting unit 15 with the first surface being the surface facing the position adjusting unit 15.

In the position adjusting unit 15, in the same manner as described above, the recording sheet A is transported to the surface treatment section 16 after the position of the recording sheet A in the width direction has been adjusted.

In the surface treatment unit 16, the image recording layer of the first surface of the recording sheet A is heated/pressed against the surface treatment belt 88 to be adhered thereto, is cooled while the recording sheet A is transported, and is detached from the surface treatment belt 88, thereby performing the surface treatment on the first surface.

Then, in the same manner as described above, the recording sheet A is cut in the width direction and in the transport direction in the cutting unit 102 to be produced as separate prints P, the prints P are rearranged in a single line in the arranging unit 104 if needed, and then are discharged to the discharge unit 106.

In other words, the position of the recording sheet A, which has been reversed, is adjusted in the position adjusting unit 15, thereby making it possible to maintain a high degree of cutting accuracy of the recording sheet A which is subsequently performed.

Note that, also in the printer 330, similarly to the printer 320, the recording sheet A may be reversed in the second reversing unit 334 prior to the surface treatment, and the first surface thereof may be first subjected to the surface treatment. Then, the recording sheet A may be reversed in the second reversing unit 334 again, to thereby perform the surface treatment subsequently on the second surface thereof.

As described above, the printer 300 shown in FIG. 8 has a structure in which the surface treatment is performed on both surfaces of the recording sheet. A in the surface treatment section 16 of the surface treatment unit 302, and then the position of the recording sheet A is adjusted in the position adjusting unit 15. Thus, the structure of the second reversing means is simple and the position adjustment can be performed immediately before cutting the recording sheet A, so the printer 300 is advantageous in terms of obtaining extremely high cutting accuracy.

Further, the printer 320 shown in FIG. 9 has a structure in which the position of the recording sheet A is adjusted in the position adjusting unit 15, and then the surface treatment is performed on both surfaces of the recording sheet A in the surface treatment section 16. Thus, it is possible to perform the surface treatment on both surfaces of the recording sheet A only by providing the second reversing means to the surface treatment section 16 as the surface treatment unit 302 when the surface treatment section 16 is arranged downstream of the position adjusting unit 15 in the current apparatus. As a result, the printer 320 is advantageous in terms of minimizing increase of manufacturing costs of the apparatus.

Further, in the printer 330 shown in FIG. 10, when the surface treatment section 16 is arranged downstream of the position adjusting unit 15 in the current apparatus, it is possible to perform the surface treatment on both surfaces of the recording sheet A only by providing the second reversing means to the surface treatment section 16 and the position adjusting unit 15 as the surface treatment unit 332. Further, the increase of the manufacturing cost of the apparatus can be suppressed to a minimum, and the position adjustment of the recording sheet A can be performed immediately before the recording sheet A is cut. As a result, the printer 330 is advantageous in terms of obtaining extremely high cutting accuracy.

Accordingly, the structure to be employed may be appropriately determined according to the performance required for the printer, the costs, and the like.

In the above-mentioned printers 300, 320, and 330, the supplying unit 12 is provided with the front/back surface discriminating means 28 for discriminating the image recording layer such as the transparent resin layer of the recording sheet A, thereby making it possible to reliably discriminating the presence or absence of the image recording layer on one surface of the recording sheet A to be supplied to the image recording unit 14. For this reason, an image can be reliably recorded on the image recording layer and surface treatment can be reliably performed on the image recording layer on which the image has been recorded. As a result, it is possible to produce any of a one-side-processed one-side print, a one-side-processed two-side print, and a two-side-processed two-side print by using a sheet for photographic-image-quality print having the image recording layer formed on one surface or both surfaces thereof as the recording sheet A.

However, the present invention is not limited thereto. Alternatively, it is possible to discriminate the presence or absence of the image recording layer on both surfaces of the recording sheet to be used in order to reliably produce a one-side-processed one-side print and/or a one-side-processed two-side print by using a recording sheet A having an image recording layer formed only on one surface thereof, or in order to reliably produce a two-side-processed two-side print by using a recording sheet A having image recording layers formed on both surfaces thereof.

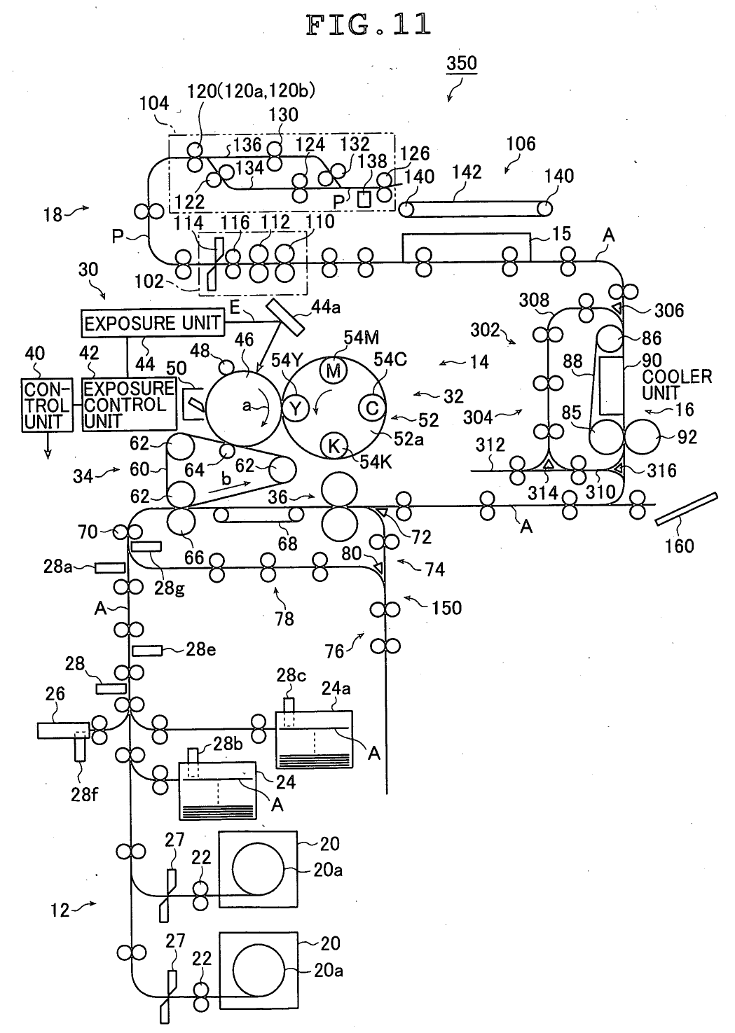

FIGS. 11, 12, and 13 are schematic diagrams each showing another embodiment of the printer according to the present invention.

In any of the printers 350, 360, and 370 which are respectively shown in FIGS. 11, 12, and 13, the presence or absence of the image recording layer (hereinafter, represented by the transparent resin layer) such as the transparent resin layer with respect to both surfaces of the recording sheet A is discriminated. Further, it is possible to discriminate whether or not the type of the surface (e.g., plain paper, sheet for the one-side photographic-image-quality print, and sheet for the two-side photographic-image-quality print) of the recording sheet A to be supplied to the image recording unit 14 is appropriate, or to make the optimal selection therefor, depending on image recording or finishing (e.g., non-processed one-side recording, non-processed two-side recording, one-side-processed one-side recording, one-side-processed two-side recording, and two-side-processed two-side recording) required for the print to be outputted.

Note that, structures of the printers 350, 360, and 370, which are respectively shown in FIGS. 11, 12, and 13, are similar to those of the printers 300, 320, and 330, which are respectively shown in FIGS. 8, 9, and 10 except for the following points. That is, in each of the printers 350, 360, and 370, there is provided the cassette 24a, which is provided in the supplying unit 12, in addition to the cassette 24, and there are provided front/back surface discriminating means 28a, 28b, 28c, 28e, 28f, and 28g in addition to the front/back surface discriminating means 28. Accordingly, the same components are denoted by the same reference symbols, detailed descriptions thereof are omitted, and different parts are mainly described below.

In addition, the printers 350, 360, and 370, which are respectively shown in FIGS. 11, 12, and 13, are each provided with the supplying unit 12 having the same structure, that is, provided with the cassettes 24 and 24a, and the front/back surface discriminating means 28, 28a, 28b, 28c, 28e, 28f, and 28g in the same manner. Accordingly, the printer 350 shown in FIG. 11 will be described hereinafter as a representative example. The front/back surface discriminating means 28a, 28b, and 28c are employed in FIGS. 5, 6, and 7, respectively.

In the printer 350 shown in FIG. 11, the supplying unit 12 includes two magazine loading units, two cassette loading units, the manual feeding unit 26, and the front/back surface discriminating means 28, 28a, 28b, 28c, 28e, 28f, and 28g. The two magazine loading units are provided to load the magazines 20 containing recording sheet rolls 20a. The two cassette loading units are provided to load the cassettes 24 and 24a containing recording cut-sheets A.

Also in the printer 350 shown in FIG. 11, similarly to the printer 300 shown in FIG. 8, the front/back surface discriminating means 28 is arranged downstream of the supplying unit 12, that is, on the immediately downstream side of the manual feeding unit 26 in the illustrated example, and on the middle left side of the transport path for the recording sheet A in FIG. 11 so that a surface facing the transfer belt 60 of the image recording unit 14, that is, a state (i.e., surface type, that is, presence or absence of a transparent resin layer) of a transfer surface can be detected or discriminated by the front/back surface discriminating means 28.

In the printer 350 shown in FIG. 11, the front/back surface discriminating means 28e is further arranged in the vicinity of the front/back surface discriminating means 28, and on an opposite side of the front/back surface discriminating means 28 across the transport path of the recording sheet A, that is, on the right side in FIG. 11 so that a surface of the recording sheet A, which does not face the transfer belt 60 of the image recording unit 14, and whose state (i.e., surface type) cannot be detected and discriminated by the front/back surface discriminating means 28, that is, a state (i.e., surface type) of a non-transfer surface can be detected by the front/back surface discriminating means 28e.

Thus, in the printer 350, surface types of both surfaces of the recording sheet A can be detected and discriminated by combination of the front/back surface discriminating means 28 and 28e.

Note that the positions of the front/back surface discriminating means 28 and 28e are not limited to those of the illustrated example, but any positions may be adopted as long as the surface types of the recording sheet A, which is transported by the transporting means of the vertical transport path, can be detected and discriminated on the downstream side of any of the magazines 20, the cassettes 24 and 24a, and the manual feeding unit 26 and on the upstream side of the registration roller pair 70 of the image recording unit 14.

Further, in the printer 350 shown in FIG. 11, similarly to the printer 300 shown in FIG. 8, the cassette 24 is loaded in the cassette loading unit arranged on the upstream side of the manual feeding unit 26 and on the downstream side of the loading units of the magazines 20. In the printer 350, in addition to the cassette 24, the cassette 24a is loaded in the cassette loading unit arranged on the downstream side of the cassette 24 and on the upstream side of the arranged position of the front/back surface discriminating means 28.

On the cassettes 24 and 24a, the front/back surface discriminating means 28b and 28c are respectively arranged such that the front/back surface discriminating means 28b and 28c each face uppermost sheets of the recording sheets A contained in the cassettes 24 and 24a so that the surface types of the uppermost sheets of the recording sheets A contained in the cassettes 24 and 24a can be detected and discriminated by the front/back surface discriminating means 28b and 28c. The recording sheets A contained in the cassettes 24 and 24a are drawn out on the transport path from the supplying unit 12 to the image recording unit 14 with the upper side of the recording sheet A being on the right side of FIG. 11. As a result, the front/back surface discriminating means 28 detects and discriminates the surface type of the front surface of the recording sheet A to be transported on the transport path, and the front/back surface discriminating means 28b and 28c detect and discriminate the surface type of the back surface of the recording sheet A to be transported on the transport path, that is, whether or not the surface is a transparent resin layer (i.e., presence or absence thereof).

Thus, in the printer 350, surface types (i.e., presence or absence of a transparent resin layer) of both surfaces of the recording sheet A supplied from the cassette 24 can be detected and discriminated by combination of the front/back surface discriminating means 28 and 28b. Further, in the printer 350, surface types of both surfaces of the recording sheet A supplied from the cassette 24a can be detected and discriminated by combination of the front/back surface discriminating means 28 and 28c.

Note that, in the case of arranging the above-mentioned front/back surface discriminating means 28e, even when the front/back surface discriminating means 28b and 28c are not arranged, the recording sheets A are supplied from the cassettes 24 and 24a, thereby making it possible to detect and discriminate the surface types of the non-transfer surfaces of the recording sheets A which are supplied from the cassettes 24 and 24a and are transported on the transport path. As a result, in order to discriminate the surface type of the non-transfer surface, the front/back surface discriminating means 28b and 28c are not necessarily arranged. However, in a case where information on the types of the recording sheets A contained in the cassettes 24 and 24a has been obtained, the surface types of the transfer surfaces can be also discriminated by discriminating the surface types of the non-transfer surfaces in a state where the recording sheets A are contained in the cassettes 24 and 24a, so it is preferable to arrange the front/back surface discriminating means 28b and 28c.

Thus, in the case of arranging the above-mentioned front/back surface discriminating means 28b and 28c, in the printer 350, it is possible to discriminate whether or not the recording sheet A is appropriate for the print P to be produced. As a result, the recording sheet A which is not appropriate for the print P to be produced is not supplied from the cassettes 24 and 24a, and the recording sheet A can be supplied only from the cassette containing the appropriate recording sheet A. After the recording sheet A has been supplied from the cassettes 24 and 24a, the recording sheet A is not discriminated as the recording sheet inappropriate for the print P to be produced in the front/back surface discriminating means 28e. As a result, it is unnecessary to allow the inappropriate recording sheet A to pass through the image recording unit 14 to be discharged to the plain paper discharge tray 160.

Note that, if there is no cassette containing the appropriate recording sheet A, the recording sheet A may be supplied from the magazines 20, a warning to that effect may be issued, or a notification or warning may be issued so as to supply the recording sheet A from the manual feeding unit 26.

Further, in the printer 350, the front/back surface discriminating means 28f is arranged on the lower side of the manual feeding unit 26 as shown in FIG. 11. The front/back surface discriminating means 28f is mounted on the lower side of the manual feeding unit 26 so that a type of a surface, which is on the lower side of FIG. 11, of the recording sheet A manually fed in the manual feeding unit 26 can be detected and discriminated. The recording sheet A manually fed in the manual feeding unit 26 is drawn out on the transport path from the manual feeding unit 26 to the image recording unit 14 with the lower side of the recording sheet A being the right side of FIG. 11. Thus, the front/back surface discriminating means 28f detects and discriminates the surface type of the front surface of the recording sheet A to be transported on the transport path, and the front/back surface discriminating means 28f detects and discriminates the surface type of the back surface of the recording sheet A to be transported on the transport path, that is, whether or not the surface is a transparent resin layer (i.e., presence or absence thereof).

Thus, in the printer 350, surface types (i.e., presence or absence of a transparent resin layer) of both surfaces of the recording sheet A supplied from the manual feeding unit 26 can be detected and discriminated by combination of the front/back surface discriminating means 28 and 28f.

Note that, in the case of arranging the above-mentioned front/back surface discriminating means 28e, even when the front/back surface discriminating means 28f is not arranged, the recording sheet A is supplied from the manual feeding unit 26, thereby making it possible to detect and discriminate the surface types of the non-transfer surfaces of the recording sheets A which are transported on the transport path. However, when the front/back surface discriminating means 28f is arranged to detect and discriminate in advance the surface type of the non-transfer surface of the recording sheet A fed in the manual feeding unit 26, it is possible to decrease the number of the recording sheets A to be fed which is inappropriate for the print P to be produced, and eliminate the necessity of uselessly discharging the inappropriate recording sheet A from the discharge tray 160. Accordingly, it is preferable to provide the front/back surface discriminating means 28f.

Note that, if the front/back surface discriminating means 28f determines that the recording sheet A fed in the manual feeding unit 26 is the inappropriate recording sheet, a warning to that effect may be issued, or the recording sheet A may be supplied from the magazines 20 or the cassettes 24 and 24a.

The above-mentioned front/back surface discriminating means 28 and 28e each detect and discriminate surface types of both surfaces of the recording sheet A being transported from the supplying unit 12 to the image recording unit 14, but the front/back surface discriminating means 28 and 28e are not limited thereto. Instead of the front/back surface discriminating means 28 and 28e, or in addition to those, the front/back surface discriminating means 28a and 28g for detecting surface types of both surfaces of the recording sheet A, which has been stopped, may be respectively arranged on the immediately upstream side of the registration roller pair 70 and on left and right sides of the transport path of FIG. 11.

The front/back surface discriminating means 28a and 28g each have exactly the same functions as those of the front/back surface discriminating means 28 and 28e, and each detect and discriminate surface types of both the transfer surface and the non-transfer surface of the recording sheet A. Further, the front/back surface discriminating means 28a and 28g detect and discriminate the surface types of the both surfaces of the recording sheet A in a state where the recording sheet A is stopped, so the front/back surface discriminating means 28a and 28g can perform detection with a high detecting accuracy and a high discriminating accuracy as compared with the front/back surface discriminating means 28 and 28e. As a result, in a case of arranging the front/back surface discriminating means 28a and 28g, it is unnecessary to arrange the front/back surface discriminating means 28, 28b, 28c, 28e, and 28f.

Alternatively, in a case of arranging the front/back surface discriminating means 28a and 28g extremely near the registration roller pair 70, it is also possible to discriminate surface types of both surfaces of the recording sheet A which has been reversed in the first reversing unit 150.

In the above-mentioned printers 350, 360, and 300, the front/back surface discriminating means 28a, 28b, 28c, 28e, 28f, and 28g are arranged in addition to the front/back surface discriminating means 28. However, according to the present invention, instead of arranging all of those front/back surface discriminating means, some of those front/back surface discriminating means may be arranged. For example, one of or both of the front/back surface discriminating means 28 and 28a may be arranged, one of or both of the front/back surface discriminating means 28e and 28g may be arranged, or the front/back surface discriminating means 28b, 28c, and 28f may be arranged instead of the front/back surface discriminating means 28e and/or 28g.

In addition, in the above-mentioned printers 350, 360, and 300, two cassettes 24 and 24a and two magazines 20 are loaded into the respective loading units, but the present invention is not limited thereto. According to the present invention, three or more cassette loading units may be provided, and three or more cassettes may be loaded thereinto. Further, three or more magazine loading units may be provided, and three or more magazines may be loaded thereinto. As a result, various types of recording sheets can be loaded, and even when a same kind of recording sheets are used, two types of recording sheets can be loaded in the respective cassettes such that one type with one surface of each sheet facing upward in one cassette and the other type with the other surface of each sheet facing upward in the other cassette.

Even when three or more cassettes are provided, it is preferable that the cassettes are each provided with front/back surface discriminating means having a function similar to that of the front/back surface discriminating means 28b and 28c.

Further, a plurality of manual feeding units 26 may be provided. Also in this case, the respective manual feeding units 26 are preferably provided with front/back surface discriminating means having a function similar to that of the front/back surface discriminating means 28f.

As a result, it becomes possible to easily or reliably select the recording sheet A appropriate for the print P to be produced from a number of cassettes or a number of magazines, and it becomes also possible to reliably supply the appropriate recording sheet A from a number of manual feeding units. Thus, it is possible to reduce or eliminate operations such as changing the cassettes 24 and 24a, changing the recording sheets A within the cassettes 24 and 24a, or changing of the magazines 20 while a printing operation is stopped, which results from the fact that the recording sheet A appropriate for the print P cannot be selected. As a result, it is possible to produce a print or prints with efficiency. Further, it is possible to reduce or eliminate the possibility of selecting the recording sheet A inappropriate for the print P by mistake.

As described above, in the printers 350, 360, and 370 which are respectively shown in FIGS. 11, 12, and 13, it is possible to discriminate whether the image recording layer such as the transparent resin layer is formed only on one surface of the recording sheet A, whether it is formed on both surfaces thereof, or whether it is not formed either of the surfaces thereof in the following manners. That is, when the recording sheet A is supplied from the supplying unit 12, the discrimination can be performed by combination of the front/back surface discriminating means 28 and 28e, or by combination of the front/back surface discriminating means 28a and 28g, when the recording sheet A is supplied from the cassette 24 or 24a, the discrimination can be performed by combination of the front/back surface discriminating means 28 and 28b or 28c, and when the recording sheet A is supplied from the manual feeding unit 26, the discrimination can be performed by combination of the front/back surface discriminating means 28 and 28f. As a result, even when a recording sheet having the image recording layer formed only on one surface thereof, a recording sheet having the image recording layers formed on both surfaces thereof, and further a recording sheet having no image recording layer formed on the surfaces thereof are mixedly provided as the recording sheet A, the image recording layer can be reliably discriminated, in other words, discrimination of the front and back surfaces of the recording sheet can be performed.

Further, since the front/back surface discriminating means 28a and 28g are provided in the vicinity of the downstream of the registration roller pair 70, it is possible to measure the state of the surface of the recording sheet A whose glossiness or the like is measured, at a timing of stopping the recording sheet A once by allowing the leading edge of the recording sheet A to abut against the registration roller pair 70. As a result, the image recording layer can be discriminated, in other words, discrimination of the front and back surfaces of the recording sheet can be performed, without lowering the treatment capability, without increasing the number of front/back surface discriminating means, with reliability, and with a high degree of accuracy.

While the printer and the image forming method according to the present invention has been described above in detail by exemplifying various embodiments, the present invention is not limited to those embodiments, but may be modified or changed without departing from the gist of the present invention.

For example, in the above-mentioned examples, the switch-back is performed as the method of reversing the recording sheet, but the present invention is not limited thereto. Alternatively, it is possible to adopt various methods, for example, a method of reversing the recording sheet A by rotating the transport roller pair with the transport direction of the recording sheet A being a rotational axis, and a known method of reversing a sheet material.

What is claimed is:

1. A printer comprising:
image recording means for recording an image on one surface of a recording medium at a predetermined recording position;
surface treatment means for performing surface treatment on said one surface of said recording medium;
first reversing means for reversing two surfaces of said recording medium after said image has been recorded on said one surface of said recording medium by said image recording means and supplying said recording medium to an upstream of said image recording means; and
second reversing means for reversing said two surfaces of said recording medium.

2. The printer according to claim 1, wherein said second reversing means is positioned upstream of said first reversing means.

3. The printer according to claim 1, wherein said second reversing means is positioned upstream of said image recording means and said first reversing means, and reverses said image recording medium before said image is recorded by said image recording means on said one surface of said recording medium.

4. The printer according to claim 1, wherein said second reversing means is positioned downstream of said image recording means and said first reversing means and upstream of said surface treatment means, and said image recording means records respective images on both surfaces of said recording medium and said surface treatment means performs said surface treatment on said one surface of said recording medium, said both surfaces of which have said respective images recorded by said image recording means.

5. The printer according to claim 1, wherein said first reversing means shares a part of a transport path for said recording medium with said second reversing means.

6. The printer according to claim 1, wherein said surface treatment means has a surface treatment belt, and presses said recording medium against said surface treatment belt to heat said recording medium, transports said recording medium to cool said recording medium while said recording medium is adhered to said surface treatment belt, and then detaches said recording medium from said surface treatment belt, thereby transferring a surface property of said surface treatment belt onto said recording medium.

7. The printer according to claim 1, wherein said image recording means records said image on said recording medium by a electrophotographic process.

8. The printer according to claim 1, wherein said image recording means records said image on said one surface of said recording medium or respective images on both surfaces of said recording medium, said surface treatment means performs said surface treatment on said one surface or said both surfaces of said recording medium, and said second reversing means reverses said recording medium subjected to said surface treatment by said surface treatment means to supply said recording medium to the upstream of said surface treatment means.

9. The printer according to claim 8, wherein said printer has a first mode in which an image is recorded on one surface of said recording medium by said image recording means to perform said surface treatment on said one surface of said recording medium, a second mode in which respective images are recorded on both surfaces of said recording medium to perform said surface treatment on one surface of said both surfaces thereof, and a third mode in which respective images are recorded on both surfaces of said recording medium to perform said surface treatment on said both surfaces thereof, and wherein said printer comprises mode selecting means for selecting one of modes including said first mode, said second mode and third mode.

10. The printer according to claim 1, wherein said image recording means records said image on said recording medium by a electrophotographic process.

11. An image forming method, comprising the steps of:
performing image recording by image recording means after reversing a first surface and a second surface of a recording medium to record an image on said second surface of said recording medium;
thereafter, reversing said recording medium and transporting said recording medium to an upstream of said image recording means;
performing said image recording on said first surface of said recording medium by said image recording means to record said image on said first surface of said recording medium; and
thereafter, performing surface treatment on said first surface of said recording medium.

12. An image forming method, comprising the steps of:
recording an image on a first surface of a recording medium by image recording means;
reversing said first surface and a second surface of said recording medium as well as transporting said recording medium to an upstream of said image recording means;
performing image recording on said second surface of said recording medium by said image recording means to record an image on said second surface of said recording medium; and
reversing said recording medium upstream of surface treatment means to perform surface treatment on said first surface of said recording medium by said surface treatment means.

13. The image forming method according to claim 12, further comprising the steps of:
further reversing said recording medium after said first surface of said recording medium is subjected to said surface treatment with said surface treatment means;
transporting said recording medium to the upstream of said surface treatment means to perform said surface treatment on said second surface of said recording medium by said surface treatment means.

14. An image forming method, comprising the steps of:
recording an image on a first surface of a recording medium by image recording means;
thereafter, reversing said first surface and a second surface of said recording medium as well as transporting said recording medium to an upstream of said image recording means;
performing image recording on said second surface of said recording medium by said image recording means to record an image on said second surface of said recording medium;
performing surface treatment on said second surface of said recording medium by surface treatment means;
thereafter, reversing said recording medium as well as transporting said recording medium to the upstream of said surface treatment means; and
performing the surface treatment on said first surface of said recording medium by said surface treatment means.
